(19) United States
(12) Patent Application Publication
(10) Pub. No.: US 2007/0288329 A1
(43) Pub. Date: Dec. 13, 2007

(54) Publicly Accessible Deferred Purchasing System With Vendor Review Access To Deferred Purchase Requests

(76) Inventors: Scott J. Broussard, Cedar Park, TX (US); Joseph Herbert Mcintyre, Austin, TX (US); Eduardo N. Spring, Round Rock, TX (US)

Correspondence Address: Biggers & Ohanian, LLP, P. O Box 1469, Austin, TX, 78767, US

(21) Appl. No.: 11/772,577

(22) Filed: Jul. 2, 2007

Related U.S. Application Data
(63) Continuation of application No. 10/202,947, filed on Jul. 25, 2002.

(51) Int. Cl. G06Q 30/00

(52) U.S. Cl. 705/26

(57) ABSTRACT

Operating a publicly accessible purchasing system including receiving, on a receipt date, from a purchaser in a publicly accessible purchasing system, a deferred purchase request (“DPR”) for an item, granting to vendors review access to DPRs, receiving from a proposing vendor a proposal regarding a reviewed DPR, selecting a selected vendor, in dependence upon the proposal, and issuing a purchase order to the selected vendor for an item on a date subsequent to the receipt date.

### CROSS-REFERENCE TO RELATED APPLICATION This application is a continuation application of and claims priority from U.S. patent application Ser. No. 10/202,947 filed on Jul. 25, 2002.

### BACKGROUND OF THE INVENTION

1. Field of the Invention

The field of the invention is data processing, or, more specifically, methods, systems, and products for publicly accessible deferred purchasing systems.

2. Description of Related Art

In the current art of on-line purchasing, there is no useful way to enter a delayed purchase request for a purchase order to be issued to a vendor at a later time. In current art, on-line purchasers enter current purchase orders directed to known vendors. Often, however, purchasers have gift or supply purchasing obligations, or other purchasing obligations, occurring at predictable times in the future, for which it would be convenient to plan now, for example, as an aid to memory or as part of a budgeted business plan. Or in some cases, regardless of memory or plans, a purchaser has time to work on-line now but knows that she will not have much time later when a purchase is needed.

That is, the subject of the present disclosure is delayed purchasing. More specifically, our subject is knowing today that a purchaser wishes to effect a purchase at some time in the future and making available to the purchaser a publicly-accessible system for entering deferred purchase requests having issue dates that result in the issuance of purchase orders on the issue dates. The advantage of such a public delayed purchasing system is that delayed purchase orders can be created as planning mechanisms days, week, or months in advance of the actual issuance date, for convenience, for planning, as aids to memory, for birthdays, anniversaries, holiday gifts and greetings, and so on. The benefits are for personal use and for business use, as in the case of advance entries of deferred purchase requests for estimated quantities of office supplies, so that even tiny businesses can have the benefits of ‘just-in-time’ controls of needed supplies, with no need to invest heavily in the infrastructure to effect such controls.

A publicly available delayed purchasing system would be even more beneficial if it were accessible by a variety of network-oriented interfaces, including, for example, personal computers communicating via the Internet, ordinary telephones, hand-held wireless internet-enabled special purpose devices, internet-enabled personal digital assistants, mobile phones, internet-enabled cell phones, and so on. Such publicly accessible delayed purchasing systems do not exist, although it would be advantageous if they did.

### SUMMARY OF THE INVENTION

Exemplary embodiments of the invention typically include methods for operating a publicly accessible purchasing system. Exemplary embodiments typically include receiving, on a receipt date, from a purchaser in a publicly accessible purchasing system, a deferred purchase request (“DPR”) for an item, granting to vendors review access to DPRs, and receiving from a proposing vendor a proposal regarding a reviewed DPR. Exemplary embodiments include selecting a selected vendor, in dependence upon the proposal, and issuing a purchase order to the selected vendor for an item on a date subsequent to the receipt date.

In exemplary embodiments, receiving a DPR includes receiving a plurality of DPRs, including storing the DPRs in a DPR table. In such embodiments, granting review access includes granting review access to the DPR table. In such embodiments, granting review access to the DPR table includes receiving a DPR table search request from the proposing vendor, searching the DPR table, generating a search result, and notifying the proposing vendor of the search result.

Exemplary embodiments of the invention include notifying the purchaser of the proposal, and receiving a response from the purchaser. In such embodiments, selecting a selected vendor in dependence upon the proposal includes selecting a selected vendor in dependence upon the purchaser response.

In exemplary embodiments, the DPR includes purchase terms, the proposing vendor proposal includes alternate purchase terms, and issuing a purchase order to the selected vendor includes issuing a purchase order to the proposing vendor in dependence upon the alternate purchase terms. In such embodiments, receiving a DPR in a publicly accessible purchasing system includes receiving a DPR across a telecommunications network through a Parlay environment. In exemplary embodiments, receiving a DPR in a publicly accessible purchasing system includes receiving a DPR across a telecommunications network through a JAIN SLEE environment.

In exemplary embodiments, receiving a DPR in a publicly accessible purchasing system typically includes receiving a DPR across an internet protocol network utilizing HTTP. In such embodiments, receiving at least one vendor proposal includes receiving at least one vendor proposal across a telecommunications network through a Parlay environment. In exemplary embodiments, receiving at least one vendor proposal includes receiving at least one vendor proposal across a telecommunications network through a JAIN SLEE environment. In such embodiments, receiving at least one vendor proposal includes receiving at least one vendor proposal across an internet protocol network utilizing HTTP.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a general process flow diagram illustrating a typical example embodiment of the present invention.

FIG. 2 is a general process flow diagram illustrating a typical example embodiment of the present invention.

FIG. 3 depicts an example of an embodiment of a table for deferred purchase requests.

FIG. 4 is a process flow diagram illustrating a purchaser notification aspect of typical example embodiments of the present invention.

FIG. 5 is a process flow diagram illustrating a vendor notification aspect of typical example embodiments of the present invention.

FIG. 6 is a process flow diagram illustrating a payment information verification aspect of typical example embodiments of the present invention.

FIG. 7 is a block diagram illustrating the overall structure of an example embodiment of the present invention utilizing telecomm-based data communications.

FIG. 8 is a process flow diagram illustrating a typical example embodiment of the present invention.

FIG. 9 depicts an example data structure for representing items in a table.

FIG. 10 depicts an example data structure for representing vendors in a table.

FIG. 11 depicts an example data structure for representing vendors and items in an associate table.

FIG. 12 is a process flow diagram illustrating a price based vendor identification aspect of typical example embodiments of the present invention.

FIG. 13 is a process flow diagram illustrating a purchase order based vendor identification aspect of typical example embodiments of the present invention.

FIG. 14 depicts an example data structure for representing purchase orders in a table.

FIG. 15 is a process flow diagram illustrating a vendor proximity based vendor identification aspect of typical example embodiments of the present invention.

FIG. 16 is a block diagram illustrating the overall structure of an example embodiment of the present invention utilizing web-based data communications.

FIG. 17 is a block diagram illustrating the overall structure of an example embodiment of the present invention utilizing telecommunications-based data communications.

FIG. 18 is a process flow diagram illustrating a vendor bidding aspect of typical example embodiments of the present invention.

FIG. 19 depicts a further exemplary data structure for deferred purchase orders.

FIG. 20 is a block diagram illustrating the overall structure of an example embodiment of the present invention utilizing Internet-based data communications.

FIG. 21 depicts an example data structure for representing vendor bids.

FIG. 22 is a process flow diagram illustrating a minimum number of vendor bids aspect of exemplary embodiments of the present invention.

FIG. 23 is a process flow diagram illustrating a purchaser choice of vendor bids aspect of exemplary embodiments of the present invention.

FIG. 24 is a block diagram illustrating the overall structure of an example embodiment of the present invention utilizing telecommunications-based data communications.

FIG. 25 is a process flow diagram illustrating a vendor deferred purchase request review aspect of typical example embodiments of the present invention.

FIG. 26 is a process flow diagram illustrating a vendor deferred purchase request review aspect of typical example embodiments of the present invention, including a DPR Table.

FIG. 27 depicts an example data structure for representing deferred purchase requests in a Deferred Purchase Request Table.

FIG. 28 is a block diagram illustrating the overall structure of an example embodiment of the present invention utilizing Internet-based data communications.

FIG. 29 depicts an example data structure for representing vendor proposals.

FIG. 30 is a process flow diagram illustrating a Deferred Purchase Request Table search aspect of exemplary embodiments of the present invention.

FIG. 31 is a process flow diagram illustrating a purchaser choice of vendor proposals aspect and a vendor alternate purchase term proposal aspect of exemplary embodiments of the present invention.

### DETAILED DESCRIPTION OF EXEMPLARY EMBODIMENTS

### Introduction

The present invention is described to a large extent in this specification in terms of methods for publicly accessible deferred purchasing systems. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executed on computer hardware, nevertheless, alternative embodiments implemented as firmware or as hardware are well within the scope of the present invention.

### Definitions

In this specification, the term “field” is used to refer to data elements, that is, to individual elements of digital data. Aggregates of fields are referred to as “records” or “data structures.” Aggregates of records are referred to as “tables.” Aggregates of tables are referred to as “databases.” Records and fields in a table are sometimes referred to respectively as “rows” and “columns.”

“Browser” means a web browser, a communications application for locating and displaying web pages. Browsers typically comprise both a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

A “foreign key” is a field in a first table that identifies and references a field in a second table. When such a foreign key is present the two tables are said to be “related.”

Data Definition Language (“DDL”) is often used to create data schema or record structures for tables. In this specification, scripts operable for creating record structures in tables are referred to as ‘DDL scripts.’

“DPR” abbreviates ‘deferred purchase request,’ a request received in a deferred purchasing system from a purchaser, the request representing an instruction to issue to a vendor on behalf of the purchaser a purchase order formulated according to detailed information provided as part of the DPR. DPRs are non-binding requests that a purchase can alter or cancel at any time prior to issuance of a purchase order.

“HTML” stands for ‘HyperText Markup Language,’ a standard markup language for displaying web pages on browsers.

“HTTP” stands for ‘HyperText Transport Protocol,’ the standard data communications protocol of the World Wide Web.

“Item” or “item to be purchased” and variants refer not only to tangible goods, but also to any entity, tangible or intangible, with respect to which rights may be transferred, including, for example, equipment, real estate, software, graphic images, patented inventions, other forms of intellectual property, information embodied in digital form, and so on.

“Parlay” refers to the Open Service Access (“OSA”) Application Programming Interface (“API”) of the multi-vendor industry consortium known as the “Parlay Group.” The OSA API is a technology-independent API that enables applications and technology solutions to operate across multiple networking platform environments.

“POP” refers to the ‘Post Office Protocol,’ a protocol for delivery of email messages from servers to email client applications. It is common for email between email servers to move according to SMTP, and email upon arriving at a destination server to travel from the destination server to an addressee's personal computer through POP. The version of POP that works with SMTP is called ‘POP2.’ There is a newer version of POP, ‘POP3,’ that can be used with or without SMTP. Although POP is probably the most common way today for servers to deliver email to email clients, some email is now delivered through a newer protocol known as “IMAP,” the Internet Message Access Protocol.

“Purchase” and its variants, “sale,” “sell,” “purchasing,” “purchaser,” and so on, as used in this disclosure, refers not only to acquisition of ownership in tangible goods, but also to acquisition of any kind of right in any entity, tangible or intangible, with respect to which rights may be transferred, including for example lease rights in equipment or real estate, license rights in software, graphic images, patented inventions, other forms of intellectual property, contractual rights, rights in information embodied in digital form, and so on.

A “purchase order” is an offer, conferring upon an offeree vendor a power of binding acceptance in accordance with its terms, to purchase, license, lease, rent, or otherwise acquire, goods, services, or intellectual property as described in the purchase order. A purchase order, unlike a DPR, typically is expected to be binding, that is, only capable of termination or alteration in accordance with terms and conditions set forth in the purchase order itself. There is within the scope of the present invention no limitation regarding the form of a purchase order. A purchase order can comprise a contract for purchase of real estate, a real estate lease, a software license, a license of patented industrial technology, an equipment lease, a purchase contract for tangible goods, and so on, including any form of offer as will occur to those of skill in the art.

“Server” in this specification refers to a computer or device comprising automated computing machinery on a network that manages resources and requests for access to resources. A “web server,” or “HTTP server,” in particular is a server that communicates with browsers by means of HTTP in order to manage and make available to networked computers documents in markup languages like HTML, digital objects, and other resources.

A “servlet” is a program designed to be executed from within another application, usually a web server's HTTP service. More particularly, servlets, unlike most application programs, are not intended to be executed directly from an operating system. Generally in this disclosure, “servlet” refers to Java servlets running on web servers providing data communications for user interfaces for deferred purchasing systems. As such, servlets are an alternative to CGI programs capable of handling actual reads and writes of data to and from file systems and databases.

A “SLEE server” is a server operating portable telecommunication services and application frameworks in a JAIN SLEE compliant execution environment. “JAIN” refers to the JAVA API for Integrated Networks. SLEE servers in typical embodiments of the present invention are implemented in JAVA using the JTAPI, the Java Telephony API. “JAIN SLEE,” or the JAIN Service Logic Execution Environment, an element of Sun Microsystems' industry-oriented de facto standard JAIN initiative, is a set of interfaces and standards for telecommunications and Internet operations within carrier grade telecommunications networks and Internet networks. JAIN-compliant telecommunications services are tested and deployed in the JAIN Service Logic Execution Environment.

“SMTP” means Simple Message Transfer Protocol, referring to the standard protocol for communicating electronic mail messages from electronic mail clients to electronic mail servers and from electronic mail servers to other electronic mail servers.

“World Wide Web,” or more simply “the web,” refers to a system of internet protocol (“IP”) servers that support specially formatted documents, documents formatted in markup languages such as HTML, XML, WML, or HDML. The term “Web” is used in this specification also to refer to any server or connected group or interconnected groups of servers that implement a hyperlinking protocol, such as HTTP or WAP (the ‘Wireless Access Protocol’), in support of URIs and documents in markup languages, regardless whether such servers or groups of servers are coupled to the World Wide Web as such.

“Wireless Application Protocol (“WAP”) is a specification for users with handheld wireless devices to access information, including information on the internet and other applications utilizing the Internet Protocol (IP). The devices include mobile phones, pagers, two-way radios, hand-held computers, and the like.

### DETAILED DESCRIPTION

In this disclosure we present exemplary embodiments of a publicly accessible deferred purchasing system that provides the public an opportunity to place an order for goods or services and indicate a date in the future on which a purchase order will issue to a vendor for the goods or services. In typical embodiments of the present invention, purchasers have accounts with a provider and have secure access through logon identifications and security codes. The provider in such embodiments is typically a telephone service provider or an internet service provider.

Embodiments of the invention typically include a user-interface that prompts the purchaser for appropriate information resulting in the creation of a deferred purchasing request, referred to herein as a “DPR.” A purchase order is created based on the DPR and is issued on an “issue date” selected by the purchaser.

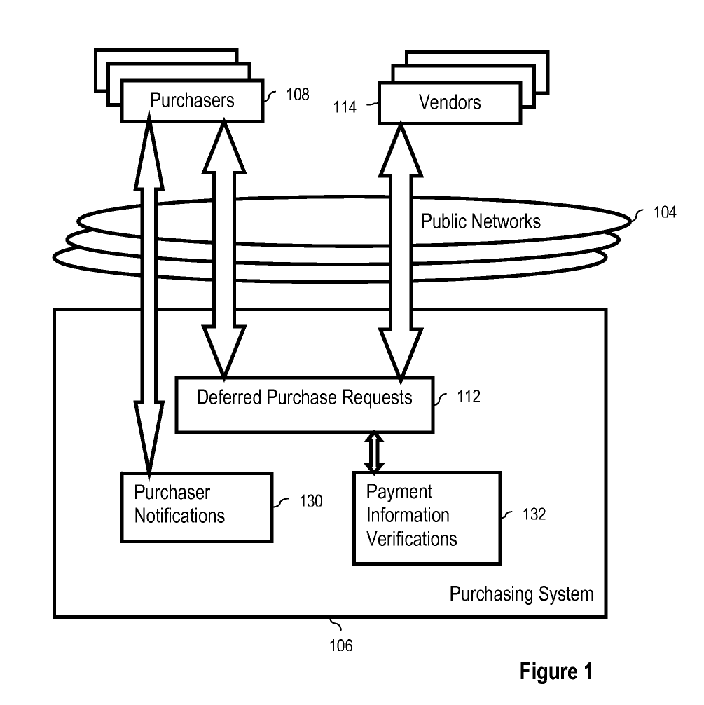

FIG. 1 is a block diagram depicting the overall structure of a deferred purchasing system according to an exemplary embodiment of the present invention. The deferred purchasing according to FIG. 1 includes purchasers (108) who enter deferred purchase requests (112) through public networks (104) into the deferred purchasing system (106). Embodiments of this kind include optional purchaser notifications (130) and optional payment information verifications (132). Embodiments of the kind illustrated in FIG. 1 are described in more detail below.

In embodiments of the kind shown in FIG. 1, public networks (104) include any kind of electronic communications network including internets and telecommunications networks, as described below in more detail. The execution environments of typical embodiments, such as, for example, SLEE and Parlay, are intended to operate across a variety of network platforms, including the Public Switched Telephone Network (PSTN), wireless networks, packet-based networks, LANs, WANs, internets, intranets, and so on. Communications protocols useful in various embodiments include the Internet Protocol (“IP”) and the Asynchronous Transfer Mode (“ATM”).

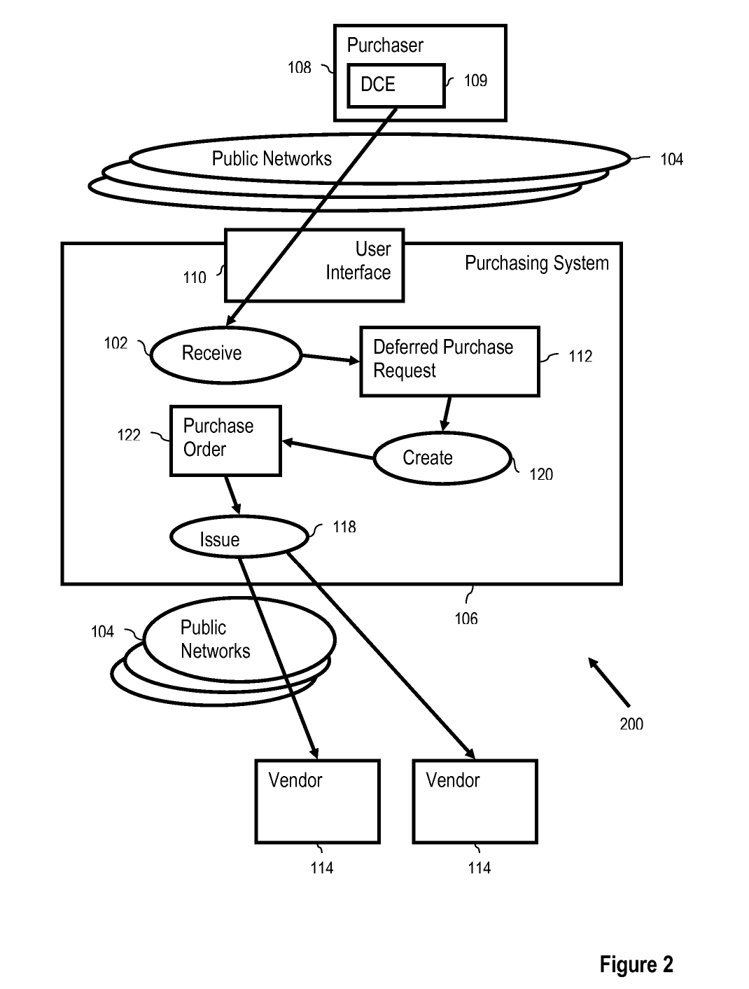

Turning now to FIG. 2, an exemplary embodiment (200) of the present invention is shown as a method for operating a publicly accessible deferred purchasing system. Embodiments of the kind shown in FIG. 2 include receiving (102) in a publicly accessible (104) deferred purchasing system (106), from a purchaser (108) through a user-interface (110), a deferred purchase request (“DPR”) (112).

In embodiments of the kind shown in FIG. 2, the purchaser utilizes data communication equipment (“DCE”) (109) for the user-interface (110) with the deferred purchasing system (106). DCE is any equipment capable of carrying out communication of information or data with a purchasing system. DCE can include, for example, a wired telephone, wireless telephone, personal digital assistants (“PDA”), computer systems, mobile computers, hand-held computers, laptop computers, network-enabled special purpose devices, and so on.

Within the Parlay OSA API is a generic user interface service capability feature. This generic user interface service capability feature is used by applications to interact with end-users. The generic user interface service capability feature includes a generic user interaction interface with methods to interact with an end-user. These methods include sending information to, or gathering information from the user, including users attached to a call. For call related purposes, a user interaction object is created. Information sent to the user includes announcements, menus, text, and data, the information being pre-defined or otherwise identified through Uniform Resource Locators (URLs) and the like. In collecting information from the end-user, a menu or announcement usually prompts for input such as a number of characters, including digits or text strings (such as “YES” if the end-user is using a telephone as the DCE (109)).

In a typical embodiment of the type shown in FIG. 2, receiving (102) a DPR (112) includes a purchaser's accessing the deferred purchasing system (106) by placing a telephone call to the deferred purchasing system. In this case, the public network (104) is a typical Public Switched Telephone Network (“PSTN”) and the purchaser's DCE (109) is a telephone handset. In response, a Parlay server establishes the call and creates a Parlay user interaction object for a user interaction with the purchaser. The user interaction object communicates an audible menu to the purchaser, the menu comprising prompts for a series of inputs from the purchaser's telephone keypad. The deferred purchasing system receives the inputs and stores the inputs as data in a DPR record.

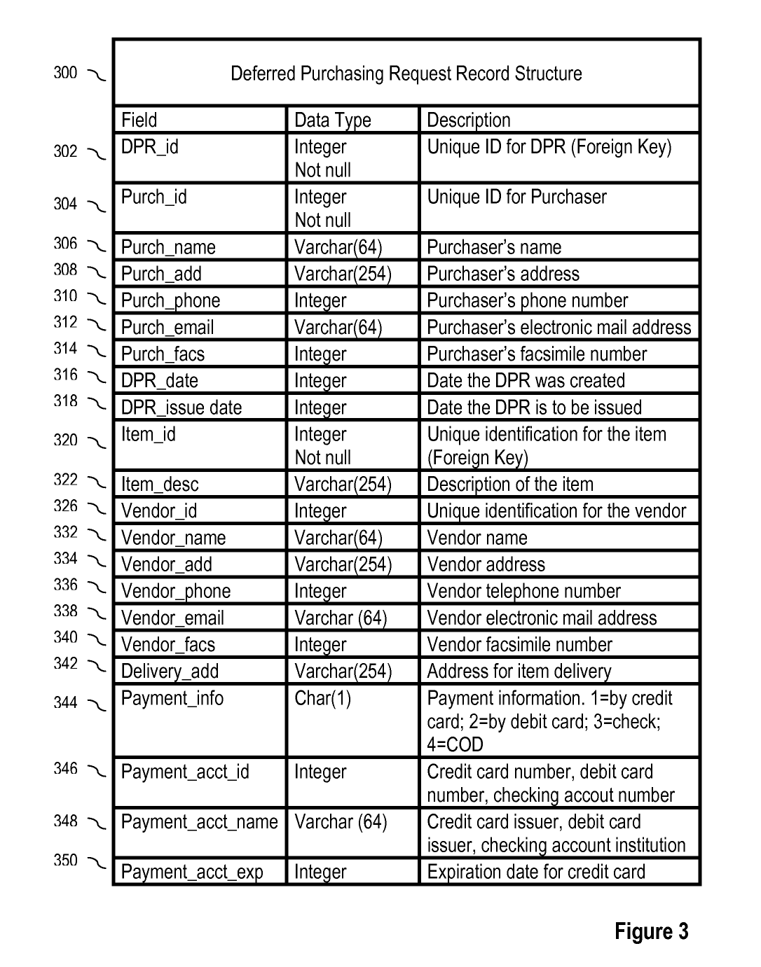

In such an embodiment, the audible menu prompt typically includes a request to input a unique user account number and personal identification number (“PIN”) using the telephone keypad, and both numbers must correspond to an authorized user account number and an authorized PIN. Once the authorization is established a subsequent audible prompt typically includes a message requesting the purchaser to input characters using the telephone keypad to describe the item to be purchased. In some embodiments, this item description input comprises a unique identification number (reference 320 on FIG. 3). The deferred purchasing system receives and stores the responsive identification number in the DPR record.

In other embodiments, the item description input includes telephone keypad responses to audible menu questions such as “Please choose from the following types of products: For clothing, press 1. For furniture, press 2. For photographic equipment, press 3.” Sub-menus are typically provided, as necessary, until the item is sufficiently described. For example, if the purchaser's response to the foregoing question was the keystroke “3,” the next menu typically includes a message such as “Please choose from the following types of photographic equipment: For digital cameras, press 1. For film cameras, press 2. For camcorders press 3.” As the purchaser inputs a numeric response to each question through the telephone keypad, the deferred purchasing system receives and records the characters in the DPR record.

In such embodiments, subsequent audible announcements prompt for a telephone keypad entry of an issue date (reference 318 on FIG. 3) by presenting an audible message to the purchaser such as: “Please enter the date on which you wish a purchase order to be issued for the item. Please enter four digits for the year, followed by two digits for the month, and two digits for the day of the month.” The deferred purchasing system receives (102) responsive input from the purchaser's telephone keypad and stores the input in the DPR record as the issue date.

In other typical embodiments of the type shown in FIG. 2, receiving (102) a DPR (112) includes a purchaser's accessing the deferred purchasing system (106) by placing a telephone call to the deferred purchasing system. In this case, the public network (104) is a typical Public Switched Telephone Network (“PSTN”) and the purchaser's DCE (109) is a telephone handset. In response, a Parlay server establishes the call and creates a Parlay user interaction object for a user interaction with the purchaser. The user interaction object communicates an audible menu to the purchaser, the menu comprising prompts for a series of inputs comprising spoken responses from the purchaser.

In such embodiments, wherein the input comprises spoken responses by the purchaser, the menu prompts for a spoken response from the purchaser and voice recognition software converts the purchaser's verbal response for storage in the DPR record. For example, the first audible menu prompt typically includes a message such as: “Please describe the item for which you want to place a deferred order.” As the purchaser responds, the verbal answer is converted to digital text. The next audible prompt typically reads back the digital text to the purchaser in a message such as: “You have ordered a Brand X Camcorder, Model XYZ. If this is correct, say Yes. If this is incorrect, say No.” A “No” response typically causes the original message requesting an item description to repeat. When a “Yes” response is received the deferred purchasing system is typically programmed to store the confirmed digital text in the DPR record as the item description (reference 322 on FIG. 3) or, optionally, the item identification (reference 320 on FIG. 3).

Similarly, embodiments of the kind shown in FIG. 2 that request a spoken response typically include an audible menu prompt with a message such as: “Please state the date on which you wish a purchase order to be issued for the item.” The voice recognition software then converts the verbal response from the purchaser to digital data in a date format and the deferred purchasing system stores the data in the DPR record as the issue date (reference 318 on FIG. 3).

In still other embodiments of the kind shown in FIG. 2, the deferred purchasing system (106) includes a web server with a conventional web site address that is publicly accessible by a purchaser (108). The purchaser's DCE (109) is a computer system having a web browser, monitor, mouse and keyboard. In these embodiments, the public network (104) is the internet, and receiving (102) the DPR (112) includes the purchaser's web browser creating a user-interface (110) with the deferred purchasing system web server when the purchaser enters the deferred purchasing system website address on the purchaser's computer keyboard. Once the web browser establishes the user-interface, the deferred purchasing system typically presents a visible message on the purchaser's monitor such as: “Please enter your user account number and password.” Following the purchaser's responsive entry of an authorized user account number and password, the deferred purchasing system typically presents item description menus on the purchaser's monitor to which the purchaser responds using the keyboard or a mouse. The deferred purchasing system receives (102) the purchaser's selection and records the purchaser's selection in the DPR record as the item description (reference 322 on FIG. 3) or, optionally, the item identification (reference 320 on FIG. 3).

In such embodiments, the deferred purchasing system typically presents another visible message on the purchaser's monitor such as: “Please enter the date on which you wish a purchase order to be issued for the item.” The purchaser again responds with input through the keyboard or mouse and the deferred purchasing system receives (102) the date and records the date in the DPR record (112) as the issue date (reference 318 on FIG. 3).

In additional embodiments of the kind shown in FIG. 2, the purchaser's DCE (109) is a hand-held computer including a micro-browser, screen display and keyboard. The deferred purchasing system (106) includes a Wireless Application Protocol (WAP) server accessible by the hand-held computer for the transmission and receipt of data through applications using the Internet Protocol (IP). In these embodiments, the public network (104) is a wireless network, and receiving (102) the DPR (112) includes the purchaser's micro-browser creating a user-interface (110) with the deferred purchasing system web server when the purchaser enters the deferred purchasing system website address on the purchaser's computer keyboard. Once the micro-browser establishes the user-interface, the deferred purchasing system typically presents a visible message on the purchaser's hand-held computer screen display such as: Please enter your user account number and password.” Following the purchaser's responsive entry of an authorized user account number and password, the deferred purchasing system typically presents item description menus on the purchaser's screen display and the purchaser inputs a response using the keyboard. The deferred purchasing system receives (102) the purchaser's inputted response and records the response in the DPR record as the item description (reference 320 on FIG. 3) or, optionally, as the item identification (reference 322 on FIG. 3).

In such embodiments wherein the purchaser's DCE (109) is a hand-held computer, the deferred purchasing system typically presents another visible message on the purchaser's screen display such as: “Please enter the date on which you wish a purchase order to be issued for the item.” The purchaser again inputs a response through the keyboard and the deferred purchasing system receives the date and records the date in the DPR record as the issue date (reference 318 on FIG. 3). In additional embodiments wherein the purchaser's DCE (109) is a hand-held computer, the purchaser inputs responses on the screen display using a stylus instead of a keyboard.

In still additional embodiments of the type shown in FIG. 2, the deferred purchasing system (106) includes a web server and the purchaser's DCE (109) includes a computer system having a web browser, monitor, keyboard, and mouse. The deferred purchasing system web server and the purchaser's computer system also include Voice over IP (VOIP) hardware and software. VOIP is a combination of hardware and software that provides a verbal conversation over the internet In these embodiments the public network (104) is the internet, and receiving (102) the DPR (112) includes the purchaser's web browser creating a user-interface (110) with the deferred purchasing system web server when the purchaser enters the deferred purchasing system website address on the purchaser's computer keyboard. Once the web browser establishes the user-interface, the deferred purchasing system typically prompts the purchaser for a spoken item description while simultaneously providing visual product images on the purchaser's monitor.

For such embodiments, wherein VOIP is utilized, a typical verbal message would be: “Please state which of the displayed product categories you wish to review.” The purchaser's verbal response is received through VOIP and the deferred purchasing system is programmed to provide successive displays and accompanying verbal prompts until a sufficient item description has been verbally input by the purchaser. For example, the final product screen display and verbal prompt typically includes a display of several camcorder models marketed by a manufacturer and a verbal prompt such as: “Please state the Brand X model you wish to purchase.” The purchaser's verbal response of “Model XYZ” completes the necessary item description input and the deferred purchasing system receives the data representing the purchaser's response and records the data in the DPR record as the item description (reference 322 on FIG. 3) or, optionally, the item identification (reference 320 on FIG. 3).

For the foregoing embodiments using VOIP, the deferred purchasing system also typically sends a verbal prompt for an issue date such as: “Please state the date on which you wish a purchase order to issue for the item.” The purchaser's verbal response is input and the deferred purchasing system receives the data representing the response and records the data in the DPR record as the issue date (reference 318 on FIG. 3).

For the kind of embodiments shown in FIG. 2, the DPR typically includes a DPR identification (reference 302 on FIG. 3), wherein the DPR identification is a unique identification for the DPR record that is created by the deferred purchasing system. The DPR also includes for such embodiments a purchaser identification (reference 304 on FIG. 3) and an item description of an item to be purchased (reference 322 on FIG. 3). The purchaser identification is a unique identification for the purchaser whose input created the DPR. In typical embodiments, this identification is the purchaser's previously established user account number.

In some embodiments of the kind illustrated in FIG. 2, the deferred purchasing system is controlled by a single vendor and all purchase orders issue to the controlling vendor. In other embodiments, wherein the deferred purchasing system is not so controlled, the purchaser inputs a vendor description, such as the vendor identification (reference 326 on FIG. 3), and the deferred purchasing system receives the vendor identification and records the description in the DPR record. Optionally, the purchaser inputs a vendor name (reference 332 on FIG. 3).

For example, in embodiments wherein the purchaser's DCE (109) is a telephone and a Parlay user interaction object has been created, the user interaction object typically prompts the purchaser for a telephone keypad inputted vendor identification number, by prompting with an audible menu prompt such as: “Please enter the three digit number for the vendor from which you would like to purchase the item.” The purchaser then enters the digits known by the purchaser to specify the vendor and the deferred purchasing system receives the inputted digits and stores the inputted digits in the DPR record as the vendor identification (reference 326 on FIG. 3).

Embodiments of the kind shown in FIG. 2 typically include creating (120) a purchase order (122) in dependence upon the DPR (112) and issuing the purchase order to a vendor (114) on the issue date. In these embodiments, creating a purchase order in dependence upon the DPR includes deriving data from a DPR record and incorporating the data into a purchase order. For example, data in the DPR record provides the identity of the vendor chosen by the purchaser (108) and the description of the item to be purchased. In some embodiments, vendor information needed to deliver the purchase order to the vendor is also derived from data in the DPR record, such as the vendor's name (reference 332 on FIG. 3), address (reference 334 on FIG. 3), telephone number (reference 336 on FIG. 3), electronic mail address (reference 338 on FIG. 3), or facsimile number (reference 340 on FIG. 3). In some embodiments, the purchaser inputs vendor information in response to prompts at the time the DPR is created. In other embodiments, this vendor information is stored in separate, pre-existing vendor records within the deferred purchasing system, the storage occurring prior to the creation of the DPR record.

Further embodiments of the present invention are illustrated in which a DPR (112) optionally includes for the purchaser, a name (306), an address (308), a telephone number (310), an electronic mail address (312), a facsimile number (314), and a delivery address (342). In such embodiments, the subsequently issued purchase order (122) provides all or part of such information to the vendor (114) for the vendor's use in determining wherein to ship the item, soliciting additional information from the purchaser, entering the purchaser in a general customer database maintained by the vendor, and so on. In some embodiments, the purchaser name, address, telephone number, electronic mail address, facsimile number, and delivery address are stored in the DPR record from input received from the purchaser at the time the DPR is created. In other embodiments, the deferred purchase system loads such additional purchaser information into the DPR record from separate, pre-existing user account records.

For embodiments according to FIG. 2, wherein the purchase order (122) issues (118) to the vendor (114) by mail, creating (120) the purchaser order (122) includes merging item description data into a word processing file and printing the word processing file as a hardcopy document. In other embodiments, wherein the purchase order (122) issues (118) to the vendor (114) by electronic mail, creating (120) the purchase order typically includes merging the item description data into an electronic mail file and electronically mailing the electronic mail file to the vendor's electronic address using a deferred purchasing system mail server.

In other embodiments of the kind shown in FIG. 2, wherein the purchase order (122) is issued to the vendor (114) by facsimile, creating (120) the purchase order typically includes merging the item description data into an electronic facsimile file and sending the electronic facsimile file to the vendor facsimile number. In such embodiments, the only hardcopy purchase order produced is the hardcopy generated at the vendor's facsimile machine.

In still other embodiments of the kind shown in FIG. 2, wherein the purchase order (122) is issued (118) to the vendor (114) by telephone, creating the purchase order typically includes creating a recorded purchase order message that incorporates the item description data and purchaser information, such as the purchaser name (reference 306 on FIG. 3) and purchaser address (reference 308 on FIG. 3), from the DPR record. The deferred purchasing system then automatically calls the vendor using the vendor telephone number (reference 336 on FIG. 3) and delivers the message. In such embodiments, the vendor typically has voice recognition software for receiving audible telephone messages such as this one from the deferred purchasing system and converting the message to data usable by the vendor.

Embodiments of the type shown in FIG. 2 are shown in FIG. 3 to optionally include a DPR date (316) and a unique item identification (320). In typical embodiments, the deferred purchasing system stores the DPR date in the DPR record at the time of the record's creation. The date is useful for purposes such as establishing priority among purchaser's whose DPRs are for the same item and when the vendor has an inadequate number of the item in stock.

With regard to the optional unique item identification (320) depicted on FIG. 3, and in embodiments of the type shown in FIG. 2, the deferred purchasing system receives (102) this unique item identification from the purchaser in the form of a responsive input to a prompt at the time the DPR is created. The purchaser typically obtains such a number through sources including hardcopy catalogs, television advertisements, manufacturer websites, vendor websites, and so on.

Also shown on FIG. 3, for various embodiments according to FIG. 2, are fields for payment related information, including a payment information field (344) indicating the preferred method of payment, a payment account identification field (346), a payment account name field (348), and a payment account expiration date field (350). These embodiments include a Parlay-based menu prompt at the time the DPR is created, the prompt requesting the purchaser to enter input as to the preferred method of payment.

In such embodiments for example, when the purchaser (108) hears the preferred method of payment prompt, with its stated options, and then presses the “1” key on the purchaser's telephone keypad, the deferred purchasing system receives (102) the inputted character and records the inputted character in the DPR record. In this case, this input or an input of the numbers “2” or “3” causes an additional prompt for the identification of the account associated with the manner of payment selected. In such embodiments this includes a credit card number, a debit card number, or a checking account number. The menu also prompts the purchaser in such a case for input as to the name (348) and expiration date (350) of the credit card identified. Later, the deferred purchasing system typically reads the “Payment_info” field as an indication that the purchaser desires to pay by credit card when the inputted number is “1,” by debit card if the number is “2,” and by check if the number is “3.” The deferred purchasing system records the account number in the “Payment_acct_id” field, the card number in the “Payment_acct_name” field, and the expiration date in the “Payment_acct_exp” field. The account number, card number, and expiration date are useful for the vendor's billing needs, and for payment verification purposes discussed below.

Similarly, in those embodiments according to FIG. 2, wherein the Parlay user interaction object supports voice recognition, the deferred purchasing system is typically programmed to send an audible message such as: “Please state your intended method of payment from among the following choices: credit card, debit card, check, or COD.” If the purchaser responds by verbally inputting the words: “Credit card,” the next audible message typically presented to the purchaser is: “Please state the name of the credit card issuer.” When the purchaser has verbally responded with the requested name, the next audible message is typically: “Please state the account number on your credit card.” After the purchaser verbally responds with the credit card number, the next audible message is typically: “Please state the expiration date shown on your credit card.”

Furthermore, as the verbal responses indicating the credit card preference, the credit card issuer name, the credit card number and the credit card expiration date, are inputted, the deferred purchasing system is typically programmed to construct one or more messages from the data resulting from the conversion of these purchaser verbal responses, and send the constructed message to the purchaser with an audible request for confirmation. Following the receipt of a confirming verbal response from the purchaser, the deferred purchasing system stores the data resulting from the conversions of the purchaser's verbal responses in the DPR record.

It should be noted that, for the deferred purchasing system (106) according to embodiments of the present invention, there is no strict requirement that the issue date must be entered at the moment the DPR is created. Alternately, for example, the purchaser (108) specifies a delivery date and the deferred purchasing system is programmed to automatically provide an issue date sufficiently in advance to give the vendor time to meet the delivery date. Alternately, for example, the deferred purchasing system is programmed to prompt the purchaser for an issue date at some point in time after the DPR is created.

The following DDL script is an example of a script useful within the present invention to create a table for aggregating DPR records (300) based upon the DPR described above and illustrated in FIG. 3.

create table DPR (

| | |
|---|---|
| DPR_id | integer not null, |
| Purch_id | integer not null, |
| Purch_name | varchar(64), |
| Purch_add | varchar(254), |
| Purch_phone | integer, |
| Purch_email | varchar(64), |
| Purch_facs | integer, |
| DPR_date | integer, |
| DPR_issue | integer, |
| Item_id | integer, |
| Item_desc | varchar(254), |
| Vendor_id | integer, |
| Vendor_name | integer, |
| Vendor_address | varchar(254), |
| Vendor_phone | integer, |
| Vendor_email | varchar(64), |
| Vendor_facs | integer, |
| Deliver_add | varchar(254) |
| Payment_info | char(1) |
| Payment_acct_id | integer |
| Payment_acct_name | varchar(64) |
| Payment_acct_exp | integer |

);

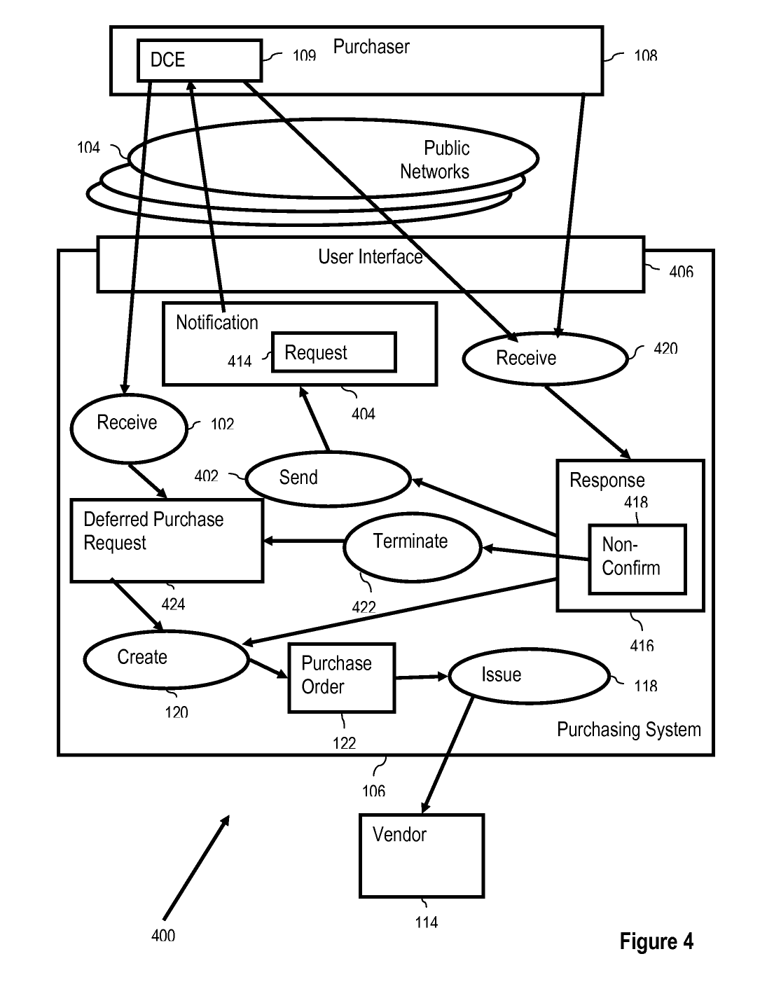

Turning now to FIG. 4, additional exemplary embodiments are shown that include sending (402) a notification (404) to the purchaser (108) prior to the issue date. In the embodiment shown, the deferred purchasing system is typically programmed to assign a date for the sending that is prior to the issue date. In some such embodiments the purchaser inputs the date in response to a prompt at the time the DPR is created. In other embodiments, the deferred purchasing system automatically assigns this date based on a previously determined number of days before the issue date.

On the notification date in such embodiments, the deferred purchasing system (106) sends (402) the notification (404) to the purchaser (108), the notification including the issue date and the item description. Purchaser information in the DPR (424) such as the purchaser's electronic mail address (reference 312 on FIG. 3) and the like, allow the notification to be sent using various channels of communication.

In some embodiments of the kind shown in FIG. 4, the deferred purchasing system (106) does not solicit a response from the purchaser to the notification. In other embodiments, the notification optionally includes a request (414) to the purchaser (108) for a pre-issue date confirmation response (416). In these types of embodiments it is typical for the deferred purchasing system to utilize a Parlay-based telephone call, including a user interaction object, to send (402) the notification. In this case, the public network (104) is a typical Public Switched Telephone Network (“PSTN”) and the purchaser's DCE (109) is a telephone handset. In this regard, the user interaction object communicates an announcement containing the notification to the purchaser. The announcement is derived from data read from the DPR record, such as the item description data and the issue date data.

In such embodiments, wherein the announcement containing the notification (404) with request (414) for confirmation is communicated by the user interaction object, the communicated announcement typically includes a subsequent menu prompt for telephone keypad input from the purchaser confirming or rejecting the deferred purchase described in the notification announcement. A typical prompt for confirmation in this regard is: “Do you still wish to purchase the item described? If so, press 1. If you wish to terminate the order, press 2.”

In such an embodiment, if a non-confirming response (418) is received (420) in response to the prompted request (414) for confirmation, the deferred purchasing system is typically programmed to terminate (422) the DPR (424). The deferred purchasing system is programmed to treat as a non-confirming response the purchaser's responsive input of “2,” or any failure to input “1,” including hang-ups or the pressing of any key other than “1.” In such embodiments, the deferred purchasing system terminates (422) the DPR (424) if no confirming response is received (420), and no purchase order will issue. Conversely, if a confirming response (416) is received (420) the scheduled issue date for the purchase order remains in effect.

For embodiments according to FIG. 4, wherein the notification (404) with request (414) for confirmation is sent (402) to the purchaser by mail, the deferred purchasing system (106) typically merges the item description data and issue date data into a word processing file and prints the word processing file as a hardcopy document for mailing to the purchaser. The word processing file typically includes as part of the notification (404) for confirmation a message that reads: “This message concerns your deferred purchase request, #123456, for a Brand X camcorder, Model XYZ, for which a purchase order is scheduled to issue on Jan. 1, 2003. This message is a request for confirmation of your continued interest in the purchase. Please call 111-111-1111 and confirm your continued interest on or before Dec. 1, 2002. Without such confirmation the deferred purchase request will terminate on Dec. 2, 2002.”

After receipt of such notification by mail the purchaser must provide a confirming response (416), the deferred purchasing system typically receiving (420) the response (416) through various methods. For example, the example notification contains a special confirmation telephone number for the purchaser's use. When the call is made by the purchaser to the special number, a Parlay-based user interaction object is typically created that communicates a series of messages to the purchaser that first request authorization input and, in subsequent messages request DPR identification input, and then confirmation input. Typical messages in this regard include:
“Please enter your user account number and PIN.”
“Please enter the DPR identification number.”
“Please press 1 to confirm your continued wish to purchase the item. Please press 2 to terminate the purchase.”

In other embodiments, wherein the notification (404) with request (414) for confirmation is sent (402) to the purchaser by electronic mail, the deferred purchasing system typically merges the item description data and issue date data into an electronic mail file and electronically mails the electronic mail file to the purchaser's electronic mail address using a deferred purchasing system mail server. In such a case, the electronic mail file will also include a request an electronic mail reply to indicate confirmation of the DPR.

In other embodiments of the kind shown in FIG. 4, wherein the notification (404) with request (414) for confirmation is sent (402) to the purchaser by facsimile, the deferred purchasing system merges the item description data and issue date data into an electronic facsimile file and sends (402) the electronic facsimile file to the purchaser's facsimile number. In these embodiments, the public network (104) is a typical Public Switched Telephone Network (“PSTN”) and the purchaser's DCE (109) is a facsimile machine. In such embodiments, the only hardcopy of the notification with request produced is the hardcopy generated at the purchaser's facsimile machine. The facsimile typically has the special confirmation telephone number discussed above with respect for confirmation to the embodiments wherein the notification with request is mailed in hardcopy form.

In other embodiments of the kind illustrated in FIG. 4, the notification (404) includes the DPR identification number (reference 302 on FIG. 3). The DPR identification number is useful for referencing by the purchaser (108) in the event the purchaser chooses a traditional form of response such as a personal telephone call or a letter.

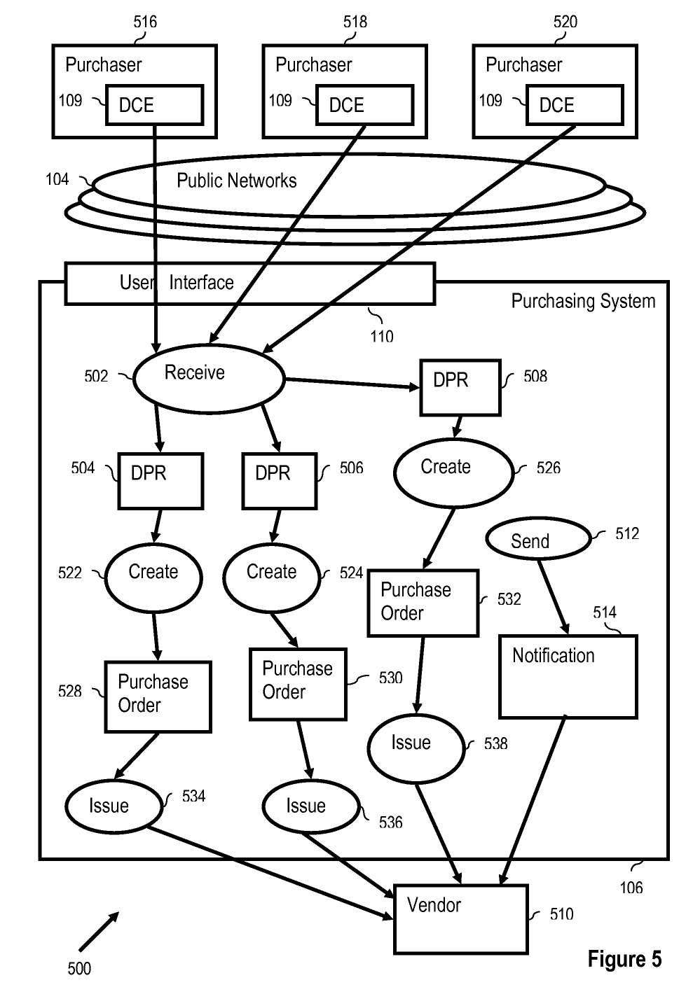

Turning now to FIG. 5, additional exemplary embodiments are illustrated wherein receiving a DPR further includes receiving (502) a plurality of DPRs (504, 506, 508) from one or more purchasers (516,518,520) for the same item to be purchased from the same identified vendor (510). As records for all such DPRs are created, they are each registered in a table, and the deferred purchasing system is typically programmed to find all DPR records for the same item and same vendor, either periodically or optionally as each DPR record is added to the table.

In such embodiments, and when at least two DPRs for the same item and vendor are so found, the deferred purchasing system sends (512) a notification (514) to the vendor (510), the notification including the issue dates, identifications of the DPRs in the plurality, and an identification of the item, which typically comprises the item identification (reference 320 on FIG. 3) or the item description (reference 322 on FIG. 3). In these embodiments, such a notification provides the vendor with adequate time in which to ensure the availability of a sufficient quantity of the item to honor all the subsequently created (522,524,526) purchase orders (528,530,532) at the time each purchase order issues (534,536,538).

For embodiments of the kind shown in FIG. 5, wherein the notification (514) is sent (512) to the vendor (510) by telephone, the deferred purchasing system typically utilizes a Parlay-based telephone call, including a user interaction object, to send (512) the notification. In such embodiments, the public network (104) is a typical Public Switched Telephone Network (“PSTN”) and the purchaser's DCE (109) is a telephone handset. In these embodiments the user interaction object communicates an announcement containing the notification to the vendor. The announcement is derived from data read from the DPR record, such as item description data, issue date data, and DPR identification data. In such embodiments, the vendor can have voice recognition software for receiving audible telephone messages such as this one from the deferred purchasing system and then converting the message to data usable by the vendor. In such embodiments, the notification announcement can state, for example: “Please be aware that our deferred purchasing system has received the following deferred purchase requests for the purchase of a Brand X camcorder, Model XYZ. The following purchase orders are currently scheduled to issue to your company on the date indicated. The purchase orders are PO No. 123456 issuing on Jan. 1, 2003, PO No. 654321 issuing on Jan. 5, 2003, DPR No. 123654 issuing on Jan. 8, 2003”

In other embodiments according to FIG. 5, wherein the notification (514) is sent (512) to the vendor (510) by mail, the deferred purchasing system (106) merges the data representing the issue dates, the identifications of DPRs in the plurality, and the item identifications into a word processing file and prints the file as a hardcopy document. In other embodiments, wherein the notification (514) is sent (512) to the vendor (510) by electronic mail, the deferred purchasing system (106) typically merges the data representing the issue dates, the identifications of the DPRs in the plurality, and the item identifications into an electronic mail file and electronically mails the electronic mail file to the vendor's electronic mail address using a deferred purchasing system mail server.

In still other embodiments of the kind shown in FIG. 5, wherein the notification (514) is sent (512) to the vendor (510) by facsimile, the deferred purchasing system merges the data representing the issue dates, the identifications of the DPRs in the plurality, and the item identifications into an electronic facsimile file, and sends the electronic facsimile file to the vendor facsimile number. In these embodiments, the public network (104) is a typical Public Switched Telephone Network (“PSTN”) and the purchaser's DCE (109) is a facsimile machine. In such embodiments, the only hardcopy notification produced is the hardcopy generated at the vendor's facsimile machine.

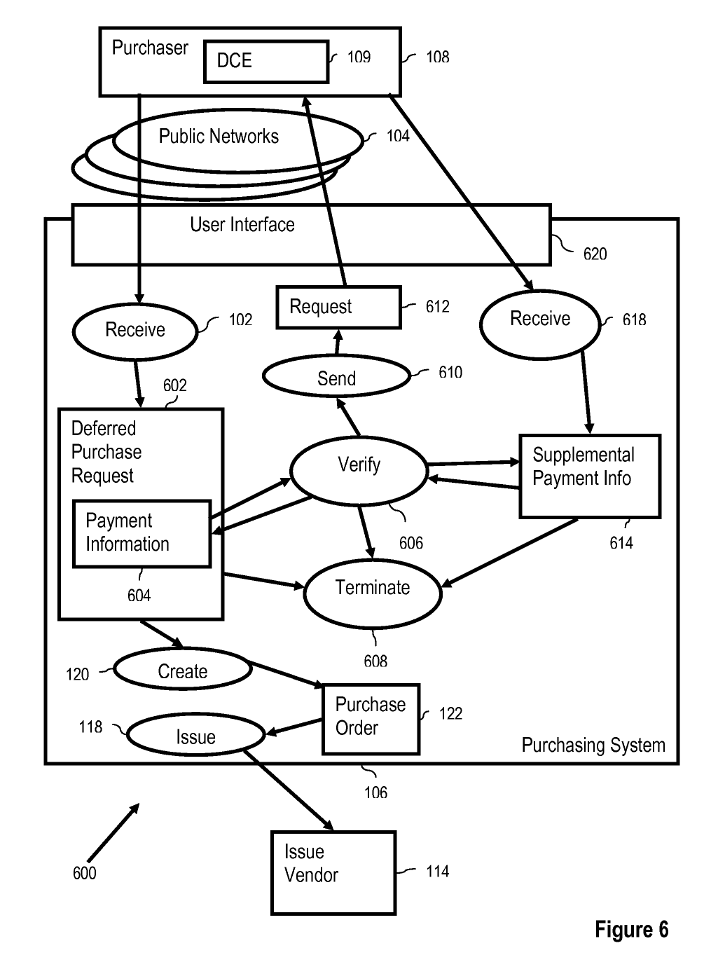

Turning now to FIG. 6, additional embodiments are shown wherein the DPR (602) includes payment information (604). Such embodiments include verifying (606) the payment information prior to the issue date, and the deferred purchasing system (106) is typically programmed to automatically assign a date for the verification based on a previously determined number of days before the issue date.

In embodiments according to FIG. 6, and at the time of the assigned verification date, the deferred purchasing system verifies (606) the payment information (604) by establishing that credit card, debit card, or checking account previously received (102) from the purchaser is a then current and valid payment method. For example, if the purchaser originally responded to a Parlay user interaction object menu prompt by inputting a “1,” the deferred purchasing system receives (102) the input and records the input in a “Payment_info” field of the DPR record. In such an example, the deferred purchasing system interprets this character on the date of verification as an intent to pay by credit card. In such an example, the credit card number was also originally input by the purchaser for recording by the deferred purchasing system in a “Payment_Acct_Id” field of the DPR record, along with a credit card name in a “Payment_acct_name” field, and a credit card expiration date in a “Payment_acct_exp” field. In such a case verifying (606) the payment information (604) includes authorizing a charge against the credit card from a credit authorization agency, using the credit card number, name and expiration date.

Embodiments of the kind illustrated in FIG. 6 typically include terminating (608) the DPR (602) if the payment information (604) verification is unsatisfactory. Unsatisfactory payment information verification in such an example includes the rejection of the charge by the authorization agency.

Embodiments of the kind shown in FIG. 6 also typically include, when the verification is unsatisfactory, sending (610) a request (612) for supplemental payment information (614) from the purchaser (108). For embodiments according to FIG. 6, wherein the request is sent to the purchaser by mail, the deferred purchasing system merges the item description data and issue date data into a word processing file and print the word processing file as a hardcopy document for mailing to the purchaser. The request typically reads: “This message concerns your deferred purchase request, #123456, for a Brand X camcorder, Model XYZ, for which a purchase order was originally scheduled to issue on January, 2003. The payment information you originally provided is no longer satisfactory. Please call 999-999-9999 and provide new payment information on or before Dec. 1, 2002. Without additional payment information the deferred purchase request will terminate on Dec. 2, 2002.”

In such embodiments, when a call is made by the purchaser to the special number, a Parlay-based user interaction object is typically created that communicates a series of messages to the purchaser that first requests authorization input and, in subsequent messages requests DPR identification input, and then supplemental payment information input. Typical messages in this regard include:
“Please enter your user account number and PIN.”
“Please enter the DPR identification number.”
“Please enter your new intended method of payment from among the following choices: For a credit card, press 1. For a debit card, press 2, for a check, press 3, for COD, press 4”
“Please enter the name of the credit card issuer, using the letters represented by numbers on your telephone keypad.”
“Please enter the account number on your credit card.”
“Please enter the expiration date shown on your credit card.”
   The deferred purchasing system receives (618) and stores the purchaser's inputted supplemental payment information (606) in the DPR record, replacing the unverifiable payment related information.

In other embodiments, wherein the request (612) for supplemental payment information (614) is sent (610) to the purchaser (108) by electronic mail, the deferred purchasing system, typically merges the item description data and issue date data into an electronic mail file and electronically mails the electronic mail file to the purchaser's electronic mail address using a deferred purchasing system mail server. In such embodiments, the electronic mail file additionally requests an electronic mail reply providing the supplemental payment information. Upon receipt (618) of the reply, the deferred purchasing system typically reads from the electronic mail reply the supplemental payment information (614) and stores the supplemental payment information in the DPR record.

In other embodiments of the kind shown in FIG. 6, wherein the request (612) for supplemental payment information (614) is sent (610) to the purchaser by facsimile, the deferred purchasing system typically merges the item description data into an electronic facsimile file and sends the electronic facsimile file to the purchaser's facsimile number. In these embodiments, the public network (104) is a typical Public Switched Telephone Network (“PSTN”) and the purchaser's DCE (109) is a facsimile machine. In such embodiments, the only hardcopy request produced is the hardcopy generated at the purchaser's facsimile machine. The facsimile has the special supplemental payment information telephone number discussed above with respect to the embodiments wherein the request for supplemental payment information is mailed in hardcopy form.

In still other embodiments of the kind shown in FIG. 6, wherein the request (612) for supplemental payment information (614) is sent (610) to the purchaser by telephone, it is typical for the deferred purchasing system to utilize a Parlay-based telephone call, including a user interaction object, to send (610) the request (612). In these embodiments, the public network (104) is a typical Public Switched Telephone Network (“PSTN”) and the purchaser's DCE (109) is a telephone handset. In this regard, the user interaction object communicates an announcement containing the request to the purchaser. The announcement is derived from data read from the DPR record, such as the item description data and the issue date data. In such embodiments, the purchaser listens to the message personally and the announcement requests the purchaser to provide supplemental payment information during the telephone call. Typical messages in this regard include:
“This message concerns your deferred purchase request, numbered 123456, for a Brand X camcorder, Model XYZ, for which a purchase order was originally scheduled to issue on January, 2003. The payment information you originally provided is no longer satisfactory. Unless additional payment information is provided during this call, the deferred purchase request will terminate on Dec. 2, 2002.”
“In this regard, please enter your new intended method of payment from among the following choices: For a credit card, press 1. For a debit card, press 2, for a check, press 3, for COD, press 4”
“Please enter the name of the credit card issuer, using the letters represented by numbers on your telephone keypad.”
“Please enter the account number on your credit card.”
“Please enter the expiration date shown on your credit card.”
   The deferred purchasing system receives (618) the purchaser's inputted supplemental payment information (606) and stores the supplemental payment information in the DPR record, replacing the unverifiable payment related information.

In the embodiments wherein the purchaser (108) provides supplemental payment information (614), the purchaser's input is stored in the DPR record (602). With the supplemental payment information recorded in the DPR, the deferred purchasing system in such examples verifies (606) the supplemental payment information. If the purchaser fails to provide supplemental payment information, or provides unverifiable supplemental payment information, the DPR is terminated (608).

### Automated Vendor Selection

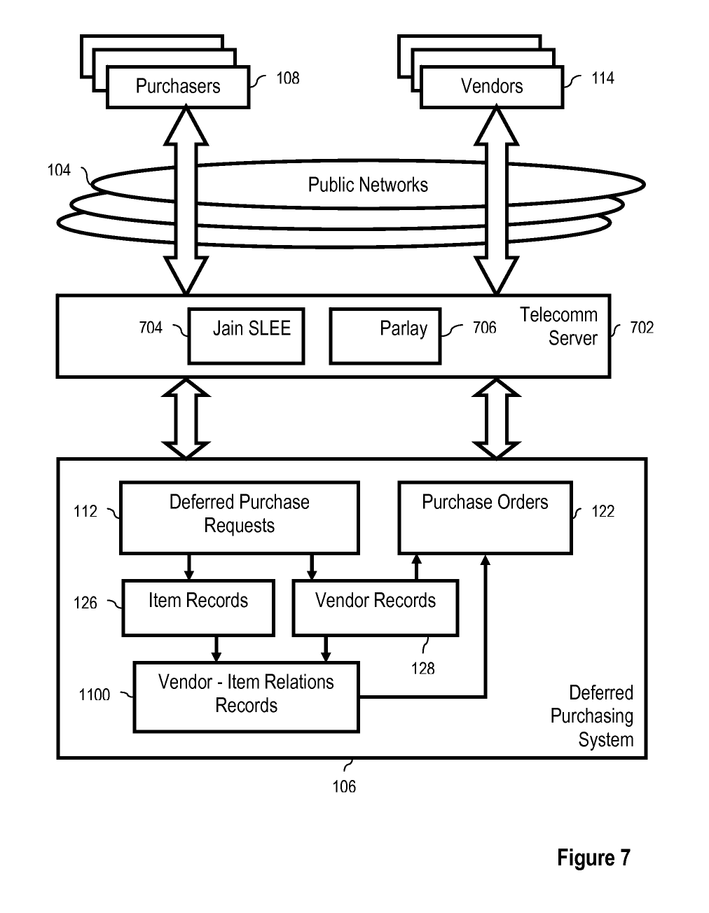

FIG. 7 sets forth a block diagram depicting a further example of an overall structure of a deferred purchasing system according to an exemplary embodiment of the present invention. The deferred purchasing system according to FIG. 7 accepts from purchasers (108) deferred purchase requests (112) (“DPRs”) through public networks (104) into the deferred purchasing system (106). Embodiments of this kind include item records (126) identifying items available for acquisition through the use of DPRs and vendor records (128) identifying vendors to whom purchase orders (122) may be issued. Embodiments of the kind shown in FIG. 7 include vendor-item relations records (1100) identifying items available for acquisition from particular vendors, often including a price at which a particular vendor represents a willingness to sell a particular item.

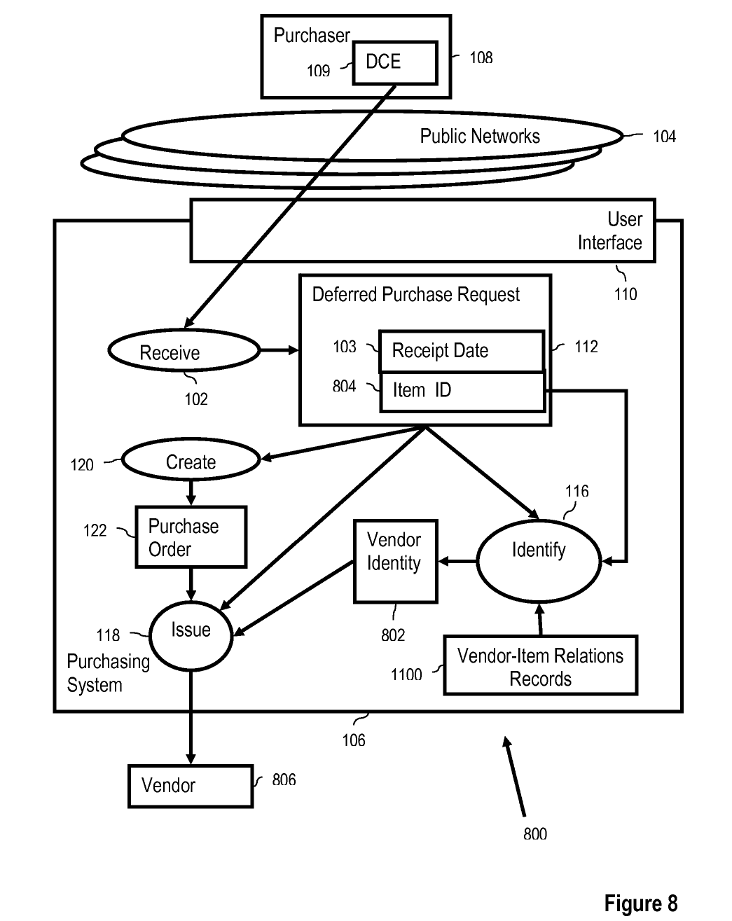

FIG. 8 sets forth a data flow diagram depicting an additional exemplary embodiment (800) of the present invention as a method for operating a publicly accessible deferred purchasing system. Embodiments of the kind shown in FIG. 8 include receiving (102), on a receipt date (103), in a publicly accessible (104) deferred purchasing system (106), from a purchaser (108) through a user-interface (110), a deferred purchase request (“DPR”) (112) for an item to be purchased. Typical embodiments include identifying (116) a vendor (802,806) and issuing (118), in dependence upon the DPR (112), a purchase order (122) to the vendor (806) on a date subsequent to the receipt date (103).

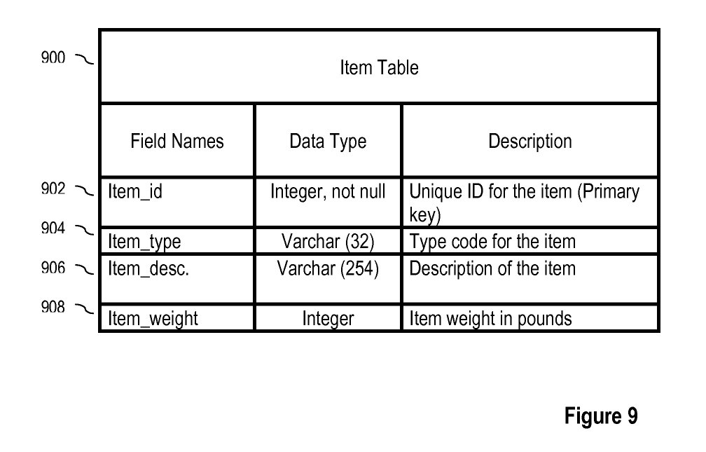

In purchasing systems utilizing methods of the kind shown in FIG. 8, receiving (102) a DPR (112) includes a purchaser's accessing the deferred purchasing system (106) by placing a telephone call to the deferred purchasing system. In the example of access through telephone, the public network (104) is typically a Public Switched Telephone Network (“PSTN”) and the purchaser's data communications equipment or “DCE” (109) is a telephone handset. In the example of telephone access, receiving (102) a DPR (112) is carried out through use of a telecommunications execution environment, such as, for example, Parley. More particularly, a Parlay server establishes a call and creates a Parlay user interaction object for a user interaction with the purchaser. The user interaction object communicates an audible menu to the purchaser, the menu comprising prompts for a series of purchaser inputs from the purchaser's telephone keypad. The user interaction object is capable of reading item records, such as those depicted in FIG. 9, for example, and communicating to a purchaser the item identifications of items available for purchase through a deferred purchasing system. The deferred purchasing system receives the purchaser inputs and stores at least some of the purchaser inputs as data in a DPR (112). A detailed example of a data structure for DPRs useful in embodiments according to FIG. 8 is set forth in FIG. 3.

In embodiments of the kind shown in FIG. 8, a DPR (112) typically includes an item identification (804) for the item to be purchased and the deferred purchasing system (106) identifies (116) a vendor in dependence upon the item identification. In such embodiments the deferred purchasing system (106) typically includes an item table having a structure, for example, of the kind described at reference 900 in FIG. 9. In such embodiments, each record in an item table represents an item available for purchase through the deferred purchasing system. Each item record includes a unique item identification stored in an “Item_id” field (902), an item type stored in an “Item_type” field (904), an item description stored in an “Item_desc” field (906), and an item weight in an “Item_weight” field (908). In such embodiments, the item identification (804) corresponds with the “Item_id” field (902) in the item table. In many embodiments, the purchasing system treats the “Item_id” field as a primary key for the item table.

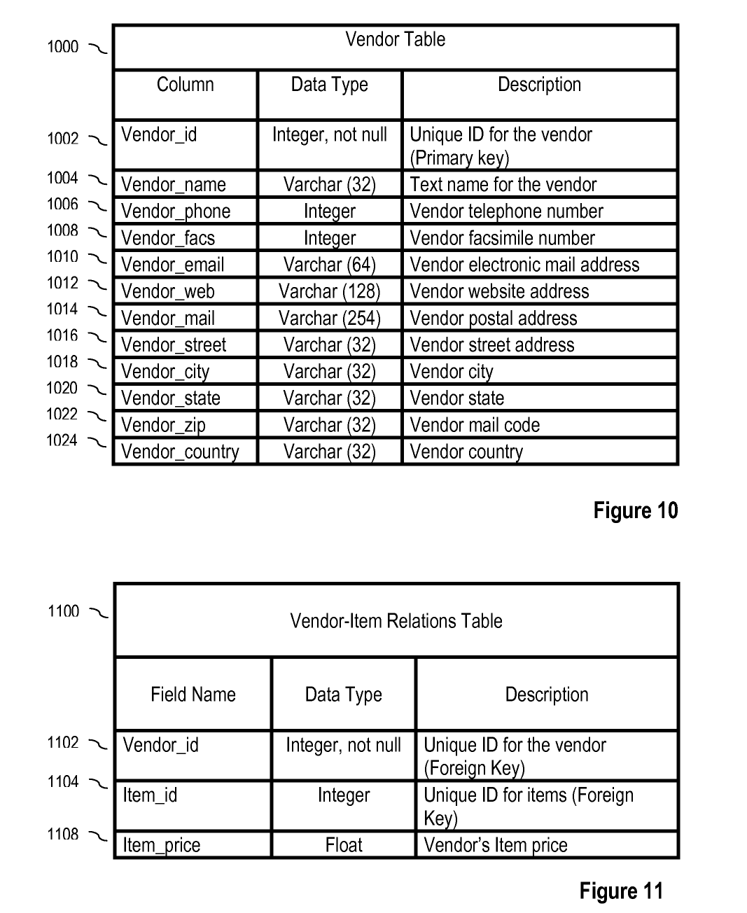

Deferred purchasing systems according to FIG. 8, typically include a vendor table (1000). FIG. 10 depicts an example data structure vendor record in a vendor table (1000), where each record represents a vendor to whom purchase orders may be issued through the deferred purchasing system. Each vendor record includes, for example, a unique vendor identification stored in a “Vendor_id” field (1002), a vendor's name stored in a “Vendor_name” field (1004), a vendor's telephone number stored in a “Vendor_phone” field (1006), an vendor's facsimile telephone number stored in a “Vendor_facs” field (1008), an electronic mail address stored in a “Vendor_email” field (1010), a website address stored in a “Vendor_web” field (1012), and a physical address stored in several fields. The physical address typically includes a street name stored in a “Vendor_street” field (1016), a city name stored in a “Vendor_city” field (1018), a state name stored in a “Vendor_state” field (1020), a mail code stored in a “Vendor_zip” field (1022), and a country stored in a “Vendor_country” field (1024). In such embodiments the “Vendor_id” field (1002) is a primary key.

For some embodiments of the kind shown in FIG. 8, identifying (116) a vendor (802) includes finding a vendor identification (802) using an intermediate table having a structure such as, for example, the Vendor-Item Relations Table (1100) shown in FIG. 11. As shown in FIG. 11, the Vendor-Item Relations Table includes vendor identifications stored in a Vendor_id field (1102), item identifications stored in an Item_id field (1104), and vendor item prices stored in an “Item_price” field (1108). In such embodiments, the Vendor-Item Relations Table associates the Item_id (902) of the item table (900) and Vendor_id (1002) of the vendor table (1000), the tables being related by such fields in a many-to-many relationship.

More particularly, for example, a vendor identified by a Vendor_id (1102) in the Vendor-Item Relations Table (1100) associates with at least one item in at least one record in the Vendor-Item Relations Table. In each such record, the Vendor-Item Relations Table identifies each of the at least one items by an Item_id (1104). In this manner, the Vendor-Item Relations Table indicates all items presented through the deferred purchasing system by a particular vendor. Similarly, an item identified by an Item_id (1104) in the Vendor-Items Relations Table associates with at least one vendor in at least one record in the Vendor-Item Relations Table. In each such record the Vendor-Item Relations Table identifies each of the at least one vendors by a Vendor_id (1102), the Vendor-Item Relations Table thus indicating all vendors that sell the item. A Vendor-Item Relations Table record stores each combination of a vendor and an item, and also includes the vendor item price—the price presented by that vendor for that item.

In typical embodiments according to FIG. 8, the Vendor-Item Relations Table (1100) relates to the item table (900) through an item identification foreign key which comprises the “Item_id” field (1104) of the Vendor-Item Relations Table. The item identification foreign key references the “Item_id” field (902) of the item table. Similarly, the Vendor-Item Relations Table (1100) relates to the vendor table (1000) through a vendor identification foreign key which comprises the “Vendor_id” field (1102) of the Vendor-Item Relations Table. The vendor identification foreign key references the “Vendor_id” field (1002) of the vendor table. By including both vendor identifications (1102) and item identifications (1104), a vendor-item relations table, such as the exemplary table depicted in FIG. 11, implements a many-to-many relation among vendors and items, so that it is possible by use of a such a table, to identify a vendor for an item by finding in such a table a record having a particular item identification.

In a typical application of embodiments of the kind shown in FIG. 8, the deferred purchasing system identifies (116) the vendor (806) by locating Vendor-Item Relations Table (1100) records that include the item identification in the Item_id field (1104) and then selecting a vendor from the vendors identified in the Vendor_id field (1102) for such records. In some embodiments, the deferred purchasing system is programmed to select the first vendor so located in the Vendor-Item Relations Table. In other embodiments, as discussed below, the deferred purchasing system utilizes various algorithms for making the vendor selection from the vendors identified in the Vendor-Item Relations Table.

Rather than describing vendors as ‘offering’ items for sale, vendors are described as ‘presenting’ items for sale through the deferred purchasing system, ‘Offer’ is a technical legal term indicating generally that an offeror is conferring upon an offeree a right to bind the offeror in an enforceable contract by accepting an offer. Vendors' presentations of items through a deferred purchasing may, at some stage in proceedings, mature into legally effective offers. The definition of where such a stage might occur is not a limitation of this invention, however. There is no requirement within the invention, that any presentation of an item or an item price from a vendor indicates an ‘offer’ to sell an item on any particular terms, including any item price that a vendor might present for an item through a deferred purchasing system.

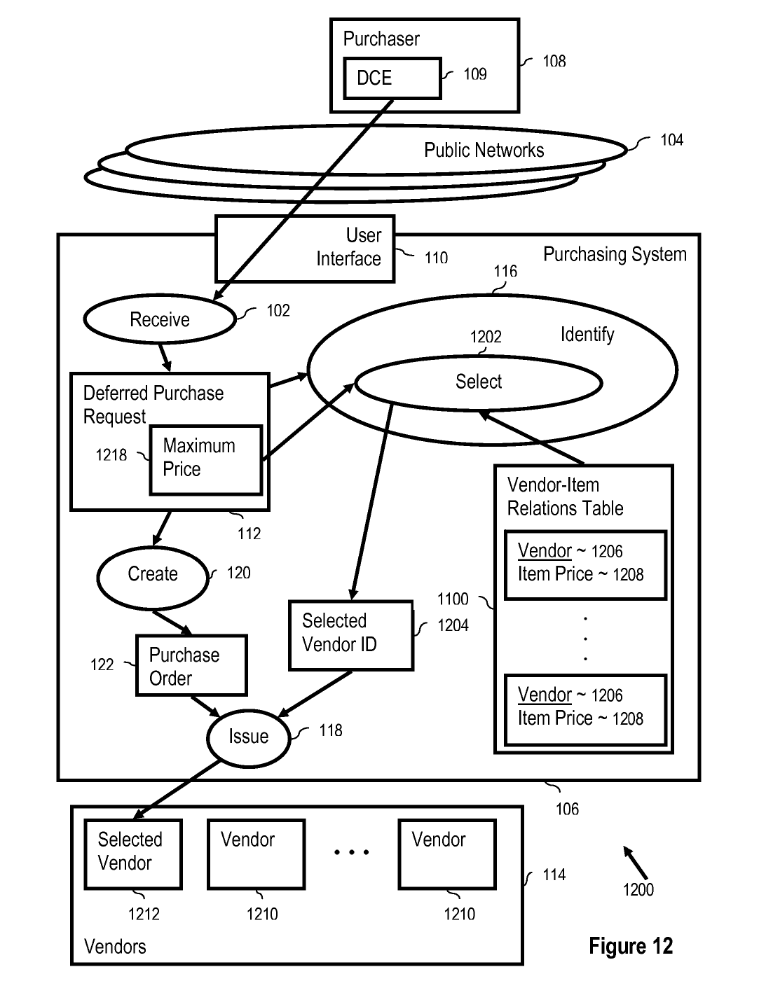

FIG. 12 sets forth a data flow diagram illustrating additional exemplary embodiments of the present invention in which identifying (116) a vendor includes selecting (1202) a selected vendor (1204) in dependence upon vendor item prices (1208). In such embodiments, the deferred purchasing system is sometimes programmed to identify a vendor by finding vendors (1210) that present a particular item for sale through the deferred purchasing system as represented by records in a Vendor-Item Relations Table (1100). Such vendors (1210) have records in a vendor-item relations table, as shown for example in FIG. 11, associating a Vendor_id (1206) with an Item_id (1104) that represents item presented for sale through the system. A deferred purchasing system according to FIG. 12 selects a vendor from among the vendors found to have vendor-item relations records with an Item_id identifying the particular item, the selected vendor (1212) being one presenting a vendor item price (1208) that is the lowest among the vendors who present the item through the deferred purchasing system.

In embodiments of the kind shown in FIG. 12, the vendor item price (1208) for a presenting vendor (1210) is typically stored in the “Item_price” field (1108) of a Vendor-Item Relations Table (1100, FIG. 11) record that includes the vendor's identification and the item identification for the item. Once the deferred purchasing system locates the Vendor-Item Relations Table records that include vendor identifications for vendors (1210) presenting the item, the deferred purchasing system compares the item prices (1208) stored in the “Item_price” column of the Vendor-Item Relations Table for each such record. The comparison finds the lowest vendor item price (1206) and the vendor identification stored in the “Vendor_id” field (1102) of the record that includes the lowest vendor item price is the selected vendor identity (1204).

In a further exemplary embodiment of the kind shown in FIG. 12, a DPR (112) includes a maximum price (1218). In some embodiments of this kind, a purchaser (108) provides a maximum price through a telephone keypad in response to an audible menu prompt. In such embodiments, the deferred purchasing system typically prompts the purchaser (108) with an audible menu prompt such as, for example:
Please indicate whether you wish to limit the selection of vendors to those presenting the item at a price no greater than a maximum price that you are willing to pay for the item. If you wish to limit the vendor selection in this manner enter the maximum price amount using the numbers shown on your telephone keypad, or press the pound key if you do not.

A deferred purchasing system according to such embodiments typically records the purchaser's response as data in a DPR record (112). If the purchaser responds by pressing “#,” then the deferred purchasing system selects from vendors presenting the item with no limitation based on a maximum price. If the purchaser responds by pressing numbers on the telephone keypad representing a maximum price amount, the deferred purchasing system typically identifies (116) a vendor by selecting (1202) a vendor (1212) from vendors (1206) shown in the Vendor-Item Relations Table to present the item. In this exemplary embodiment, the deferred purchasing system compares the maximum price to the vendor item price (1208) associated with an presenting vendor, and limits the selection to those vendors presenting a vendor item price (1208) that is not greater than the maximum price.

In various embodiments according to FIG. 12, embodiments in which the DPR includes a maximum price (1218) and the deferred purchasing system selects from the Vendor-Item Relations Table the first vendor presenting the item, the deferred purchasing system limits the selection to the first vendor presenting the item at a vendor item price no greater than the maximum price. In other embodiments, embodiments in which the DPR includes a maximum price (1218) and the deferred purchasing system selects from the Vendor-Item Relations Table the vendor presenting the item at the lowest vendor item price (1208), the deferred purchasing system limits the selection to vendors presenting the item at the lowest vendor item price, the vendor item price being no greater than the maximum price.

In some embodiments according to FIG. 12, the vendor item price (1208) includes typical additions to a base price for the item, such as sales tax, shipping, handling, and the like. In some embodiments the vendor item price represents the total price for the item, while in other embodiments the vendor item price is the base price for the item before such additions. A deferred purchasing system according to such embodiments typically determines the shipping portion of the total price by finding the item weight in “Item_weight” field (908, FIG. 9) in an item table (900), and calculating the shipping cost based on the item weight.

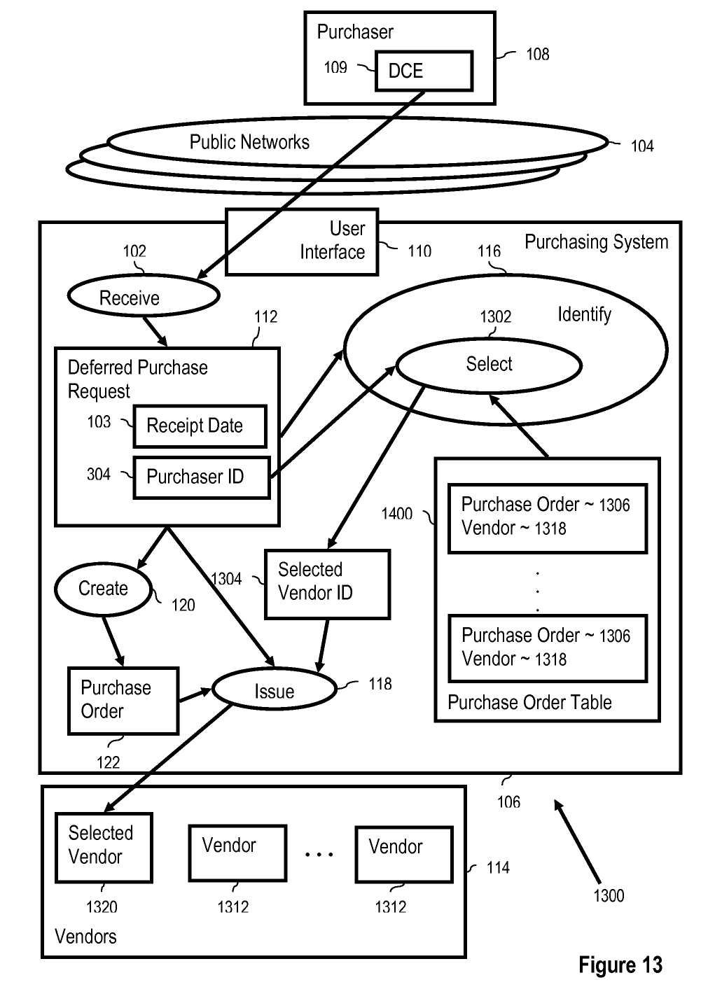

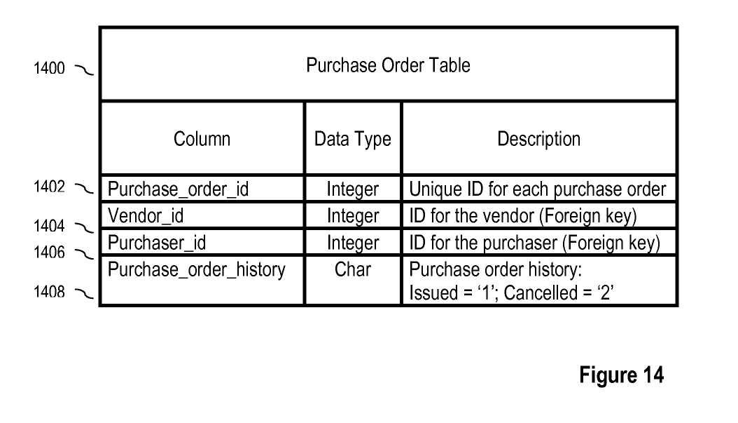

FIG. 13 sets forth a data flow diagram depicting additional exemplary embodiments of the invention in which a plurality of vendors (1312) present an item and identifying (116) a vendor includes selecting (1302) a selected vendor (1304,1320) in dependence upon purchase orders (1306). The deferred purchasing system is typically programmed to store purchase orders from previous deferred purchases as records in a Purchase Order Table (1400), for which an example data structure is depicted in FIG. 14. Each purchase order record (1306) in the Purchase Order Table typically includes a unique identification stored in a “Purchase_order_id” field (1402), a vendor identification for the vendor associated with the purchase order stored in a “Vendor_id” field (1404), a purchaser identification for the purchaser associated with the purchase order stored in a “Purchaser_id” field (1406), and a purchase order history for each purchase order stored in a “Purchase_order_history” field (1408). The “Purchase_order_history” field typically includes the number “1” as an indication that the purchase order was issued and a deferred purchase completed, or the number “2” if the purchase order was cancelled.

In some embodiments of the kind shown in FIG. 13, the Purchase Order Table (1400) relates to the item table (900) through a vendor identification foreign key which comprises the “Vendor_id” field (1402) of the Purchase Order Table. The item identification foreign key references the “Vendor_id” field (1002) of the vendor table.

In some embodiments of the kind shown in FIG. 13, the deferred purchasing system prompts the purchaser (108) to input an indication as to whether the purchaser wants the vendor to be identified based on previous purchase orders involving the purchaser. For example, the deferred purchasing system typically prompts the purchaser with an audible menu prompt such as:
Please indicate whether you wish to limit the selection of vendors to vendors with which you have completed purchases for one or more items in the past using this deferred purchasing system. Press 1 if you do wish to limit the selection to such vendors, or 2 if you do not.

A deferred purchasing system according to FIG. 13 typically records a purchaser's inputted response as data in a DPR record (112). In such embodiments, if the purchaser responds by pressing “2,” then the deferred purchasing system selects from vendors presenting the item with no limitation as to previous transactions with the purchaser. If the purchaser responds by pressing “1,” the deferred purchasing system typically responds to the affirmative indication by locating from the Vendor-Item Relations Table (1100) the vendors (1312) presenting the item, and selecting (1304) a vendor (1320) from such presenting vendors (1312) who is represented in the Purchase Order Table (1400) by a vendor identification (1318) stored in the “Vendor_id” field in a purchase order (1306) recorded in the Purchase Order Table, the selection being further limited to the vendors in such purchase order records having a “1” stored in the “Purchase_order_history” field (1408) of the record. In such embodiments the “1” indicates that a previous purchase order was issued to the vendor (1320).

In another example of the kind of embodiments shown in FIG. 13, the deferred purchasing system prompts the purchaser (108) to input an indication as to whether the purchaser wants the vendor to be selected from vendors that are not associated with previously cancelled purchase orders involving the purchaser. For example, the deferred purchasing system may prompt the purchaser with an audible menu prompt such as:
Please indicate whether you wish to limit the selection of vendors by excluding vendors identified with respect to any of your previous deferred purchases that were terminated prior to the completion of the transaction. Press 1 if you do wish to limit the selection by excluding such vendors, or 2 if you do not.

A deferred purchasing system according to this kind of embodiment typically records the purchaser's response as data in a DPR record (112). In such embodiments, if the purchaser responds by pressing “2,” then the deferred purchasing system selects from vendors presenting the item with no limitation as to previously cancelled transactions with the purchaser. If the purchaser responds by pressing “1,” the deferred purchasing system limits the selection to vendors (1318) that are not associated with cancelled purchase orders (1306) recorded in the Purchase Order Table (1400), as indicated by the number “2” in the “Purchase_order_history” field (1408) of the Purchase Order Table.

In other embodiments according to FIG. 13, wherein the deferred purchasing system limits the selection to vendors (1318) associated with purchase orders (1306) recorded in the Purchase Order Table (1400), the deferred purchasing system typically utilizes other algorithms to complete the vendor selection in the event more than one vendor is so associated with such recorded purchase orders. In such a case, the deferred purchasing system typically completes the vendor selection by comparing the vendor item prices (reference 1208 on FIG. 12) associated with the vendors with respect to the item, as recorded in the Vendor-Item Relations Table (1100), and then selecting the lowest price vendor.

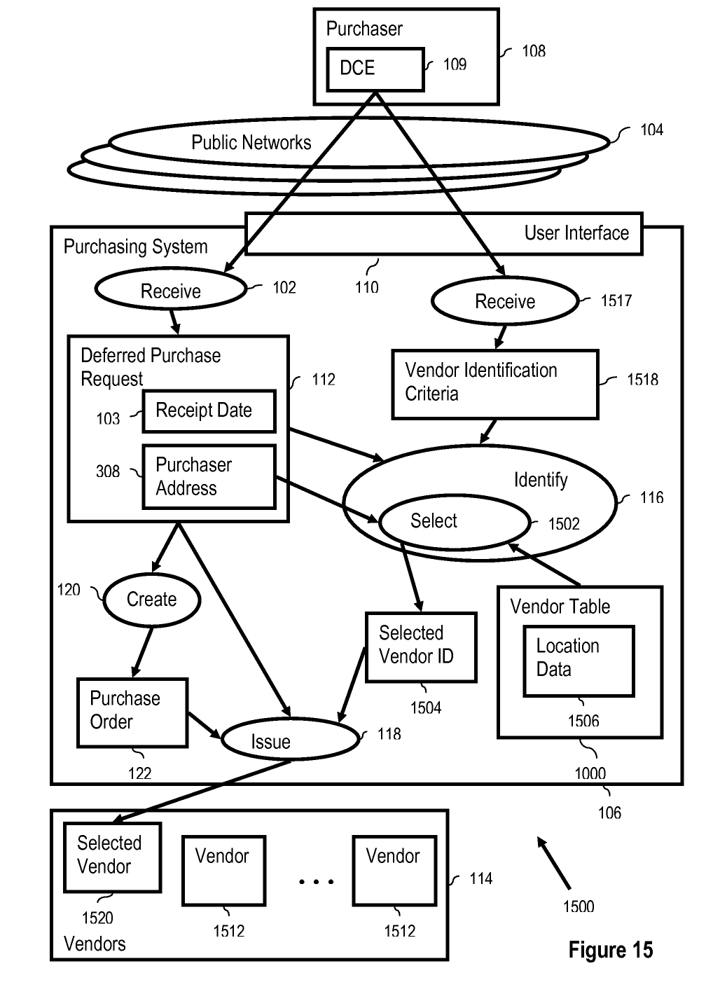

FIG. 15 sets forth a data flow diagram depicting additional exemplary embodiments of the present invention in which more than one vendor (1512) presents an item and vendor records in the vendor table (1000) typically include location data (1506) and vendor identifications (1002) for the vendors. In such embodiments the deferred purchasing system typically identifies a vendor by selecting (1502) a selected vendor (1504,1520) in dependence upon proximity of a vendor to the purchaser (108).

Referring again to FIG. 10, the vendor table (1000) is shown to include a record for each vendor that includes the vendor identification for the vendor stored in the “Vendor_id” field and vendor location data for the vendor. Location data typically includes the name of the vendor's city stored in the “Vendor_city” field (1016), the name of the vendor's state stored in the “Vendor_state” field (1018), the name of the vendor's country stored in the “Vendor_country” field (1022), and the vendor's zip code stored in the “Vendor_zip” field (1020). Similar purchaser address information is typically provided by the purchaser at the time a DPR (112) is created, or optionally, when a purchaser establishes a purchaser's account.

Deferred purchasing systems according to FIG. 15 typically prompt a purchaser (108) to enter, as telephone keypad input, an indication as to whether the purchaser only wants to do business with vendors that operate in proximate geographical locations. Such deferred purchasing systems may prompt a purchaser with an audible menu prompt such as:
Please indicate whether you wish to limit the selection of vendors to vendors residing in your country, by pressing 1 if you do wish to limit the selection to your country, or 2 if you do not.

If the purchaser presses “2” the deferred purchasing system ignores vendor proximity while identifying a vendor. If the purchaser presses “1” in response to such a prompt, the deferred purchasing system typically continues with another audible menu prompt such as:
Please indicate whether you wish to limit the selection of vendors to vendors residing in your state, by pressing 1 if you do wish to limit the selection to your state, or 2 if you do not.

If the purchaser responds by pressing “2,” then the deferred purchasing system selects from vendors in the same country as the purchaser, with no further proximity limitation. If the purchaser responds by pressing “1,” the deferred purchasing system typically continues with another audible menu prompt such as:
Please indicate whether you wish to limit the selection of vendors to vendors residing in your city, by pressing 1 if you do wish to limit the selection to your city, or 2 if you do not.

If the purchaser responds by pressing “2,” then the deferred purchasing system selects from vendors in the same state as the purchaser, with no further proximity limitation. If the purchaser responds by pressing “1,” the deferred purchasing system typically continues with another audible menu prompt such as:
Please indicate whether you wish to limit the selection of vendors to vendors residing in your zip code area, by pressing 1 if you do wish to limit the selection, or 2 if you do not.

If the purchaser responds by pressing “2,” then the deferred purchasing system selects from vendors in the same city as the purchaser, with no further proximity limitation. If the purchaser responds by pressing “1,” the deferred purchasing system limits the selection of vendors to those residing in the same zip code area as the purchaser.

Such a deferred purchasing system typically records the purchaser's inputted responses to such prompts as data in a DPR record (112). In such embodiments, embodiments in which the purchaser has responded with telephone keypad input to indicate that the purchaser desires to limit the selection of vendors to those residing in the purchaser's same city, a deferred purchasing system typically finds vendors presenting the item from the Vendor-Item Relations Table (1100) and then, using the vendor table (1000), selects (1502) from such presenting vendors (1512) a vendor (1520) having a city name stored in the “Vendor_city” field in the vendor table that matches the purchaser's city. In so selecting, the deferred purchasing system typically reads the selected vendor's identification (1504) stored in the “Vendor_id” (1002) field in the vendor table, and utilizes the vendor identification when issuing the purchase order (122). In the event more than one presenting vendor operates in the same city as the purchaser, the deferred purchasing system typically utilizes other algorithms to complete the vendor selection. The deferred purchasing system in such a case may complete the process of selecting a vendor, for example by comparing vendor item prices (reference 1208 on FIG. 12) presented by vendors for an item, as recorded in the Vendor-Item Relations Table (1100 on FIG. 11), selecting the vendor presenting the lowest price for the item.

It is clear from our discussion of the examples illustrated in FIGS. 8, 12, 13, and 15, that deferred purchasing systems according to embodiments of the present invention identify vendors based on a variety of vendor identification criteria. For example, embodiments according to FIG. 12 identify vendors based on vendor item price criteria such that the deferred purchasing system utilizes algorithms based on vendor item prices (reference 1208 on FIG. 12). In another example, embodiments according to FIG. 13 identify vendors based on previous purchase order criteria such that the deferred purchasing system utilizes algorithms based on the purchaser's previous purchase orders (reference 1306 on FIG. 13) stored in the Purchase Order Table (1400). In another example, embodiments according to FIG. 15 identify vendors based on vendor proximity criteria such that the deferred purchasing system utilizes algorithms based on vendor location data (reference 1506 on FIG. 15) stored in the vendor table (1000).

In some such embodiments, and as illustrated in FIG. 15, identifying a vendor includes receiving such (1517) vendor identification criteria (1518) from the purchaser (108), and identifying (116) a vendor in dependence upon the vendor identification criteria. For example, as discussed with respect to FIG. 15 above, the deferred purchasing system prompts the purchaser for input as to whether the selection of the vendor should be based on, or limited by, the vendors' locations, as represented by vendor location data (1506) in the vendor table (1000).

Another example is shown in FIG. 12, wherein the vendor identification criteria is the vendor item price (1208). In some embodiments according to FIG. 12, the deferred purchasing system audibly prompts the purchaser for input as to whether the purchaser wants the deferred purchasing system to identify a vendor by selecting (1202) a vendor (1204,1212) having the lowest vendor item price. A typical audible menu prompt includes prompts such as:
If you wish to have a vendor chosen on the basis of the lowest vendor price for the item, press 1, if not, press 2.

Typically, the deferred purchasing system records the purchaser's inputted response as data in the DPR record. In such embodiments, if the purchaser inputs a “2” on the telephone keypad, the deferred purchasing system does not use the vendor item price as vendor identification criteria. If the purchaser inputs a “1,” the deferred purchasing system identifies vendors based on the received vendor identification criteria—in this example the vendor item price criteria.

In other embodiments, the deferred purchasing system is typically programmed to include vendor identification criteria without receiving such criteria from the purchaser. In some embodiments, for example, the deferred purchasing system automatically identifies a vendor, by first finding vendors that present the item, then selecting from the presenting vendors those vendors that present the lowest vendor item price, then, if necessary, selecting the vendor in closest proximity to the purchaser. Persons of skill in the art will immediately recognize that the order of priority for the various vendor identification criteria is readily reorderable to suit the preferences of a deferred purchasing system administrator, and that the deferred purchasing system, in some embodiments, automatically combines vendor identification criteria from both the purchaser and the deferred purchasing system administrator.

This disclosure discusses many examples of communications with purchasers in terms of telecommunications, that is, automated audible menus, telephone keypad input from purchasers, and so on. FIG. 7 depicts a data communications architecture in which a telecommunications server (702) implements either a Jain SLEE environment (704) or a Parlay environment (706) for telecommunications with both purchasers (108) and vendors (114). As described earlier, it is, for example a Java object operating in a Java SLEE environment that implements the user interface (110 on FIG. 15, for example). The user interface (110) is a combination of software and computer hardware, such as a Jain SLEE environment running on a telecom server, that prompts purchasers with audible menus and accepts purchaser response in the form of keypad inputs or voice recognition.

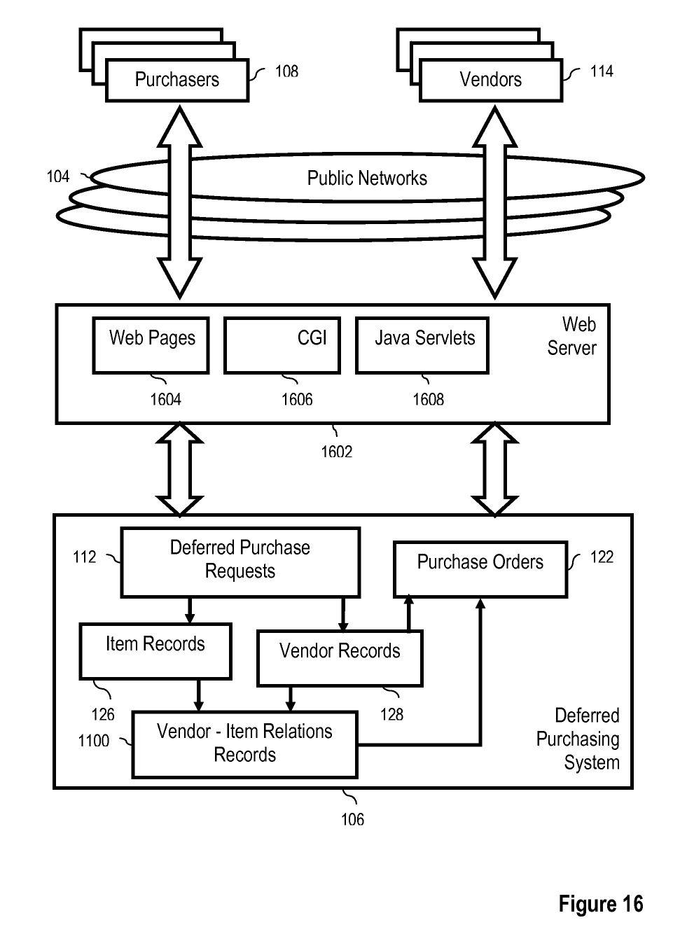

In some embodiments, as shown in FIG. 16, a deferred purchasing system (106) operates in conjunction with a web server having a conventional web site address publicly accessible by purchasers (108) and vendors (114). The purchaser's DCE (109 on FIG. 15, for example) is a computer system having a browser, monitor, mouse and keyboard. In this kind of embodiment, the public network (104) is an internet protocol network, and the user interface (110) includes a set of web pages, HTML documents and forms, communicated between a web server and a purchaser in HTTP messages. In such embodiments, receiving (102) a DPR (112) includes receiving data for a DPR in an HTTP message from a purchaser's browser. In such embodiments, access to data and to functions within a deferred purchasing system (106) is typically accomplished through CGI gateway programs (1606) or Java servlets (1608).

In such web-based embodiments and with further respect to embodiments of the kind shown in FIG. 12, the deferred purchasing system, in addition to typical access authorization messages, typically presents as a visible message on the purchaser's monitor, a web page displayed through the purchaser's browser, such as, for example:
If you have a preference as to the method by which a vendor will be selected to fill your deferred purchase request, please click on one of the following listed methods:
   Select a vendor based on the lowest price presented
   Select a vendor that operates in my country
   Select a vendor that operates in my state
   Select a vendor that operates in my city
   Select a vendor that operates in my zip code area
   Select a vendor that I have used in previous purchases through this deferred purchasing system
   Exclude vendors for which previous transactions with me were cancelled

Typically, a deferred purchasing system according to such an embodiment records the purchaser's inputted response as data in a DPR record (112). In such embodiments, after the purchaser has clicked on the desired vendor identification criteria, and upon receipt by the deferred purchasing system web server of the purchaser's selection, the deferred purchasing system is programmed to utilize such criteria to identify a vendor for the deferred purchase. For example, if the purchaser clicks “Select a vendor that operates in my city,” the deferred purchasing system typically finds, from location data in the vendor table (1000), all vendors located within the purchaser's city, and then selects one of such vendors that presents the item.

This disclosure describes in detail many alternative aspects and exemplary embodiments of the present invention, but it should be clear to readers that there are many, many more alternatives that can be embodied within the scope of the present invention. Additional alternatives include, for example, providing a purchaser with an option to select a new vendor before the issue data of a DPR. Deferred purchase systems may advantageously be expanded to include tracking of vendor discounts, discount coupon availability, promotional offers, and the like, at least some of which may become effective during the period between receipt of a DPR and the DPR's issue date. Such deferred purchasing systems can include scanning a promotions database or table keyed with vendor identification, linking vendor_ids from the promotions table to DPRs having identified vendors, and transmitting to the purchasers from whom the DPRs were received announcements or invitations to take advantage of promotional offers. Alternatively, such deferred purchasing systems, upon discovering a promotional offer that results in a lower overall purchase price for a DPR for a particular vendor, can be programmed to automatically assert the promotion on behalf of the purchaser identified in the DPR, all in accordance with one or more predefined algorithms.

Alternatively, a deferred purchasing system may be expanded to take advantage of a promotional offer from a second vendor, that is, a vendor other than a first vendor already identified to a DPR. Such a deferred purchasing system may, for example, scan a promotions table for vendor_ids, link the vendor_ids to a vendor-item relations table, then send promotions accouncements to purchasers from whom DPRs were received for items associated with new promotions, giving, for example, such purchasers an option to change vendors. Alternatively, such deferred purchasing systems, upon discovering a promotion that results in a lower overall purchase price can be programmed to change vendors for a DPR according to one or more predefined algorithms.

Alternatively, a deferred purchasing can be expanded to respond appropriately to changes in vendor status, particularly an eventuality that a vendor can go out of business. Such deferred purchasing systems can advantageously be programmed to query vendors for operational status, inform affected purchasers of pertinent changes in vendor operational status, allow purchasers to choose alternate vendors as needed, and automatically select alternative vendors according to predetermined criteria such as, for example, price range, location, and so on.

Web-based user interfaces thus are alternatives to Parlay or Jain SLEE interfaces. Although FIGS. 7 and 16 respectively show telecommunications (702) and web-based communications (1602) with both purchasers (108) and vendors (114), there is no limitation in the invention itself regarding the architectures of such communications. More particularly, it is entirely within the scope of the invention for a deferred purchasing system to implement telephone menus for accepting DPRs from purchasers and web-based email for issuing purchase order to vendors. It is entirely within the scope of the invention for a deferred purchasing system to implement a web site for accepting DPRs from purchasers and issue purchase orders to vendors with automated telephone messages, and so on, including any data communications architecture as will occur to those of skill in the art.

Although the embodiments of the present invention have been described to a large extent using Parlay for telephonic user interactions with the deferred purchasing system, persons skilled in the art will recognize that such embodiments are suitably utilized in a SLEE environment as well. Both JAIN API in a SLEE environment, and the Parlay OSA API, establish a user-interface for a purchaser that provides the interaction necessary to present a variety of optional purchasing strategies to the purchaser, while prompting audibly or visibly as needed to acquire input from the purchaser. The input from the purchaser provides the data needed to create the record containing the DPR, the DPR record then being available for use with regard to payment information verification, pre-issue notifications to vendors and purchasers, determinations of purchaser proximity to potential vendors, purchaser preferences as to vendor identification criteria, and other features shown to be provided in the various embodiments of the invention.

By this point in our discussion readers clearly understand the benefits to business organizations in using various embodiments of the present invention. In particular, delayed purchase requests are supplied from a provider, such as a telephone company or an internet service provider, to any company or organization that provides telephone ordering, thereby allowing a delayed purchasing service provide cross-enterprise inventory purchasing and other supply chain functions, while providing a valued service to subscribers or providers' services generally.

### Vendor Selection Through Vendor Bidding

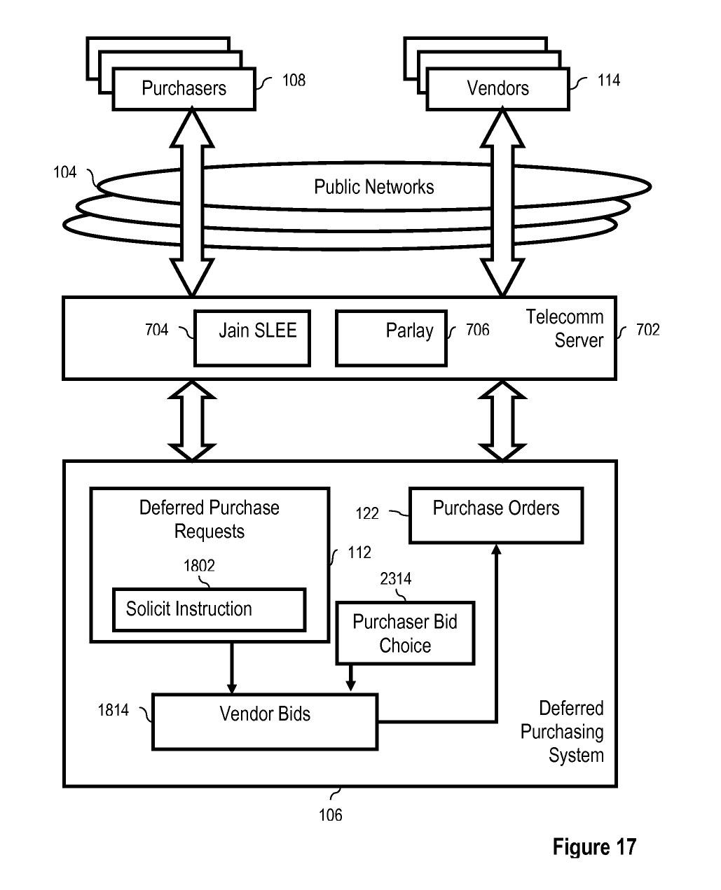

FIG. 17 sets forth a block diagram depicting a further example of an overall structure of a deferred purchasing system according to an exemplary embodiment of the present invention. A deferred purchasing system according to FIG. 17 accepts from purchasers (108) deferred purchase requests (112) (“DPRs”) through public networks (104) into the deferred purchasing system (106). Embodiments of this kind include vendor bids (1814) solicited from vendors (114), the successful vendor bid providing a basis for the selection of the vendor to whom a purchase order (122) will be issued. Embodiments of the kind shown in FIG. 17 include bid solicitation instructions (1802) received from the purchaser, the instruction indicating that the purchaser desires the solicitation of vendor bids. Additional embodiments according to FIG. 17 include a purchaser bid choice (2314) indicating which of the received vendor bids the purchaser has chosen.

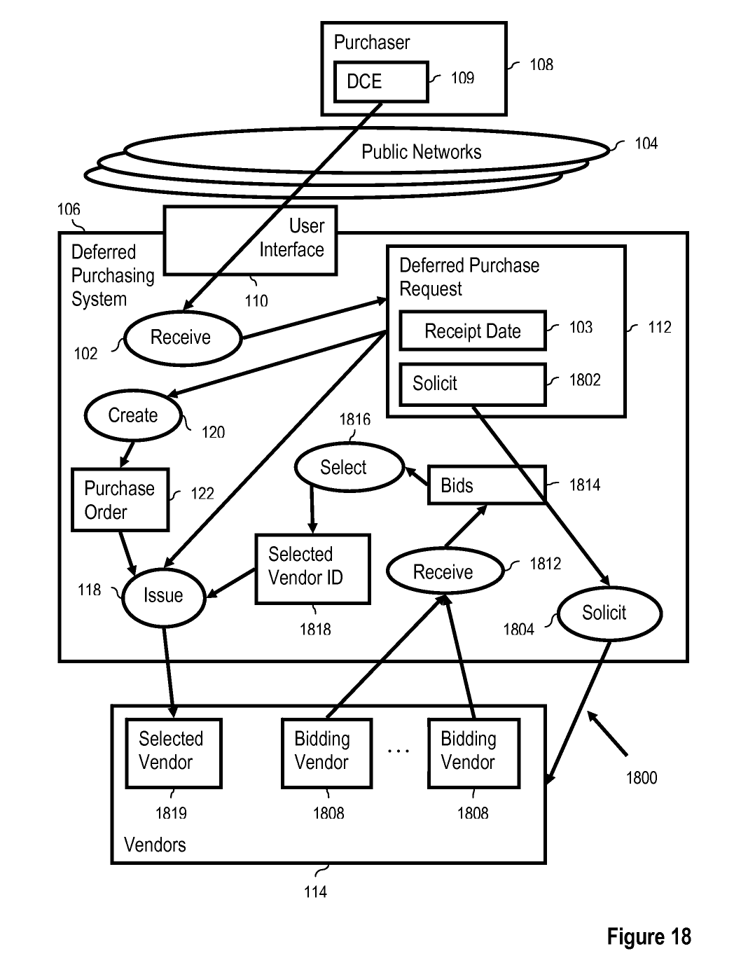

FIG. 18 sets forth a data flow diagram depicting an additional exemplary embodiment (1800) of the present invention as a method for operating a publicly accessible deferred purchasing system. Embodiments of the kind shown in FIG. 18 include receiving (102), on a receipt date (103), in a publicly accessible (104) deferred purchasing system (106), from a purchaser (108) through a user-interface (110), a deferred purchase request (“DPR”) (112) for an item to be purchased. Typical embodiments include soliciting (1804) at least one bid (1814) from at least one vendor (114), receiving (1812) at least one bid (1814) from one or more bidding vendors (1808), selecting (1816) a vendor (1818,1819) in dependence upon the at least one received bid, and issuing (118), in dependence upon the DPR (112), a purchase order (122) to the selected vendor (1819) on a date subsequent to the receipt date (103).

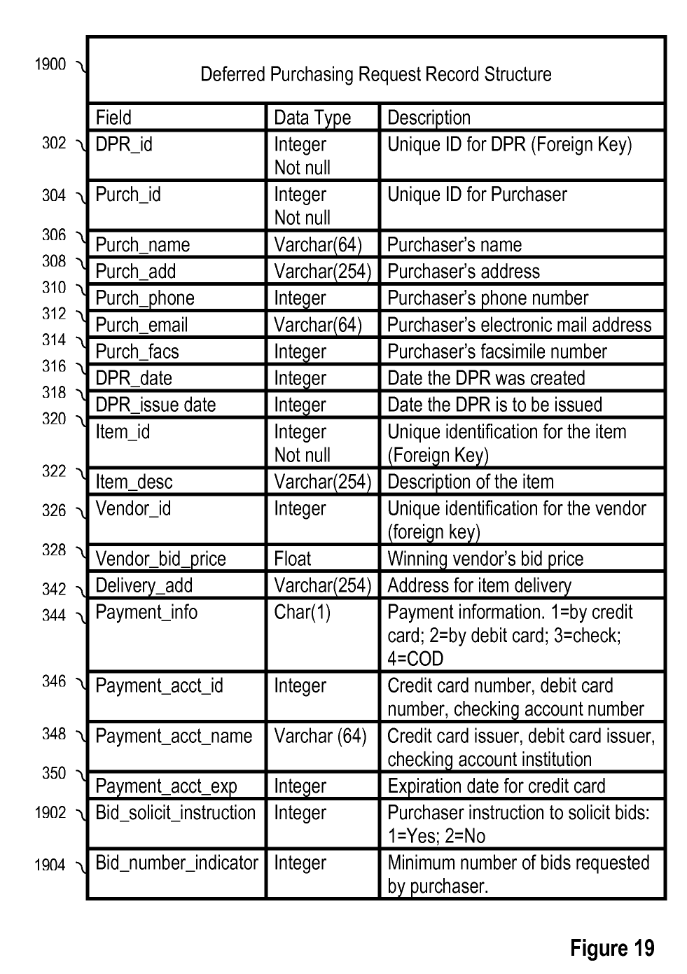

In purchasing systems utilizing methods of the kind shown in FIG. 18, receiving (102) a DPR (112) includes a purchaser's accessing the deferred purchasing system (106) by placing a telephone call to the deferred purchasing system. In the example of access through telephone, the public network (104) is typically a Public Switched Telephone Network (“PSTN”) and the purchaser's data communications equipment or “DCE” (109) is a telephone handset. In the example of telephone access, receiving (102) a DPR (112) is carried out through use of a telecommunications execution environment, such as, for example, Parlay (reference 706 on FIG. 7). More particularly, for example, a Parlay server establishes a call and creates a Parlay user interaction object for a user interaction with the purchaser. In such an example the user interaction object communicates an audible menu to the purchaser, the menu comprising prompts for a series of purchaser inputs from the purchaser's telephone keypad. The user interaction object is capable of reading item records, such as those depicted in FIG. 9, for example, and communicating to a purchaser the item identifications of items available for purchase through a deferred purchasing system. In such a case, the deferred purchasing system receives the purchaser inputs and stores at least some of the purchaser inputs as data in a DPR (112). A detailed example of a data structure for DPRs useful in embodiments according to FIG. 18 is set forth in FIG. 19.

In embodiments of the kind shown in FIG. 18, a DPR (112) typically includes an instruction from the purchaser (108) for a deferred purchasing system to solicit bids. In such embodiments the deferred purchasing system prompts the purchaser to input an indication as to whether the purchaser wants the deferred purchasing system to solicit bids from vendors (114). For example, the deferred purchasing system typically prompts the purchaser with an audible prompt such as:
Please indicate whether you desire vendors to bid on the opportunity to provide the item you have chosen. Press 1, if you do desire vendor bidding, or 2 if you do not.
   Your Choice (1/2): ______

A deferred purchasing system according to FIG. 18 typically records a purchaser's inputted response as data in a DPR record (112). In this regard, the DPR data structure illustrated in FIG. 19 includes, for storage of the inputted response, a “Bid_solicit_instruction” field (1902). In such embodiments, if the purchaser responds by pressing “2,” the deferred purchasing system selects from vendors presenting the item without soliciting bids. If the purchaser responds by pressing “1,” the deferred purchasing system responds to the affirmative indication by locating from the Vendor-Item Relations Table (reference 1100 on FIG. 11) the vendors presenting the item, finding the information necessary to communicate a bid solicitation to the presenting vendors from the related vendor table (reference 1000 on FIG. 10), and soliciting (1804) bids (1814) from the presenting vendors.

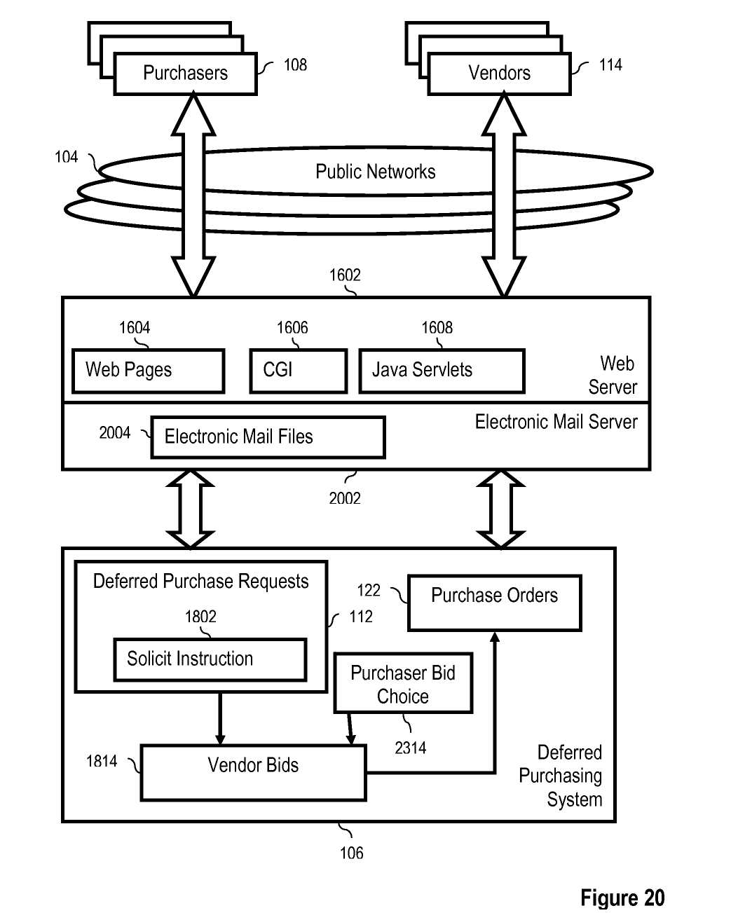

In embodiments according to FIG. 18, a deferred purchasing system typically solicits (1804) bids from the presenting vendors by communicating through publicly accessible networks (104). For example, the deferred purchasing system may solicit a bid from a vendor by electronic mail, utilizing the electronic mail address stored in the “Vendor_email” field (reference 1010 on FIG. 10) of the vendor table (reference 1000 on FIG. 10). In this regard, the deferred purchasing system operates in conjunction with a mail server (reference 2004 on FIG. 20) having a conventional electronic mail address, and the vendors (114) typically have DCE including a mail server (reference 2002 on FIG. 20), monitor, mouse and keyboard.

In such embodiments, and as illustrated in FIG. 20, the public network (104) for communications between the deferred purchasing system (106) and the bidding vendors (114) is an internet protocol network, and a vendor interface includes the deferred purchasing system electronic mail files received by the vendor and viewed on the vendor's monitor and the electronic mail files received and viewed or read by the deferred purchasing system. For such embodiments, soliciting (reference 1804 on FIG. 18) and receiving (reference 1812 on FIG. 18) a bid (reference 1814 on FIG. 18) from the vendor includes sending and receiving data in electronic mail messages communicated through email protocols such as, for example, SMTP, POP, or IMAP.

In embodiments of the kind shown in FIG. 18, wherein a deferred purchasing system solicits (1804) bids from vendors by utilizing electronic mail, deferred purchasing systems according to embodiments of the present invention typically merge DPR identification data stored in the “DPR_id” field (reference 302 on FIG. 19) of the DPR record (112), item identification data stored in the “Item_id” field (reference 320 on FIG. 19) of the DPR record, item description data stored in the “Item_desc” field (reference 322 on FIG. 19) of the DPR record, item weight data stored in the “Item_weight” field (reference 908 on FIG. 9) of the Item Table (reference 900 on FIG. 9), purchaser address data stored in the “Purch_add” field (reference 308 on FIG. 19), and a textual message, into an electronic mail file such as, for example:

We are soliciting bids from vendors with respect to the Deferred Purchasing Request identified below. If you desire to submit a bid for the item described below please reply to this email and state your total price, including all shipping, handling and taxes, by first entering the DPR identification number, followed by your total price, in the subject line. Please respond within three business days.

| | |
|---|---|
| DPR identification: | DPR123456 |
| Item identification: | I789ABC |
| Item description: | Brand X Camcorder, Model XYZ |
| Item weight: | 2 pounds, 8 ounces |
| Purchaser Address: | Anywhere, Texas, 99999, USA |

In such embodiments a deferred purchasing system mail server typically transfers this electronic mail file across an internet protocol network utilizing SMTP, and the presenting vendors receive the electronic mail file through their respective SMTP mail servers.

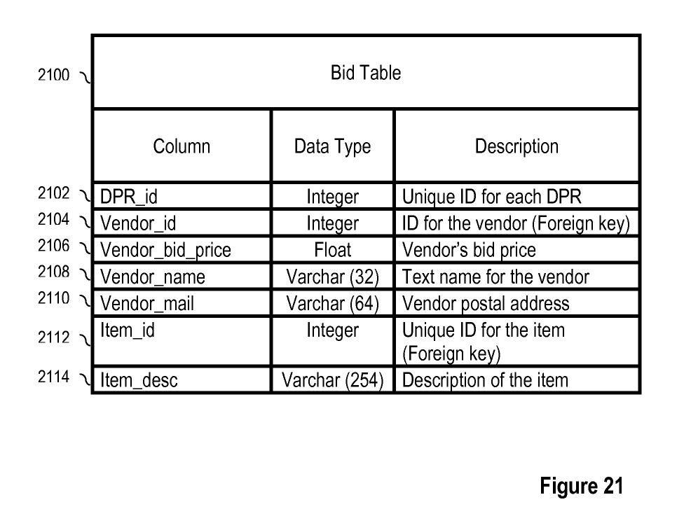

In embodiments according to FIG. 18, wherein a deferred purchasing system solicits (1804) bids (1814) from presenting vendors by sending the foregoing electronic mail file, all or some of the presenting vendors (1808) submit a bid (1814), as requested, by entering the DPR identification and then the total bid price in a “Subject” line, and then sending the reply. In such embodiments, the deferred purchasing system receives (1804) the electronic mail file through the deferred purchasing system SMTP mail server, and is typically programmed to read the data in the subject line and parse the subject line data to store, in a bid record in a Bid Table, the DPR identification data and the bid price data. In typical embodiments of the kind shown in FIG. 18, the Bid Table has a data structure of the kind described at reference (2100) in FIG. 21, with each record in the Bid Table (2100) representing one vendor bid (1814), the deferred purchasing system storing a DPR identification in a “DPR_id” field (2102), a bidding vendor identification in a “Vendor_id” field (2104), a bidding vendor bid price in a “Vendor_bid_price” field (2106), a bidding vendor name in a “Vendor_name” field (2108), a bidding vendor address in a “Vendor_address” field (2110), an item identification in an “Item_id” field (2112), and an item description in an “Item_desc” field (2114).

In embodiments of the kind shown in FIG. 18, in which a deferred purchasing system receives (1812) the foregoing electronic mail file reply and reads and parses the “Subject” line data, the deferred purchasing system is typically programmed to then read vendor email address data present in the “From” line of the electronic mail file reply. By then searching a vendor table (reference 1000 on FIG. 10), the deferred purchasing system locates a vendor identification, vendor name, and vendor address associated with the vendor email address in a record in the vendor table for the bidding vendor (1808). In such embodiments the deferred purchasing system typically stores, in the bid record in the Bid Table (2100), the located vendor identification in the “Vendor_id” field (2104), the located vendor name in the “Vendor_name” field (2108), and the located vendor address in the “Vendor_address” field (2110). Similarly, the deferred purchasing system typically locates an item identification and an item description utilizing the DPR identification read from the “Subject” line of the electronic mail reply in conjunction with the item identification and item description associated with the DPR identification in the DPR record (reference 1900 on FIG. 19). The item identification so located is then typically stored in the “Item_id” field (2112) of the Bid Table (2100), and the item description is typically stored in the “Item_desc” field (2114) of the Bid Table.

In some embodiments according to FIG. 18, in which a deferred purchasing system receives (1812) a bid (1814) as an electronic mail file reply and stores data from such electronic mail file in a bid record in the Bid Table (2100), the deferred purchasing system is typically programmed to select (1816) from the accumulated bid records for all bidding vendors (1808) a selected vendor (1819) having the winning bid (1814), and store the selected vendor identification (1818) in the “Vendor_id” field (reference 326 on FIG. 19) of the DPR record (112). In such embodiments the winning bid (1814) is determined utilizing various algorithms, including algorithms that determine the winning bid based on the lowest vendor bid price. In other embodiments, the deferred purchasing system utilizes algorithms that determine the winning bid by first finding vendors among such bidding vendors (1808) who have addresses that satisfy proximity criteria (as discussed with respect to FIG. 15) and then choosing from such bidding vendors, the vendor having the bid containing the lowest vendor bid price.

In still other embodiments of the kind shown in FIG. 18, wherein a deferred purchasing system locates presenting vendors in a Vendor-Item Relations Table (1100), the deferred purchasing system is typically programmed to solicit (1804) bids (1814) only from such presenting vendors that have an acceptable purchase order history with the purchaser. As discussed with regard to FIG. 13, a Purchase Order Table (reference 1400 on FIG. 14) is typically utilized by the deferred purchasing system for determining if a particular vendor has previously completed a purchase order (122) for a particular purchaser. For example, if a record in the Purchase Order Table (1400) includes both the purchaser and the vendor, the deferred purchasing system typically reads the “Purchase_order_history” field (1408), and if a “2” is read from the field, the presenting vendor and the purchaser have a terminated transaction based on a previous purchase order. When such is the case, the deferred purchasing system is typically programmed to exclude the vendor from the presenting vendors from whom bids will be solicited.

In embodiments of the kind illustrated in FIG. 18, wherein a deferred purchasing system selects (1816) a selected vendor (1819) based on the selected vendor's bid (1814) and stores the selected vendor identification (1818) in the DPR record (112), the deferred purchasing system, on a date subsequent to receiving (102) the DPR, typically creates (120) a purchase order (122) and issues (118) the purchase order to the selected vendor utilizing the vendor identification in the DPR record.

In additional embodiments of the kind illustrated in FIG. 18, a deferred purchasing system solicits (1804) bids (1814) from vendors by utilizing electronic mail, the deferred purchasing system typically merging DPR identification data stored in the “DPR_id” field (reference 302 on FIG. 19) of the DPR record (112), item identification data stored in the “Item_id” field (reference 320 on FIG. 19) of the DPR record, item description data stored in the “Item_desc” field (reference 322 on FIG. 19) of the DPR record, item weight data stored in the “Item_weight” field (reference 908 on FIG. 9) of the Item Table (reference 900 on FIG. 9), purchaser address data stored in the “Purch_add” field (reference 308 on FIG. 19), and a textual message, into an electronic mail file (reference 2004 on FIG. 20) such as, for example:

We are soliciting bids from vendors with respect to the Deferred Purchase Request identified below. If you desire to submit a bid for the item described below please click on the “Go To Bidding Web Site” link below. Please respond within three business days.

| | |
|---|---|
| DPR identification: | DPR123456 |
| Item identification: | I789ABC |
| Item description: | Brand X Camcorder, Model XYZ |
| Item weight: | 2 pounds, 8 ounces |
| Purchaser Address: | Anywhere, Texas, 99999, USA |

### Go to Bidding Web Site

In such embodiments a deferred purchasing system mail server (reference 2002 on FIG. 20) typically transfers this electronic mail file across an internet protocol network utilizing SMTP, and presenting vendors receive the electronic mail file through their respective SMTP mail servers. In this regard, the deferred purchasing system operates in conjunction with a web server (reference 1602 on FIG. 20) having a conventional web site, and the vendors (114) typically have DCE including a web browser, monitor, mouse and keyboard. In such embodiments, and as illustrated in FIG. 20, the public network (104) for communications between the deferred purchasing system (106) and the bidding vendors (114) is an internet protocol network, and a vendor interface includes a set of web pages (1604), HTML documents and forms, communicated between a web server and a vendor in HTTP messages. For such embodiments, soliciting (1804) and receiving (1812) a bid (1814) from the vendor includes sending data in SMTP electronic mail files to the vendor's mail server, and sending and receiving HTTP messages to and from the vendor's browser. Deferred purchasing systems according to such embodiments typically implement access to data and functions within such systems by use of CGI gateway programs (1606) or Java servlets (1608).

In embodiments according to FIG. 18, wherein the foregoing electronic mail file with a web site link is utilized, the bidding vendor (1808) clicks on the link and is connected with a deferred purchasing system web site, where the deferred purchasing system typically presents as a visible message on the vendor's monitor, a web page displayed through the vendor's browser, such as, for example:

Thank you for your interest in bidding on the Deferred Purchase Request identified below. Please enter your bid, in the form of a total price (including all shipping, handling and taxes) in the space provided, and click on the “CONTINUE” button.

| | |
|---|---|
| DPR identification: | DPR123456 |
| Item identification: | I789ABC |
| Item description: | Brand X Camcorder, Model XYZ |
| Item weight: | 2 pounds, 8 ounces |
| Purchaser Address: | Anywhere, Texas, 99999, USA |

YOUR BID IS: $
CONTINUE

A deferred purchasing system according to such embodiments typically records the bidding vendor's (1808) inputted response as data in the “Vendor_bid_price” field (2106) of a bid record in a Bid Table (2100). In such embodiments, at some time after the vendor has entered the vendor bid price and clicked the “Continue” button, and after receipt by the deferred purchasing system web server of the vendor's bid (1814), the deferred purchasing system is programmed to utilize an algorithm for selecting (1816) a selected vendor (1818,1819) based on the bids (1814) recorded as bid records in the Bid Table.

In additional embodiments according to FIG. 18, in which a deferred purchasing system solicits (1804) bids (1814) from the presenting vendors by communicating through publicly accessible networks (104), the deferred purchasing system may solicit a bid from a vendor by telephone, utilizing the vendor's telephone number stored in the “Vendor_phone” field (reference 1006 on FIG. 10) of the vendor table (reference 1000 on FIG. 10). FIG. 17 depicts a data communications architecture in which a telecommunications server (702) implements either a Jain SLEE environment (704) or a Parlay environment (706) for telecommunications with vendors (114). In some embodiments according to FIG. 17, a Java object operating in a Java SLEE environment implements a user interface between the deferred purchasing system and the vendor. The user interface is a combination of software and computer hardware, such as a Jain SLEE environment running on a telecom server, that prompts vendors with audible menus and accepts vendor responses in the form of keypad inputs or voice recognition. For such embodiments, soliciting (reference 1804 on FIG. 18) and receiving (1812, FIG. 18) a bid (1814, FIG. 18) from the vendor includes sending and receiving data through the user interface.

In embodiments of the kind shown in FIG. 18, wherein the deferred purchasing system solicits (1804) bids for a DPR (112) from presenting vendors by utilizing a telephone call, the deferred purchasing system is typically programmed to include DPR identification data stored in the “DPR_id” field (reference 302 on FIG. 19) of the DPR record, item identification data stored in the “Item_id” field (reference 320 on FIG. 19) of the DPR record, item description data stored in the “Item_desc” field (reference 322 on FIG. 19) of the DPR record, item weight data stored in the “Item_weight” field (reference 908 on FIG. 9) of an Item Table (reference 900 on FIG. 9), purchaser address data stored in the “Purch_add” field (reference 308 on FIG. 19), and an audible message, in a pre-recorded telephone message file such as, for example:
We are soliciting bids from vendors with respect to Deferred Purchasing Request No. DPR123456 for a Brand X Camcorder, Model XYZ. If you desire to submit a bid for this item please continue listening to the remaining information and respond by speaking or using your telephone keypad when requested.
The Item Identification number for the item is I789ABC, the item weight is 2 pounds, 8 ounces, the purchaser address is Anywhere, Texas, 99999, United States.
If you wish to submit a bid, speak or press 1 followed by the bid, in the form of a total price, including all shipping, handling and taxes. If you do not wish to bid, speak or press 2.

A deferred purchasing system according to such embodiments typically creates a record in a Bid Table (reference 2100 on FIG. 21) for a bidding vendor's (1808) affirmative response, and stores the DPR identification data in a “DPR_id” field (2102), the bid price in the “Vendor_bid_price” field (2106), and vendor identification data for the bidding vendor in the “Vendor_id” field (2104). In typical embodiments of the kind shown in FIG. 18, the Bid Table includes a bid record for each bidding vendor who has affirmatively responded to the foregoing audible message prompt.

In embodiments of the kind shown in FIG. 18, wherein the deferred purchasing system receives (1812) the vendor's inputted response to the audible prompts, the deferred purchasing system is typically programmed to select (1816) from the accumulated bid records for all bidding vendors (1808) a selected vendor (1819) having the winning bid (1814), and store the selected vendor identification (1818) in the “Vendor_id” field (reference 326 on FIG. 19) of the DPR record (112). In such embodiments the winning bid (1814) is determined utilizing various algorithms, including algorithms that determine the winning bid based on the lowest vendor bid price.

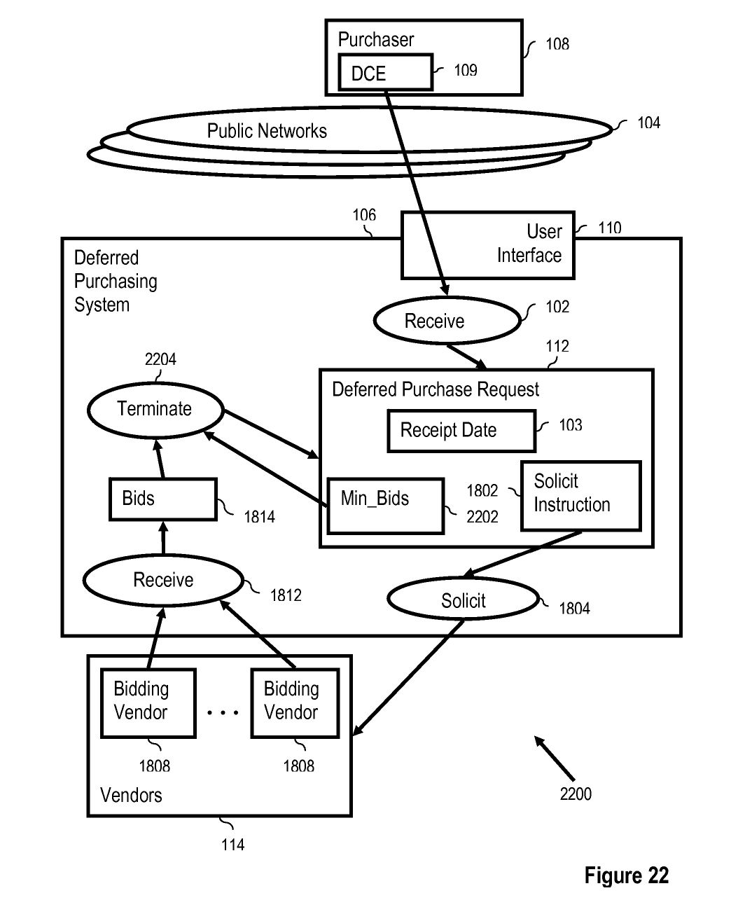

FIG. 22 sets forth a data flow diagram illustrating additional exemplary embodiments of the present invention wherein a DPR (112) includes both a solicitation instruction (1802) and an indication (2202) of the minimum number of bids (1814) that is acceptable to the purchaser (108). In such embodiments a deferred purchasing system typically prompts the purchaser to input an indication as to whether a purchaser wants the deferred purchasing system to solicit bids from vendors (114). For example, the deferred purchasing system typically prompts the purchaser with an audible prompt such as, for example:
Please indicate whether you desire vendors to bid on the opportunity to provide the item you have chosen, by pressing 1, if you do desire vendor bidding, or 2 if you do not.

A deferred purchasing system according to FIG. 18 typically records a purchaser's inputted response as data in a DPR record (112). In this regard, the DPR data structure illustrated in FIG. 19 includes, for storage of the inputted response, a “Bid_solicit_instruction” field (1902). In such embodiments, if the purchaser responds by pressing “2,” the deferred purchasing system selects from vendors presenting the item with no bids solicited. If the purchaser responds by pressing “1,” the deferred purchasing system responds to the affirmative indication by prompting the purchaser with an additional message, such as, for example:
You have chosen to have bids solicited from vendors with respect to your Deferred Purchase Request. You have the option of specifying the minimum number of bids which you consider sufficient for the bidding process. If the number of received bids is less than this number no purchase order will be issued at the future date. Please indicate the minimum number of bids which you considered sufficient for the bidding process by using your telephone keypad to enter the minimum number, or press zero if you have no preference as to a minimum number of bids.

A deferred purchasing system according to FIG. 18 typically records a purchaser's inputted response as data in the DPR record (112). In this regard, the DPR data structure illustrated in FIG. 19 includes, for storage of the inputted response, a “Bid_number_indicator” field (1904). In such embodiments, if the purchaser responds by pressing “0,” the deferred purchasing system solicits (1804) bids (1814) from presenting vendors, and receives (1812) bids from one or more bidding vendors (1808) presenting the item and selects (1816) a selected vendor (1819) from the bidding vendors with no minimum number of bids required. If the purchaser responds by pressing a number other than “0,” the deferred purchasing system, after storing data from each bidding vendor's subsequently received bid in a bid record in the Bid Table (2100), determines the number of bids from the Bid Table (2100) and terminates (2204) the DPR if the number is smaller than the non-zero minimum bid number entered.

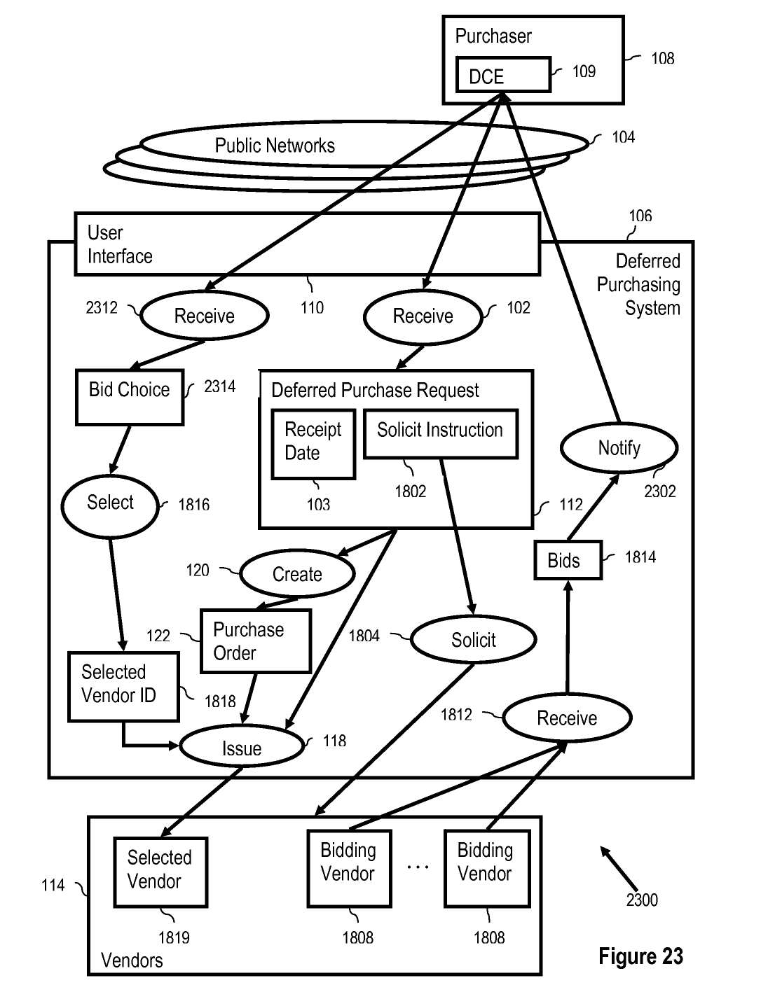

FIG. 23 sets forth a data flow diagram illustrating additional exemplary embodiments of the present invention in which a DPR (112) includes a solicitation instruction (1802) indicating that a purchaser (108) desires bidding by vendors (114) and the deferred purchasing system solicits (1804) bids (1814) from presenting vendors and receives (1812) bids from bidding vendors (1808). In such embodiments the deferred purchasing system typically stores, in a bid record in a Bid Table (2100) for each bidding vendor, a vendor identification in the “Vendor_id” field (2104), a vendor name in the “Vendor_name” field (2108), and a vendor bid price in the “Vendor_bid_price” field (2106), the deferred purchasing system notifying (2302) the purchaser of the received bids. In such embodiments the deferred purchasing system typically notifies the purchaser by creating an electronic mail file (reference 2004 on FIG. 20) that includes a DPR identification stored in the “DPR_id” field (reference 302 on FIG. 19) of the DPR record (112), item identification data stored in the “Item_id” field (reference 320 on FIG. 19) of the DPR record, item description data stored in the “Item_desc” field (reference 322 on FIG. 19) of the DPR record, and a textual message, such as, for example:
In response to your original instructions, we have solicited vendor bids with respect to your Deferred Purchasing Request No. DPR123456 for a Brand X Camcorder, Model XYZ (Item Identification No. I789ABC).
In order for you to choose from the vendor bids received please click on the “Go To Vendor Bid Review” link below.

### Go to Vendor Bid Review

A deferred purchasing system according to FIG. 23 typically utilizes a mail server (reference 2002 on FIG. 20) to transfer this electronic mail file across an internet protocol network utilizing SMTP, and the purchaser receives the electronic mail file through its SMTP mail server or electronic mail client. In this regard, the deferred purchasing system operates in conjunction with a web server (reference 1602 on FIG. 20) having a conventional web site, and the purchaser (108) typically has DCE (109) including a web browser, mail server (or mail client), monitor, mouse and keyboard. In such embodiments, and as illustrated in FIG. 20, the public network (104) for communications between the deferred purchasing system (106) and the purchasers (108) is an internet protocol network, and a user interface (110) includes a set of web pages (reference 1604 on FIG. 20), HTML documents and forms, communicated between a web server and a purchaser in HTTP messages. For such embodiments, notifying (2302) a purchaser of received vendor bids (1814) includes sending data in SMTP electronic mail files to the purchaser's mail server (or mail client), and sending and receiving HTTP messages to and from the purchaser's browser. Deferred purchasing systems according to such embodiments often implement access to data and functions within such systems by use of CGI gateway programs (1606) or Java servlets (1608).

In embodiments according to FIG. 23, wherein the foregoing electronic mail file with a web site link is utilized, the purchaser clicks on the link and is connected with a deferred purchasing system web site, through which the deferred purchasing system typically presents as a visible message on the purchaser's monitor, a web page displayed through the purchaser's browser, the web page including, for each bidding vendor, a vendor name from the “Vendor_name” field (reference 2108 on FIG. 21), and a vendor bid price from the “Vendor_bid_price” field (2106) of the bid record in the Bid Table (2100) in which is stored the bidding vendor's bid data. In such an example, the deferred purchasing system presents a web page such as:

With respect to your Deferred Purchasing Request No. DPR123456 for a Brand X Camcorder, Model XYZ (Item Identification No. I789ABC), we have received the following vendor bids:

| | |
|---|---|
| (First vendor name) | $350.00 |
| (Second vendor name) | $340.00 |
| (Third vendor name) | $375.00 |

Please choose the vendor bid which you desire by clicking on the vendor name shown next to the vendor bid price.

A deferred purchasing system according to such an embodiment typically receives (2312), in response to the web page prompt, a bid choice (2314) from the purchaser, and then selects (1816) a selected vendor (1819) by storing the selected vendor identification (1818) for the vendor submitting the bid (1814) so chosen by the purchaser. In such embodiments, the deferred purchasing system typically stores the selected vendor's identification (1818) in the “Vendor_id” field (reference 326 on FIG. 19) of the DPR record (112) and stores the vendor bid price from the chosen bid in a “Vendor_bid_price” field (reference 328 on FIG. 19) of the DPR record. In such a case, the deferred purchasing system later creates (120) and issues (118) a purchase order (122) for the item to the vendor whose bid is indicated in the purchaser's bid choice, and the purchase order includes the vendor bid price.

### Vendor Selection Through Vendor Access and Vendor Proposals

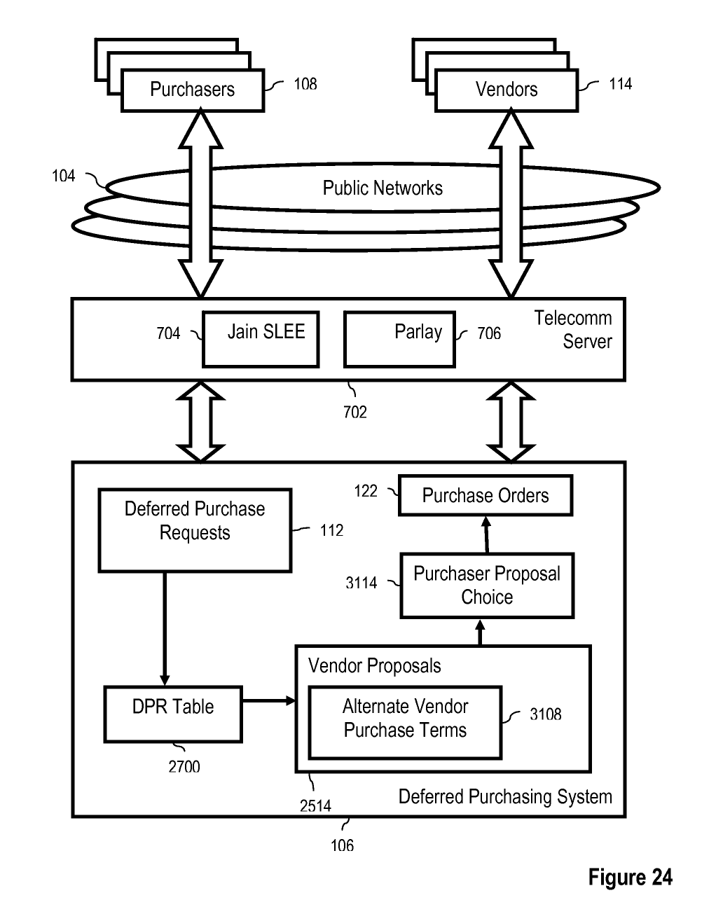

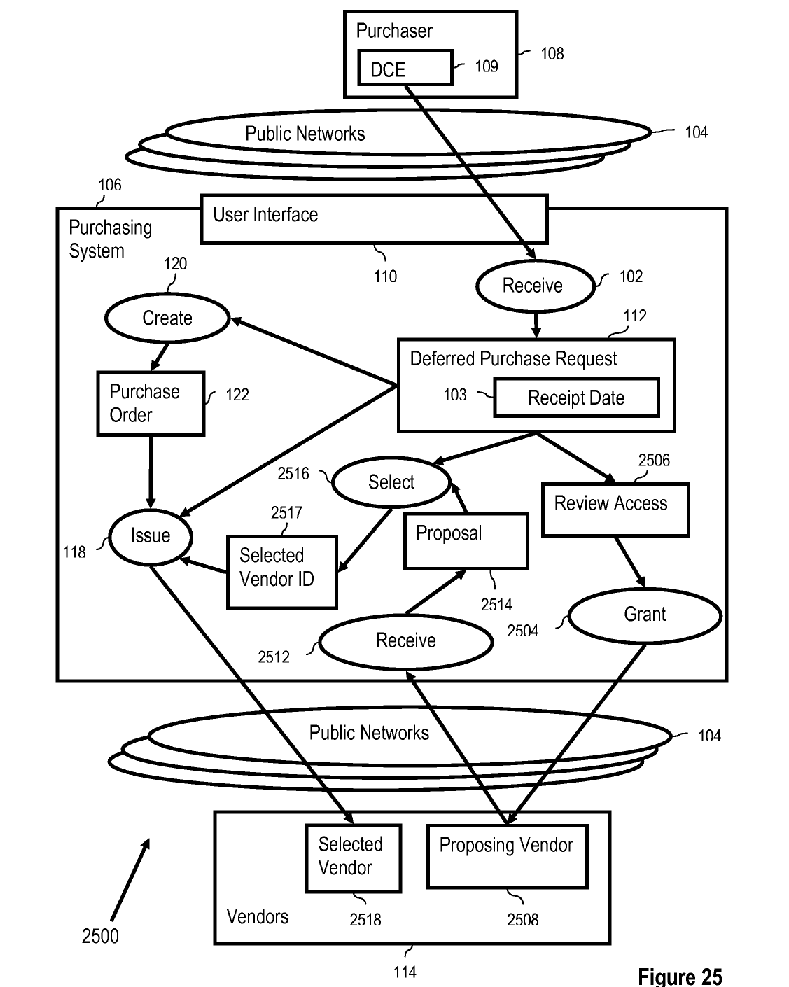

FIG. 24 sets forth a block diagram depicting a further example of an overall structure of a deferred purchasing system (106) according to an exemplary embodiment of the present invention. A deferred purchasing system according to FIG. 24 accepts from purchasers (108) deferred purchase requests (112) (“DPRs”) through public networks (104) into the deferred purchasing system. Embodiments of this kind include vendor proposals (2514) from vendors (114), based on vendor access to a Deferred Purchase Request Table (2700). The vendor proposals include alternate vendor purchase terms (3108). The vendor proposals provide a basis for the selection of the vendor to whom a purchase order (122) will be issued. Embodiments of the kind shown in FIG. 24 include a purchaser proposal choice (3114) indicating which of the vendor proposals the purchaser has chosen.

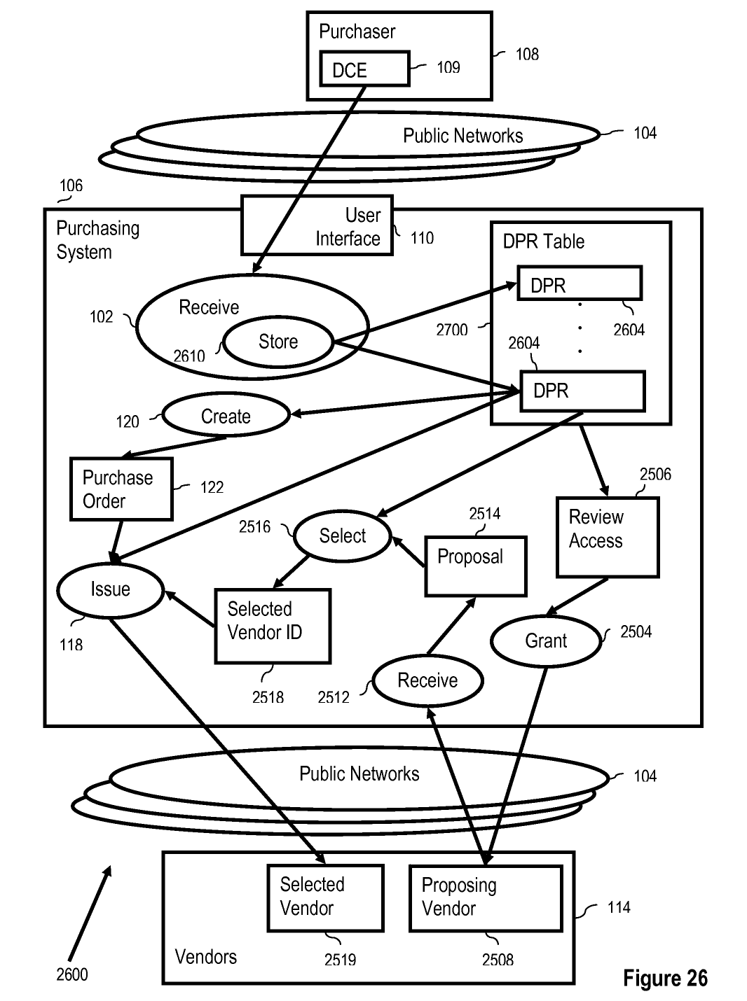

FIG. 25 sets forth a data flow diagram depicting an additional exemplary embodiment (2500) of the present invention as a method for operating a publicly accessible deferred purchasing system. Embodiments of the kind shown in FIG. 25 include receiving (102), on a receipt date (103), in a publicly accessible (104) deferred purchasing system (106), from a purchaser (108) through a user-interface (110), a deferred purchase request (“DPR”) (112) for an item to be purchased. Typical embodiments include granting (2504) review access (2506) to DPRs to at least one proposing vendor (2508), receiving (2512), from proposing vendors, at least one vendor proposal (2514) regarding a reviewed DPR, selecting (2516) a vendor (2518, FIG. 26, Reference 2519) in dependence upon the at least one received proposal, and issuing (118), in dependence upon the DPR (112), a purchase order (122) to the selected vendor (FIG. 26, Reference 2519) on a date subsequent to the receipt date (103).

In purchasing systems utilizing methods of the kind shown in FIG. 25, receiving (102) a DPR (112) includes a purchaser's accessing the deferred purchasing system (106) by placing a telephone call to the deferred purchasing system. In the example of access through telephone, the public network (104) is typically a Public Switched Telephone Network (“PSTN”) and the purchaser's data communications equipment or “DCE” (109) is a telephone handset. In the example of telephone access, receiving (102) a DPR (112) is carried out through use of a telecommunications execution environment, such as, for example, Parlay (FIG. 7, Reference 706). More particularly, for example, a Parlay server establishes a call and creates a Parlay user interaction object for a user interaction with the purchaser. In such an example the user interaction object communicates an audible menu to the purchaser, the menu comprising prompts for a series of purchaser inputs from the purchaser's telephone keypad. The user interaction object is capable of reading item records, such as those depicted in FIG. 9, for example, and communicating to a purchaser the item identifications of items available for purchase through a deferred purchasing system. In such a case, the deferred purchasing system receives the purchaser inputs and stores at least some of the purchaser inputs as data in a DPR (112).

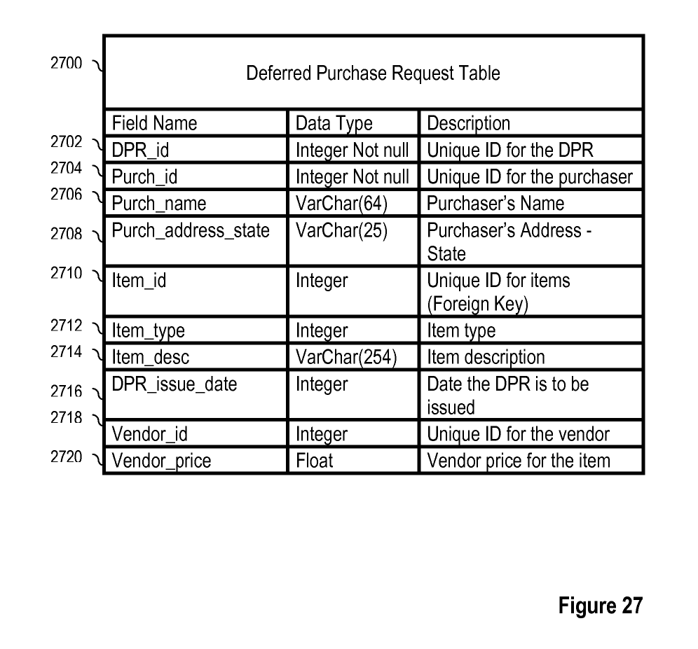

In purchasing systems utilizing methods of the kind shown in FIG. 25, and as further illustrated in the additional exemplary embodiment (2600) of FIG. 26, a plurality of DPRs (2604) are received (102) by a deferred purchasing system (106) and stored (2610) in a DPR Table (2700) having a data structure of the kind described at reference 2700 in FIG. 27, including DPR identification data in a “DPR_id” field (2702), purchaser identification data in a “Purch_id” field (2704), purchaser name data in a “Purch_name” field (2706), purchaser state data in a “Purch_address_state” field (2708), item identification data in an “Item_id” field (2710), item type data in an “Item_type” field (2712), item description data in an “Item_desc” field (2714), and DPR issue date data in a “DPR_issue_date” field (2716). In such embodiments each DPR is a record in the DPR Table, and granting (2504) review access (2506) includes granting review access to the DPR Table (2700). In additional exemplary embodiments, a DPR Table includes all or some of the additional DPR fields set forth in FIG. 3 and FIG. 19.

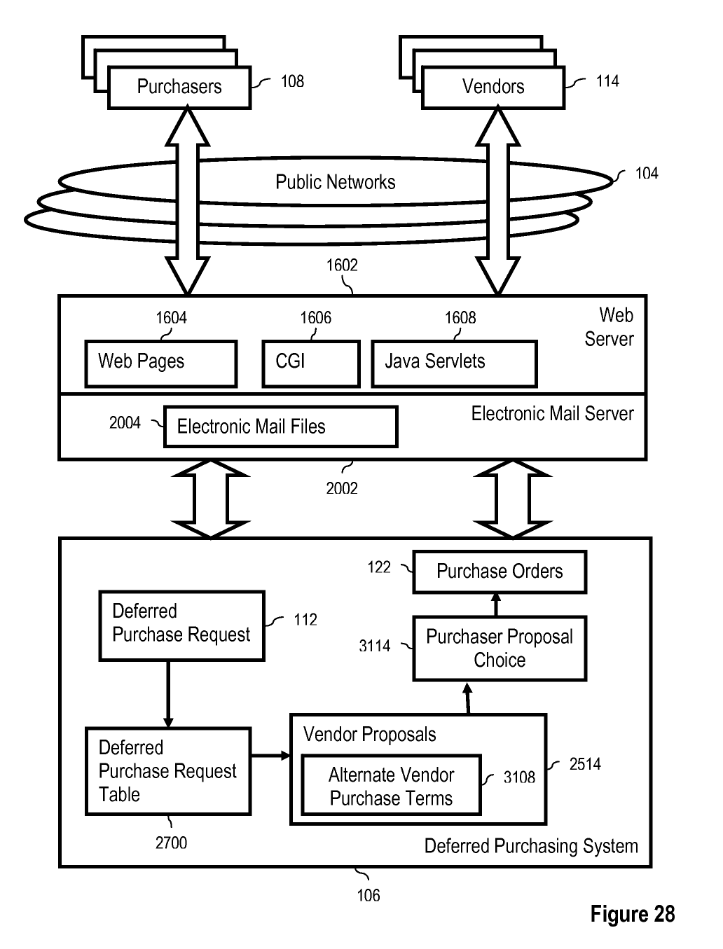

In embodiments of the kind shown in FIG. 26, a deferred purchasing system (106) typically provides DPR review access (2506) to vendors (114) by communicating through publicly accessible networks (104). In such embodiments the deferred purchasing system typically provides a web site accessible by vendors that desire DPR review access, and in this regard, the deferred purchasing system operates in conjunction with a web server (reference 1602 on FIG. 28) having a conventional web site, and the vendors (114) typically have DCE including a web browser, monitor, mouse and keyboard. In such embodiments, and as illustrated in FIG. 28, the public network (104) for communications between the deferred purchasing system (106) and the proposing vendors (114,2508) is an internet protocol network, and a vendor interface includes a set of web pages (1604), HTML documents and forms, communicated between a web server and a vendor in HTTP messages. For such embodiments, granting (2504) DPR review access (2506) to vendors includes sending and receiving HTTP messages to and from the vendor's browser. Deferred purchasing systems according to such embodiments typically implement access to data and functions within such systems by use of CGI gateway programs (1606) or Java servlets (1608).

In embodiments according to FIG. 26, wherein a deferred purchasing system (106) utilizes a web site for vendor DPR review access (2506), a vendor enters the deferred purchasing system web site address on the vendor's keyboard, and the deferred purchasing system typically presents a visible message on the vendor's monitor, such as, for example:
Please enter your vendor identification and password.

Following the purchaser's responsive entry of an authorized vendor identification and password, a deferred purchasing system typically presents, as a visible message on the vendor's monitor, a web page having an initial access menu displayed through the vendor's browser, such as, for example:
Thank you for your interest in submitting a proposal with regard to Deferred Purchase Requests accessible through this web site. Please choose the type of access that you desire at this time by clicking on one of the following:
   Access To All DPRs
   Access To DPRs By Item Type
   Access To DPRs By Item Identification
   Access To DPRs By Purchaser Name or Identification
   Access To DPRs Associated With Your Vendor Identification

In embodiments according to FIG. 26, wherein a vendor responds to the foregoing initial access menu by clicking on “Access To All DPRs,” a deferred purchasing system (106) typically presents a first sorting preference menu for visual presentation on the vendor's monitor through the vendor's web browser, such as, for example:
You have indicated that you desire review access to all Deferred Purchase Requests. Please choose your first sorting preference by clicking on one of the following:
   Sort DPRs By Item Type
   Sort DPRs By Item Identification
   Sort DPRs By Purchaser Name
   Sort DPRs By Purchaser Identification
   Sort DPRs By Purchaser State
   Sort DPRs By Prospective Issue Date

In embodiments according to FIG. 26, wherein a vendor responds to the first sorting preference menu by clicking on the one of the sorting preferences, a deferred purchasing system (106) is typically programmed to present a second sorting preference menu. For example, if the vendor selected “Sort DPRs By Item Type” as the first sorting preference, the deferred purchasing system typically responds by presenting a second sorting preference menu for visual presentation on the vendor's monitor, through the vendor's web browser, such as, for example:
You have indicated that “Item Type” is your first sorting preference. Please choose your second sorting preference by clicking on one of the following:
   Sort DPRs By Item Description
   Sort DPRs By Purchaser Name
   Sort DPRs By Purchaser Identification
   Sort DPRs By Purchaser State
   Sort DPRs By Prospective Issue Date

In embodiments according to FIG. 26, wherein a vendor responds to the second sorting preference menu by clicking on one of the remaining sorting preferences such as “Sort DPRs By Purchaser State,” a deferred purchasing system (106) is typically programmed to find all DPR records (2604) in a DPR Table (2700), sort the records according to item type data stored in the “Item_Type” field (2712) of the DPR record, and then sort the records within each group of records having the same item type, according to purchaser state data stored in a “Purch_address_state” field (2708). In such a case the twice-sorted DPR records are then incorporated into a web sorted DPR list for visual presentation on the vendor's monitor through the vendor's web browser, such as, for example:
At your request the following list of Deferred Purchase Requests has been prepared for your review. Please click on any Deferred Purchase Request for which you desire to make a proposal:
   Item Type=Clothing
      Purchaser State=Georgia
         DPR234567 Men's Black Dress Shoes, Size 11; Issue Date: Jul. 11, 2003
         DPR765432 Men's Brown Dress Shoes, Size 10; Issue Date: Apr. 16, 2003
      Purchaser State=Kentucky
         DPR345678 Men's Khaki Slacks, 38W32L; Issue Date: Jun. 5, 2003
         DPR876543 Men's Dress Slacks, 36W32L; Issue Date: Oct. 11, 2003
   Item Type=Furniture
      Purchaser State=New York
         DPR456789 Brand G Recliner; Issue Date: May 6, 2003
         DPR987654 Brand H Dinette: Issue Date: Apr. 15, 2003
      Purchaser State=Rhode Island
         DPR567890 Brand H Desk; Issue Date: Feb. 2, 2003
         DPR098765 Brand J Office Chair; Issue Date: Sep. 16, 2003
   Item Type=Photographic Equipment
      Purchaser State=Colorado
         DPR109876 Brand Z Camcorder, Model BCD; Issue Date: Feb. 1, 2003
         DPR678901 Brand W Digital Camera, Model DCB; Issue Date: Jan. 2, 2003
      Purchaser State=Texas
         DPR123456 Brand X Camcorder, Model XYZ; Issue Date: Apr. 3, 2003
         DPR654321 Brand Y 35 mm Camera, Model ABC; Issue Date: Mar. 4, 2003

In embodiments according to FIG. 26, wherein a vendor responds to the sorted DPR list by clicking on the listed DPR having “DPR123456” as the DPR identification, a deferred purchasing system (106) is typically programmed to present a vendor proposal form for visual presentation on the vendor's monitor through the vendor's web browser, such as, for example:
You have expressed your interest in submitting a proposal regarding the Deferred Purchase Request identified as DPR123456, for a Brand X Camcorder, Model XYZ, for which a purchase order is scheduled to issue on Apr. 3, 2003. Please enter your proposal, in the form of a total price (including all shipping, handling and taxes) in the space provided and click on the “CONTINUE” button.
   YOUR PROPOSAL IS: $_____
      CONTINUE

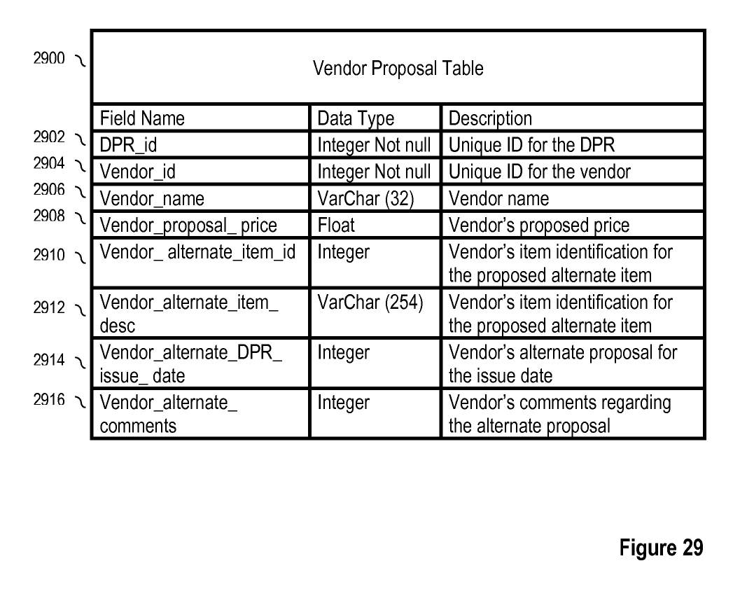

A deferred purchasing system according to such embodiments typically receives (2512) a proposing vendor's (2508) inputted proposal (2514) and records the proposal as data in a “Vendor_proposal_price” field in a record representing the proposal in a Vendor Proposal Table (2900) as illustrated in FIG. 29, the deferred purchasing system also storing, for each vendor proposal record, DPR identification data in a “DPR_id” field (2902), proposing vendor identification data in a “Vendor_id” field (2904), and proposing vendor name data in a “Vendor_name” field (2906). In such embodiments, when more than one vendor proposal is received, the deferred purchasing system records each proposal in a vendor proposal record in the Vendor Proposal Table.

In embodiments according to FIG. 26, wherein a deferred purchasing system (106) receives at least one vendor proposal (2514) as a result of vendor DPR review access (2506) and each such proposal is recorded in a vendor proposal record in a Vendor Proposal Table (2900), the deferred purchasing system utilizes various algorithms to select (2516) a vendor (2518,2519) based on vendor prices, including vendor item prices (1108) from a Vendor-Item Relations Table (reference 1100 on FIG. 11) and vendor proposal prices (2908) from the Vendor Proposal Table (2900). In such embodiments, for example, the deferred purchasing system selects a vendor based on the lowest vendor price as indicated in the Vendor-Item Relations Table (1100) and the Vendor Proposal Table (2900). In such a case the deferred purchasing system determines the selected vendor identification (2518), creates (120) a purchase order (122) and issues (118) the purchase order to the selected vendor (2519) on a date subsequent to the receipt of the DPR. In such embodiments, the selected vendor (2519) may or may not be the proposing vendor (2508), and may or may not be a vendor that, prior to the proposal (2514), was a presenting vendor (as indicated by an association of the item and the vendor in the Vendor-Item Relations Table, and as discussed with respect to FIG. 12).

In embodiments according to FIG. 26, wherein a vendor responds to the above-referenced initial access menu by clicking on “Access To DPRs By Item Type,” a deferred purchasing system (106) typically presents an item type menu for visual presentation on the vendor's monitor through the vendor's web browser, such as, for example:
You have indicated that you desire review access to all Deferred Purchase Requests of a particular item type. Please choose the item type of interest to you by clicking on one of the following available item types:
   CLOTHING
   FURNITURE
   PHOTOGRAPHIC EQUIPMENT

In embodiments according to FIG. 26, wherein a vendor clicks the “Photographic Equipment” button, a deferred purchasing system (106) typically finds from a DPR Table (2700) all DPR records having an item type representing photographic equipment stored in an “Item_type” field of the record representing each DPR. In such a case the DPR records determined to have the photographic equipment item type are then incorporated into an item type list for visual presentation on the vendor's monitor through the vendor's web browser, such as, for example:
At your request the following list of Deferred Purchase Request has been prepared for your review. This list includes only those Deferred Purchase Requests for photographic equipment. Please click on any Deferred Purchase Request for which you desire to make a proposal:
   Item Type=Photographic Equipment
      Purchaser State=Colorado
         DPR109876 Brand Z Camcorder, Model BCD; Issue Feb. 1, 2003
         DPR678901 Brand W Digital Camera, Model DCB; Issue Jan. 2, 2003
      Purchaser State=Texas
         DPR123456 Brand X Camcorder, Model XYZ; Issue Apr. 3, 2003
         DPR654321 Brand Y 35 mm Camera, Model ABC; Issue Date: Mar. 4, 2003

In embodiments according to FIG. 26, wherein a vendor responds to the item type list by clicking on the listed DPR having “DPR123456” as the DPR identification, a deferred purchasing system (106) is typically programmed to present a vendor proposal form for visual presentation on the vendor's monitor through the vendor's web browser, such as, for example:
You have expressed your interest in submitting a proposal regarding the Deferred Purchase Request identified as DPR123456 for a Brand X Camcorder, Model XYZ, for which a purchase order is scheduled to issue on Apr. 3, 2003. Please enter your proposal, in the form of a total price (including all shipping, handling and taxes) in the space provided and click on the “CONTINUE” button.
   YOUR PROPOSAL IS: $______
      CONTINUE

A deferred purchasing system according to such embodiments typically receives (2512) a proposing vendor's (2508) inputted proposal (2514) and records the proposal as data in a “Vendor_proposal_price” field in a record representing the proposal in a Vendor Proposal Table (2900) as illustrated in FIG. 29. In such embodiments, the deferred purchasing system also stores, for each vendor proposal record, DPR identification data in a “DPR_id” field (2902), proposing vendor identification data in a “Vendor_id” field (2904), and proposing vendor name data in a “Vendor_name” field (2906).

In embodiments according to FIG. 26, wherein a vendor responds to the above-referenced initial access menu by clicking on “Access To DPRs By Item Identification,” a deferred purchasing system (106) typically presents a web page item identification form for visual presentation on the vendor's monitor through the vendor's web browser, such as, for example:
You have indicated that you desire review access to all Deferred Purchase Requests for a particular item. Please enter the item identification of interest to you and then click the “Continue” button.
   ITEM IDENTIFICATION: ______
      CONTINUE

In embodiments according to FIG. 26, wherein the vendor inputs an item identification and clicks the “Continue” button, a deferred purchasing system (106) typically finds from a DPR Table (2700) all DPR records having matching item identification data stored in an “Item_id” field (2706) of the record representing each DPR. In such a case the DPR records so found are then incorporated into an item identification list for visual presentation on the vendor's monitor through the vendor's web browser. If, for example, the vendor entered “I789ABC” as the item identification, the item identification list would read for this example:
At your request the following list of Deferred Purchase Requests has been prepared for your review. This list includes only those Deferred Purchase Requests for the item having the item identification “I789ABC.” Please click on any Deferred Purchase Requests for which you desire to make a proposal:
   Item Identification=I789ABC
      DPR012345 Brand X Camcorder, Model XYZ; Issue Jun. 3, 2003
      DPR123456 Brand X Camcorder, Model XYX; Issue Apr. 3, 2003

In embodiments according to FIG. 26, wherein a vendor responds to the item identification DPR list by clicking on the listed DPR having “DPR123456” as the DPR identification, a deferred purchasing system (106) is typically programmed to present a vendor proposal form for visual presentation on the vendor's monitor through the vendor's web browser, such as, for example:
You have expressed your interest in submitting a proposal regarding the Deferred Purchase Request identified as DPR123456 for a Brand X Camcorder, Model XYZ, for which a purchase order is scheduled to issue on Apr. 3, 2003. Please enter your proposal, in the form of a total price (including all shipping, handling and taxes) in the space provided and click on the “CONTINUE” button.
   YOUR PROPOSAL IS: $______
      CONTINUE

A deferred purchasing system according to such embodiments typically receives (2512) a proposing vendor's (2508) inputted proposal (2514) and records the proposal as data in a “Vendor_proposal_price” field in a record representing the proposal in a Vendor Proposal Table (2900) as illustrated in FIG. 29, the deferred purchasing system also storing, for each vendor proposal record, DPR identification data in a “DPR_id” field (2902), proposing vendor identification data in a “Vendor_id” field (2904), and proposing vendor name data in a “Vendor_name” field (2906).

In embodiments according to FIG. 26, wherein a vendor responds to the above-referenced initial access menu by clicking on “Access To DPRs By Purchaser Name Or Identification,” a deferred purchasing system (106) typically presents a purchaser name/identification menu for visual presentation on the vendor's monitor through the vendor's web browser, such as, for example:
You have indicated that you desire review access to all Deferred Purchase Requests for particular purchasers. Please enter either the purchaser name or purchaser identification number for the purchaser of interest to you and then click the “Continue” button.
   PURCHASER NAME: ______
   PURCHASER IDENTIFICATION: ______
      CONTINUE

In embodiments according to FIG. 26, wherein the vendor inputs a purchaser name and clicks the “Continue” button, a deferred purchasing system (106) typically finds from a DPR Table (2700) all DPR records having matching purchaser name data stored in a “Purch_name” field (2706) of the record representing each DPR. If the vendor instead entered a purchaser identification, the deferred purchasing system typically finds from the DPR Table all DPR records having matching purchaser identification data stored in a “Purch_id” field (2704) of the DPR of the record representing each DPR. In such a case the DPR records so found are then incorporated into a purchaser name/identification list for visual presentation on the vendor's monitor through the vendor's web browser. If, for example, the vendor entered “RRR, Inc.” as the purchaser name, the purchaser/identification list would read for this example:
At your request the following list of Deferred Purchase Requests has been prepared for your review. This list includes only those Deferred Purchase Requests where RRR, Inc. is the purchaser. Please click on any Deferred Purchase Requests for which you desire to make a proposal:
   Purchaser=RRR, Inc.
      DPR123456 Brand X Camcorder, Model XYZ; Issue Apr. 3, 2003
      DPR654321 Brand Y 35 mm Camera, Model ABC; Issue Date: Mar. 4, 2003

In embodiments according to FIG. 26, wherein a vendor responds to the purchaser name/identification list by clicking on the listed DPR having “DPR123456” as the DPR identification, a deferred purchasing system (106) is typically programmed to present a vendor proposal form for visual presentation on the vendor's monitor through the vendor's web browser, such as, for example:
You have expressed your interest in submitting a proposal regarding the Deferred Purchase Request identified as DPR123456 for a Brand X Camcorder, Model XYZ, for which a purchase order is scheduled to issue on Apr. 3, 2003. Please enter your proposal, in the form of a total price (including all shipping, handling and taxes) in the space provided and click on the “CONTINUE” button.
   YOUR PROPOSAL IS: $______
      CONTINUE

A deferred purchasing system according to such embodiments typically receives (2512) a proposing vendor's (2508) inputted proposal (2514) and records the proposal as data in a “Vendor_proposal_price” field in a record representing the proposal in a Vendor Proposal Table (2900) as illustrated in FIG. 29, the deferred purchasing system also storing, for each vendor proposal record, DPR identification data in a “DPR_id” field (2902), proposing vendor identification data in a “Vendor_id” field (2904), and proposing vendor name data in a “Vendor_name” field (2906). It should be noted at this point that a given purchaser name is not necessarily associated with just one purchaser identification, since a large company may have several purchasing agents or departments, in different locations, with each having its own unique purchaser identification.

In embodiments according to FIG. 26, wherein a vendor responds to the above-referenced initial access menu by clicking on “Access To DPRs Associated With Your Vendor Identification,” a deferred purchasing system (106) typically finds from a Vendor-Item Relations Table, such as the table illustrated in FIG. 11, all records for items for which the vendor is a presenting vendor, by searching a “Vendor_id” field of the Vendor-Item Relations Table for the vendor's identification submitted during the vendor's login to the web site. In such a case the deferred purchasing system then typically finds from a DPR Table (2700) all DPRs for item identifications appearing the records so found by searching an “Item_id” field (2706) of the DPR Table. The deferred purchasing system is typically programmed to then present to the vendor a list of such DPRs by incorporating the DPRs into a vendor-associated items list for visual presentation on the vendor's monitor through the vendor's web browser, such as, for example:
You have indicated that you desire review access to all Deferred Purchase Requests for items with respect to which you are shown to be a presenting vendor. Our records indicate that the following Deferred Purchasing Requests are for items that you have previously indicated are available from your company. Please click on any Deferred Purchase Requests for which you desire to make a proposal:
   DPR109876 Brand Z Camcorder, Model BCD; Issue Feb. 1, 2003
   DPR123456 Brand X Camcorder, Model XYZ; Issue Apr. 3, 2003
   DPR654321 Brand Y 35 mm Camera, Model ABC; Issue Date: Mar. 4, 2003
   DPR678901 Brand W Digital Camera, Model DCB; Issue Jan. 2, 2003

In embodiments according to FIG. 26, wherein a vendor responds to the vendor-associated items list by clicking on the listed DPR having “DPR123456” as the DPR identification, a deferred purchasing system (106) is typically programmed to present a vendor proposal form for visual presentation on the vendor's monitor through the vendor's web browser, such as, for example:
You have expressed your interest in submitting a proposal regarding the Deferred Purchase Request identified as DPR123456 for a Brand X Camcorder, Model XYZ, for which a purchase order is scheduled to issue on Apr. 3, 2003. Please enter your proposal, in the form of a total price (including all shipping, handling and taxes) in the space provided and click on the “CONTINUE” button.
   YOUR PROPOSAL IS: $______
      CONTINUE

A deferred purchasing system according to such embodiments typically receives (2512) a proposing vendor's (2508) inputted proposal (2514) and records the proposal as data in a “Vendor_proposal_price” field in a record representing the proposal in a Vendor Proposal Table (2900) as illustrated in FIG. 29. In such embodiments, the deferred purchasing system also stores, for each vendor proposal record, DPR identification data in a “DPR_id” field (2902), proposing vendor identification data in a “Vendor_id” field (2904), and proposing vendor name data in a “Vendor_name” field (2906).

In some embodiments of the kind shown in FIG. 26, a vendor will have no prior relationship with a deferred purchasing system (106), and will not have a vendor identification. Through catalogs, advertisements, and other public information, however, the vendor can acquire information as to item types, item identification, item descriptions, and the like, as used by the deferred purchasing system. With this type of information, review access by such a vendor is productively achieved when the vendor accesses a deferred purchasing system web site that does not require a password. As discussed with respect to FIG. 26, such a vendor, without a vendor identification, is able to access the DPRs by item type, item identification or item descriptions. Persons of skill in the art will immediately recognize that additional web pages presented by the deferred purchasing system are readily available for acquiring additional vendor information, such as a vendor address, in the event such a vendor submits a proposal.

In additional embodiments according to FIG. 26 in which a deferred purchasing system grants (2504) DPR review access (2506) to proposing vendors (2508) by communicating through publicly accessible networks (104), the vendor initiates such access by telephone. FIG. 24 depicts a data communications architecture in which a telecommunications server (702) implements either a Jain SLEE environment (704) or a Parlay environment (706) for telecommunications with vendors (114). In some embodiments according to FIG. 24, a Java object operating in a Java SLEE environment implements a user interface between the deferred purchasing system and the vendor. The user interface is a combination of software and computer hardware, such as a Jain SLEE environment running on a telecom server, that prompts vendors with audible menus and accepts vendor responses in the form of keypad inputs or voice recognition. For such embodiments, granting (2504) review access (2506) to DPRs to a proposing vendor (2508) and receiving (2512) proposals (2514) from proposing vendors includes sending and receiving data through the user interface.

In embodiments of the kind shown in FIG. 26, wherein a deferred purchasing system grants (2504) review access (2506) to a DPR table (2700) to proposing vendors (2508) by utilizing a telephone call from a vendor, the deferred purchasing system is typically programmed to include as an answer to the vendor's telephone call an audible message, in a pre-recorded telephone message file such as, for example:
Thank you for calling Vendor Deferred Purchase Request Review Access. Please enter your vendor identification, by pressing the number using your telephone keypad, or speaking number slowly.

In such embodiments according to FIG. 26, a deferred purchasing system (106) typically searches a vendor table such as the vendor table illustrated in FIG. 10, for matching vendor identification data in a “Vendor_id” field (reference 1002 on FIG. 10). If such matching data is located, the deferred purchasing system is typically programmed to continue with another audible message prompt, such as, for example:
Please indicate the manner in which you wish to access the Deferred Purchase Requests currently pending in the Deferred Purchasing System.
If you wish to access all DPRs, press or speak 1.
If you wish to access the DPRs by item type, press or speak 2.
If you wish to access the DPRs by item identification, press or speak 3.
If you wish to access the DPRs by purchaser name or purchaser identification, press or speak 4.
If you wish to access the DPRs associated with your company's vendor identification, press or speak 5.

In embodiments according to FIG. 26, wherein a proposing vendor has responded by pressing 3, a deferred purchasing system (106) is typically programmed to continue with another audible message prompt, such as, for example:
To access all DPRs having a particular item identification, press the seven character item identification number using your telephone keypad, or speak the seven character item identification number slowly.

In such embodiments according to FIG. 26, wherein a proposing vendor has responded to the foregoing audible prompt by pressing the item identification number “I789ABC,” a deferred purchasing system (106) is typically programmed to then find, from a DPR Table such as the table shown in FIG. 27, all DPR records having matching item identification data stored in a “Item_id” field in the DPR record. From the DPR records found to have matching item identification data stored in such field, the deferred purchasing system then typically incorporates DPR identification data from a “DPR_id” field (2702) and DPR issue date data from a “DPR_issue_date” field (2716) into another audible message prompt, such as, for example:
The Deferred Purchasing System has searched and located all DPRs for items having item identification number I789ABC.
The DPRs for items having item identification number:
I789ABC are as follows:
   DPR012345. Issue date scheduled for Jun. 3, 2003
   DPR 123456. Issue date scheduled for Apr. 3, 2003
Please enter the nine character DPR item identification number for each DPR for which you wish to submit a proposal by pressing the number using your telephone key pad, or speaking the number slowly.

In embodiments according to FIG. 26, wherein a proposing vendor has responded to the foregoing audible prompt by pressing “DPR123456,” a deferred purchasing system (106) is typically programmed to receive the inputted DPR identification and store the same as data in a “DPR_id” field (2902) in a vendor proposal record in a Vendor Proposal Table such as the table (2900) depicted in FIG. 29. In such embodiments, the deferred purchasing system also stores the vendor identification in a “Vendor_id” field in the same vendor proposal record, and continues with another audible message prompt, such as, for example:
Please enter your proposal, in the form of a total price (including all shipping, handling and taxes) by pressing the amount in whole dollars using your telephone keypad, or speaking the amount in whole dollars slowly.

In such a case, wherein a deferred purchasing system receives (2512) a proposing vendor's (2508) proposal (2514) as an inputted response to the foregoing audible message prompt, the deferred purchasing system typically records the inputted proposal price as data in a “Vendor_proposal_price” field (2908) in a Vendor Proposal Table (2900). In such embodiments, wherein a Vendor Proposal Table has a record for each vendor proposal received following vendor review access (2506), the deferred purchasing system typically utilizes various algorithms, such as lowest vendor price, for selecting (2516) a vendor (2519) based on the vendor proposals, creating (120) a purchase order (122), and issuing (118) the purchase order to the selected vendor on a date subsequent to the date the DPR was received.

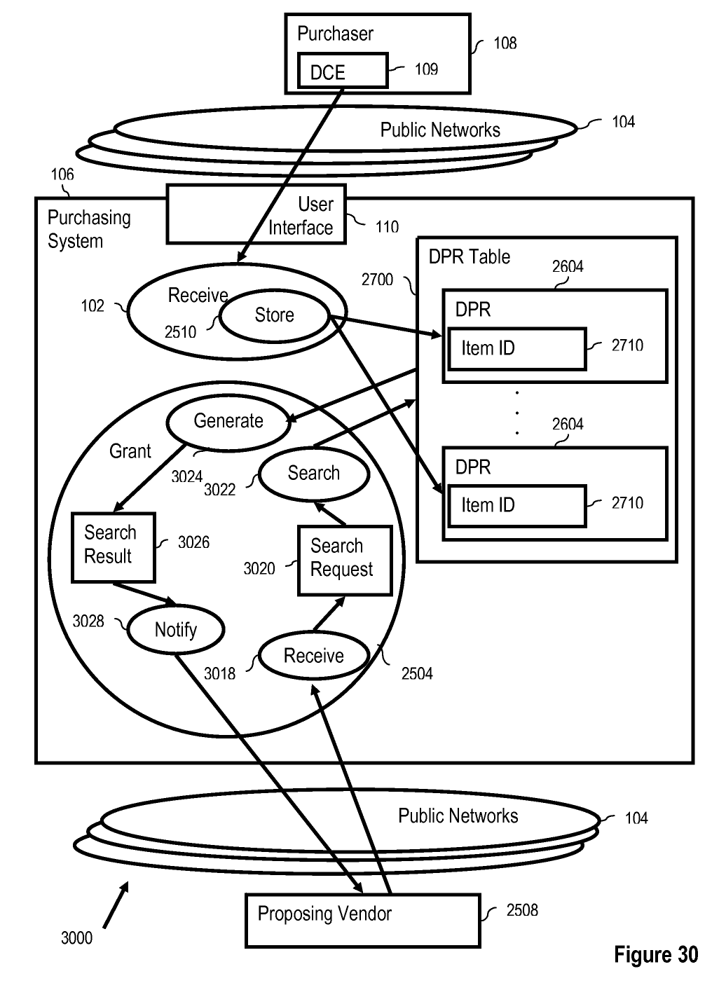

FIG. 30 sets forth a data flow diagram illustrating additional exemplary embodiments (3000) of the present invention, wherein a deferred purchasing system (106) receives (3018) from a proposing vendor (2508) a DPR table search request (3020), searches (3022) a DPR Table of the kind illustrated in FIG. 27, generates (3024) a search result (3026), and notifies (3028) the proposing vendor of the search result. For example, as discussed with respect to FIG. 26, and in embodiments wherein a deferred purchasing system grants (2504) a vendor request for review access (2506) to the DPR table (2700) based on an item identification, the deferred purchasing system receives a search request by receiving the vendor's submission of the item identification entered in response to a deferred purchasing system item identification menu presented on the vendor's monitor through the vendor's web browser. In such an embodiment, the deferred purchasing system searches (3022) the DPR Table (2700) to find all DPR records having a matching item identification in an “Item_id” field (2710), generates (3024) a responsive search result (3026) in the form of a DPR list on a web page (including all such DPR records with the matching item identification), and notifies (3028)the proposing vendor (2508) of the search result by presenting the web page DPR list on the vendor's monitor through the vendor's web browser.

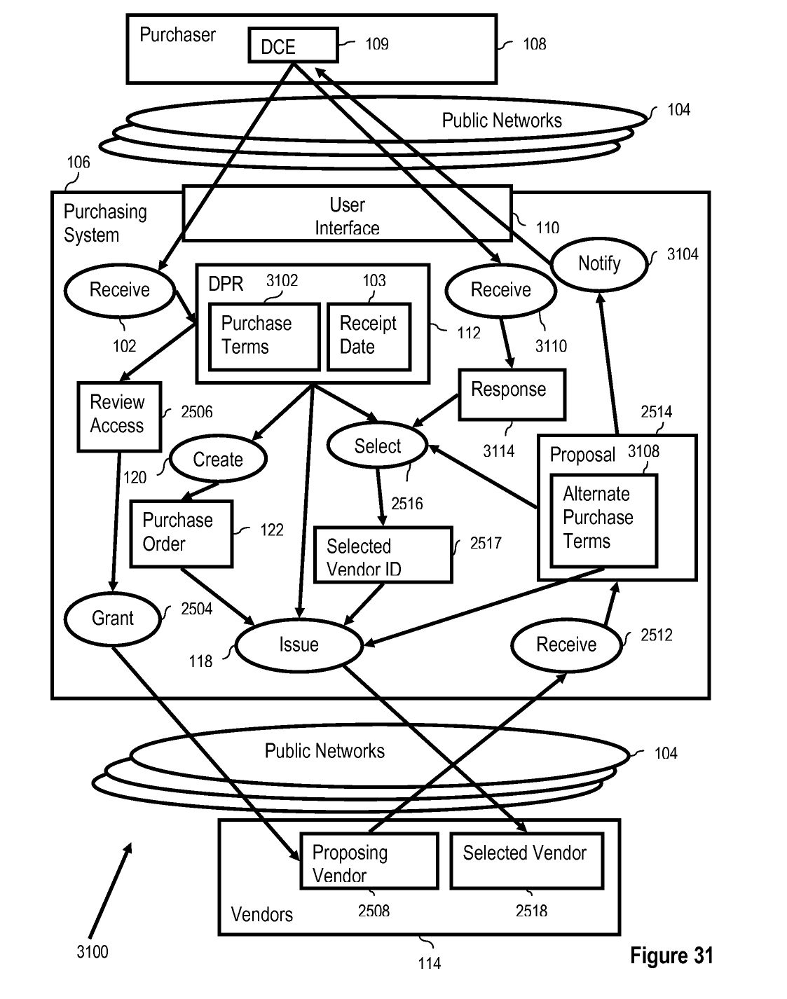

FIG. 31 sets forth a data flow diagram illustrating additional exemplary embodiments (3100) of the present invention, wherein a deferred purchasing system (106) receives at least one vendor proposal after granting (2504) vendor DPR review access (2506) to the proposing vendors, and each such proposal is recorded in a Vendor Proposal Table (2900). In such embodiments, and wherein the deferred purchasing system receives more than one such vendor proposal, the deferred purchasing system typically notifies (3104) a purchaser (108) of the proposals across publicly accessible networks (104), and the deferred purchasing system receives (3110) a response (3112) from the purchaser and selects (2516) a vendor (2518,2519) in dependence upon the response.

In embodiments according to FIG. 31, wherein a deferred purchasing system (106) has received more than one vendor proposal (2514), the deferred purchasing system typically notifies the purchaser by creating an electronic mail file (reference 2004 on FIG. 28) that includes a DPR identification stored in the “DPR_id” field (reference 2902 on FIG. 29) of a Vendor Proposal Table (2900), item description data stored in the “Item_desc” field (reference 2714 on FIG. 27) of an associated DPR record in the DPR Table (2700), and a textual message, such as, for example:
With regard to your Deferred Purchasing Request No. DPR123456 for a Brand X Camcorder, Model XYZ, we have received vendor price proposals for your consideration.
In order for you to choose from the vendor price proposals please click on the “GO TO VENDOR PROPOSAL REVIEW”link below.
   GO TO VENDOR PROPOSAL REVIEW

A deferred purchasing system according to FIG. 31 typically utilizes a mail server (reference 2002 on FIG. 28) to transfer this electronic mail file across an internet protocol network utilizing SMTP, and the purchaser receives the electronic mail file through its SMTP mail server or electronic mail client. In this regard, the deferred purchasing system operates in conjunction with a web server (reference 1602 on FIG. 28) having a conventional web site, and the purchaser (108) typically has DCE (109) including a web browser, mail server (or mail client), monitor, mouse and keyboard. In such embodiments, and as illustrated in FIG. 28, the public network (104) for communications between the deferred purchasing system (106) and the purchasers (108) is an internet protocol network, and a user interface (110) includes a set of web pages (reference 1604 on FIG. 28), HTML documents and forms, communicated between a web server and a purchaser in HTTP messages. For such embodiments, notifying (3104) a purchaser of received vendor proposals (2514) includes sending data in electronic mail messages communicated through electronic mail protocols such, for example, SMTP, POP, or IMAP, to the purchaser's mail server (or mail client), and sending and receiving HTTP messages to and from the purchaser's browser. Deferred purchasing systems according to such embodiments often implement access to data and functions within such systems by use of CGI gateway programs (1606) or Java servlets (1608).

In embodiments according to FIG. 31, wherein the above-described electronic mail file with a web site link is utilized, the purchaser clicks on the link and is connected with a deferred purchasing system web site, through which the deferred purchasing system typically presents, as a visible message on the purchaser's monitor, a web page displayed through the purchaser's browser, the web page including, for each proposing vendor (2508), a vendor name from a “Vendor_name” field (2906) and a vendor price proposal from the “Vendor_proposal_price” field (2908) of the proposal record in a Vendor Proposal Table (2900) in which is stored the proposing vendor's proposal data. In such an example, the deferred purchasing system presents a web page such as:

With respect to your Deferred Purchasing Request No. DPR123456 for a Brand X Camcorder, Model XYZ, we have received the following vendor price proposals:

| | |
|---|---|
| (First vendor name) | $350.00 |
| (Second vendor name) | $340.00 |
| (Third vendor name) | $375.00 |

Please choose the vendor proposal which you desire by clicking on the vendor name shown next to the vendor price proposal.

A deferred purchasing system according to such an embodiment typically receives (3110), in response to the web page prompt, a price proposal response (3114) from the purchaser indicating the chosen price proposal (2514), and then selects (2516) a selected vendor (2518) by storing the selected vendor identification (2517) for the vendor submitting the proposal (2514) so chosen by the purchaser. In such embodiments, the deferred purchasing system typically stores the selected vendor's identification (2517) in a “Vendor_id” field (2718) in the purchaser's DPR record in a DPR Table (2700), and stores the vendor price proposal from the chosen proposal in a “Vendor_price” field (2720) of the purchaser's DPR record. In such a case, the deferred purchasing system later creates (120) and issues (118) a purchase order (122) for the item to the vendor whose proposal is indicated in the purchaser's response, and the purchase order includes the vendor price proposal as the price.

In additional embodiments according to FIG. 31, a DPR (112) includes purchase terms (3102), a deferred purchasing system (106) receives (2512) a proposing vendor's (2508) proposal (2514) that includes alternate purchase terms (3108), and the deferred purchasing system issues (118) a purchase order (122) in dependence upon the alternate purchase terms. In such embodiments wherein a deferred purchasing system utilizes a web site for vendor DPR review access (2506), the vendor enters a vendor identification and password for web site access, and the deferred purchasing system typically presents, as a visible message on the vendor's monitor, a web page having a initial access menu displayed through the vendor's browser, such as, for example:
Thank you for your interest in submitting a proposal with regard to Deferred Purchase Requests accessible through this web site. Please choose the type of access that you desire at this time by clicking on one of the following:
   Access To All DPRs
   Access To DPRs By Item Type
   Access To DPRs By Item Identification
   Access To DPRs By Purchaser Name or Identification
   Access To DPRs Associated With Your Vendor Identification

In embodiments according to FIG. 31, wherein a vendor responds to the above-referenced initial access menu by clicking on “Access To DPRs By Item Identification,” a deferred purchasing system (106) typically presents an item identification menu for visual presentation on the vendor's monitor through the vendor's web browser, such as, for example:
You have indicated that you desire review access to all Deferred Purchase Requests for a particular item. Please enter the item identification of interest to you and then click the “Continue” button.
   ITEM IDENTIFICATION: ______
      CONTINUE

In embodiments according to FIG. 31, wherein a vendor inputs an item identification and clicks the “Continue” button, a deferred purchasing system (106) typically finds from a DPR Table (2700) all DPR records having matching item identification data stored in an “Item_id” field (2706) of the record representing each DPR. In such a case the DPR records so found are then incorporated into an item identification list for visual presentation on the vendor's monitor through the vendor's web browser. If, for example, the vendor entered “1789ABC” as the item identification, the item identification list would read for this example:
At your request the following list of Deferred Purchase Requests has been prepared for your review. This list includes only those Deferred Purchase Requests for the item having the item identification “I789ABC.” Please click on any Deferred Purchase Requests for which you desire to make a proposal:
   Item Identification=I789ABC
      DPR012345 Brand X Camcorder, Model XYZ; Issue Jun. 3, 2003
      DPR123456 Brand X Camcorder, Model XYX; Issue Apr. 3, 2003

In embodiments according to FIG. 31, wherein a vendor responds to the item identification DPR list by clicking on the listed DPR having “DPR123456” as the DPR identification, a deferred purchasing system (106) is typically programmed to present a vendor proposal form for visual presentation on the vendor's monitor through the vendor's web browser, such as, for example:

You have expressed your interest in submitting a proposal regarding the Deferred Purchase Request identified as DPR123456 for a Brand X Camcorder, Model XYZ, for which a purchase order is scheduled to issue on Apr. 3, 2003. If you wish to submit a proposal according to the existing purchase terms of DPR123456, please enter your proposal, in the form of a total price (including all shipping, handling and taxes) in the space provided and click on the “CONTINUE” button. If you desire to alter the DPR123456 purchase terms please click on the “ALTERNATE TERMS” button.

YOUR PROPOSED PRICE ACCORDING TO
DPR123456 TERMS WITHOUT ALTERATION IS:
$
ALTERNATE TERMS
CONTINUE

In embodiments according to FIG. 31, wherein a proposing vendor clicks on the “ALTERNATE TERMS” button, a deferred purchasing system (106) typically presents a vendor alternate proposal form for visual presentation on the vendor's monitor through the vendor's web browser, such as, for example:
You have expressed your interest in submitting an alternate proposal for DPR123456 for a Brand X Camcorder, Model XYZ. Please enter the alternate purchase terms across from the current purchase terms below, along with any comments as to the nature or basis for the alteration.
Item Identification: I789ABC Alternate: ______
Item Description:
Brand X Camcorder, Model XYZ Alternate: ______
DPR Issue Apr. 3, 2003 Alternate: ______
Proposed Price: $______
Comments: ______

In embodiments according to FIG. 31, wherein a deferred purchasing system (106) receives (2512) at least one vendor proposal (2514) having alternate purchase terms (3108), the deferred purchasing system is typically programmed to record the alternate purchase terms data in a vendor proposal record in a Vendor Proposal Table (2900), such as the table illustrated in FIG. 29. In such embodiments, wherein a proposing vendor (2508) has entered item identification data, item description data, comment data, and price proposal data for a different item, the deferred purchasing system typically stores the alternate item identification data in a “Vendor_alternate_item_id” field (2910), the alternate item description data in a “Vendor_alternate_item_desc” field (2912), the comment data in a “Vendor_alternate_comment” field (2916), and the price proposal data in a “Vendor_proposal_price” field (2908), in a vendor proposal record in the Vendor Proposal Table.

In other such embodiments according to FIG. 31, wherein a proposing vendor has entered an alternate DPR issue date, a deferred purchasing system (106) typically stores the alternate DPR issue date data in a “Vendor_alternate_DPR_issue_date” field (2914). In such embodiments, the deferred purchasing system typically stores the alternate DPR issue date data in such a field in a vendor proposal record in a Vendor Proposal Table (2900).

For embodiments of the kind shown in FIG. 31, wherein a deferred purchasing system (106) receives (2512) at least one vendor proposal (2514) that includes one or more alternate purchase terms (3108), the deferred purchasing system typically notifies (3104) a purchaser (108) of the proposals across publicly accessible networks (104), and the deferred purchasing system receives (3110) a response (3112) from the purchaser and selects (2516) a vendor (2518,2519) in dependence upon the response. In some such embodiments a deferred purchasing system notifies a purchaser of alternate purchase terms in a vendor proposal by telephone, utilizing the purchaser's telephone number stored in the “Purchaser_phone” field (such as reference 310 on FIG. 19) of a DPR record. FIG. 24 depicts a data communications architecture in which a telecommunications server (702) implements either a Jain SLEE environment (704) or a Parlay environment (706) for telecommunications with purchasers (108). In some embodiments according to FIG. 24, a Java object operating in a Java SLEE environment implements a user interface between the deferred purchasing system and the purchaser. The user interface is a combination of software and computer hardware, such as a Jain SLEE environment running on a telecom server, that prompts purchasers with audible menus and accepts purchaser responses in the form of keypad inputs or voice recognition. For such embodiments notifying (3104) the purchaser of the vendor proposal (2514) and receiving (3110) a response (3114) from the purchaser includes sending and receiving data through the user interface.

In embodiments of the kind shown in FIG. 31, wherein a deferred purchasing system notifies (3104) purchasers of vendor proposals (2514) with alternate purchase terms by utilizing a telephone call, the deferred purchasing system is typically programmed to include DPR identification data stored in a “DPR_id” field (2902), alternate item identification data stored in a “Vendor_alternate_item_id” field (2910), alternate item description data stored in a “Vendor_alternate_item_desc” field (2912) of the DPR record, price proposal data stored in a “Vendor_proposal_price” field (2908), and an audible message, in a pre-recorded telephone message file, such as, for example:
We have received an unsolicited proposal from a vendor with respect to your Deferred Purchasing Request No. DPR123456, for a Brand X Camcorder, Model XYZ. The proposal includes purchase terms that are different from the purchase terms originally provided in your Deferred Purchase Request. Please listen to the alternate purchase terms and if you desire to accept such terms, and alter your Deferred Purchase Request, please respond by speaking or using your telephone keypad when requested.
The Item Identification number for an alternate item, different from the item you identified in the Deferred Purchase Request, is 1789ABD, and the item description for the alternate item is a Brand Y Camcorder, Model XZZ. The proposal price for the alternate item is $300. The vendor submitting this proposal for an alternate item has included the following comment: “The suggested camcorder is actually the same as the Brand X, Model XYZ. Both are manufactured by a company known as “SSS, Inc.” and marketed by the Brand X and Brand Y companies under different company and model names. Brand Y sells for substantially less, as indicated by the proposed price.”
If you wish to accept this vendor's proposal for a different item, speak or press 1. If you do not wish to accept the proposal, speak or press 2 or hang up.

In embodiments according to FIG. 31, wherein a purchaser responds affirmatively to the alternate purchase terms in the vendor proposal by pressing “1,” a deferred purchasing system (106) typically stores, in a DPR record in a DPR Table (2700), vendor identification data (2518) in a “Vendor_id” field (2718) alternate item identification data in an “Item_id” field (2710), alternate item description data in an “Item_desc” field (2714), price proposal data in a “Vendor_proposal_price” field (2720). By so recording the alternate purchase terms (3108), the deferred purchasing system modifies the DPR, and subsequently creates (120) a purchase order (122) to be issued (118) to a selected vendor (2519) on a date subsequent to the creation of the original DPR. In such embodiments, the purchase order is for the alternate item.

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

1. A method for operating a publicly accessible purchasing system, the method comprising:
receiving, on a receipt date, from a purchaser in a publicly accessible purchasing system, a deferred purchase request (“DPR”) for an item, the DPR representing an instruction to issue to a vendor on behalf of the purchaser a purchase order formulated according to detailed information provided as part of the DPR;
granting to vendors review access to DPRs;
receiving from a proposing vendor a proposal regarding a reviewed DPR;
selecting a vendor, in dependence upon the proposal; and
issuing a purchase order to the selected vendor for an item on a date subsequent to the receipt date.

2. The method of claim 1 wherein receiving a DPR comprises receiving a plurality of DPRs, the method further comprising:
storing the DPRs in a DPR table;
wherein granting review access further comprises granting review access to the DPR table.

3. The method of claim 2 wherein granting review access to the DPR table further comprises:
receiving a DPR table search request from the proposing vendor;
searching the DPR table;
generating a search result; and
notifying the proposing vendor of the search result.

4. The method of claim 1, further comprising:
notifying the purchaser of the proposal;
receiving a response from the purchaser;
wherein selecting a selected vendor in dependence upon the proposal comprises selecting a selected vendor in dependence upon the purchaser response.

5. The method of claim 1, wherein the DPR comprises purchase terms, the proposing vendor proposal comprises alternate purchase terms, and issuing a purchase order to the selected vendor further comprises issuing a purchase order to the proposing vendor in dependence upon the alternate purchase terms.

6. The method of claim 1 wherein receiving a DPR in a publicly accessible purchasing system further comprises receiving a DPR across a telecommunications network through a Parlay environment.

7. The method of claim 1 wherein receiving a DPR in a publicly accessible purchasing system further comprises receiving a DPR across a telecommunications network through a JAIN SLEE environment.

8. The method of claim 1 wherein receiving a DPR in a publicly accessible purchasing system further comprises receiving a DPR across an internet protocol network utilizing HTTP.

9. The method of claim 1 wherein receiving at least one vendor proposal comprises receiving at least one vendor proposal across a telecommunications network through a Parlay environment.

10. The method of claim 1 wherein receiving at least one vendor proposal comprises receiving at least one vendor proposal across a telecommunications network through a JAIN SLEE environment.

11. The method of claim 1 wherein receiving at least one vendor proposal comprises receiving at least one vendor proposal across an internet protocol network utilizing HTTP.

12. A system for operating a publicly accessible purchasing system, the system comprising:
means for receiving, on a receipt date, from a purchaser in a publicly accessible purchasing system, a deferred purchase request (“DPR”) for an item, the DPR representing an instruction to issue to a vendor on behalf of the purchaser a purchase order formulated according to detailed information provided as part of the DPR;
means for granting to vendors review access to DPRs;
means for receiving from a proposing vendor a proposal regarding a reviewed DPR;
means for selecting a vendor, in dependence upon the proposal; and
means for issuing a purchase order to the selected vendor for an item on a date subsequent to the receipt date.

13. The system of claim 12 wherein means for receiving a DPR comprises means for receiving a plurality of DPRs, the system further comprising:
means for storing the DPRs in a DPR table;
wherein means for granting review access further comprises means for granting review access to the DPR table.

14. The system of claim 13 wherein means for granting review access to the DPR table further comprises:
means for receiving a DPR table search request from the proposing vendor;
means for searching the DPR table;
means for generating a search result; and
means for notifying the proposing vendor of the search result.

15. The system of claim 12, further comprising:
means for notifying the purchaser of the proposal;
means for receiving a response from the purchaser;
wherein means for selecting a selected vendor in dependence upon the proposal comprises means for selecting a selected vendor in dependence upon the purchaser response.

16. The system of claim 12, wherein the DPR comprises purchase terms, the proposing vendor proposal comprises alternate purchase terms, and means for issuing a purchase order to the selected vendor further comprises means for issuing a purchase order to the proposing vendor in dependence upon the alternate purchase terms.

17. The system of claim 12 wherein means for receiving a DPR in a publicly accessible purchasing system further comprises means for receiving a DPR across a telecommunications network through a Parlay environment.

18. The system of claim 12 wherein means for receiving a DPR in a publicly accessible purchasing system further comprises means for receiving a DPR across a telecommunications network through a JAIN SLEE environment.

19. The system of claim 12 wherein means for receiving a DPR in a publicly accessible purchasing system further comprises means for receiving a DPR across an internet protocol network utilizing HTTP.

20. The system of claim 12 wherein means for receiving at least one vendor proposal comprises means for receiving at least one vendor proposal across a telecommunications network through a Parlay environment.

21. The system of claim 12 wherein means for receiving at least one vendor proposal comprises means for receiving at least one vendor proposal across a telecommunications network through a JAIN SLEE environment.

22. The system of claim 12 wherein means for receiving at least one vendor proposal comprises means for receiving at least one vendor proposal across an internet protocol network utilizing HTTP.

23. A computer program product for operating a publicly accessible purchasing system, the computer program product comprising:
a recording medium;
means, recorded on the recording medium, for receiving, on a receipt date, from a purchaser in a publicly accessible purchasing system, a deferred purchase request (“DPR”) for an item, the DPR representing an instruction to issue to a vendor on behalf of the purchaser a purchase order formulated according to detailed information provided as part of the DPR;
means, recorded on the recording medium, for granting to vendors review access to DPRs;
means, recorded on the recording medium, for receiving from a proposing vendor a proposal regarding a reviewed DPR;
means, recorded on the recording medium, for selecting a vendor, in dependence upon the proposal; and
means, recorded on the recording medium, for issuing a purchase order to the selected vendor for an item on a date subsequent to the receipt date.

24. The computer program product of claim 23 wherein means, recorded on the recording medium, for receiving a DPR comprises means, recorded on the recording medium, for receiving a plurality of DPRs, the computer program product further comprising:
means, recorded on the recording medium, for storing the DPRs in a DPR table;
wherein means, recorded on the recording medium, for granting review access further comprises means, recorded on the recording medium, for granting review access to the DPR table.

25. The computer program product of claim 24 wherein means, recorded on the recording medium, for granting review access to the DPR table further comprises:
means, recorded on the recording medium, for receiving a DPR table search request from the proposing vendor;
means, recorded on the recording medium, for searching the DPR table;
means, recorded on the recording medium, for generating a search result; and
means, recorded on the recording medium, for notifying the proposing vendor of the search result.

26. The computer program product of claim 23, further comprising:
means, recorded on the recording medium, for notifying the purchaser of the proposal;
means, recorded on the recording medium, for receiving a response from the purchaser;
wherein means, recorded on the recording medium, for selecting a selected vendor in dependence upon the proposal comprises means, recorded on the recording medium, for selecting a selected vendor in dependence upon the purchaser response.

27. The computer program product of claim 23, wherein the DPR comprises purchase terms, the proposing vendor proposal comprises alternate purchase terms, and means, recorded on the recording medium, for issuing a purchase order to the selected vendor further comprises means, recorded on the recording medium, for issuing a purchase order to the proposing vendor in dependence upon the alternate purchase terms.

28. The computer program product of claim 23 wherein means, recorded on the recording medium, for receiving a DPR in a publicly accessible purchasing system further comprises means, recorded on the recording medium, for receiving a DPR across a telecommunications network through a Parlay environment.

29. The computer program product of claim 23 wherein means, recorded on the recording medium, for receiving a DPR in a publicly accessible purchasing system further comprises means, recorded on the recording medium, for receiving a DPR across a telecommunications network through a JAIN SLEE environment.

30. The computer program product of claim 23 wherein means, recorded on the recording medium, for receiving a DPR in a publicly accessible purchasing system further comprises means, recorded on the recording medium, for receiving a DPR across an internet protocol network utilizing HTTP.

31. The computer program product of claim 23 wherein means, recorded on the recording medium, for receiving at least one vendor proposal comprises means, recorded on the recording medium, for receiving at least one vendor proposal across a telecommunications network through a Parlay environment.

32. The computer program product of claim 23 wherein means, recorded on the recording medium, for receiving at least one vendor proposal comprises means, recorded on the recording medium, for receiving at least one vendor proposal across a telecommunications network through a JAIN SLEE environment.

33. The computer program product of claim 23 wherein means, recorded on the recording medium, for receiving at least one vendor proposal comprises means, recorded on the recording medium, for receiving at least one vendor proposal across an internet protocol network utilizing HTTP.
